(19) United States
(12) Patent Application Publication
(10) Pub. No.: US 2024/0259733 A1
(43) Pub. Date: Aug. 1, 2024

(54) VIBRATION COMPONENTS AND LOUDSPEAKERS

(71) Applicant: SHENZHEN SHOKZ CO., LTD., Shenzhen (CN)

(72) Inventors: Wenbing ZHOU, Shenzhen (CN); Qingyi WANG, Beijing (CN); Lei ZHANG, Shenzhen (CN); Xin QI, Shenzhen (CN); Fengyun LIAO, Shenzhen (CN)

(73) Assignee: SHENZHEN SHOKZ CO., LTD., Shenzhen (CN)

(21) Appl. No.: 18/430,834

(22) Filed: Feb. 2, 2024

Related U.S. Application Data
(63) Continuation of application No. PCT/CN2022/094544, filed on May 23, 2022.

(30) Foreign Application Priority Data
Mar. 18, 2022 (WO) PCT/CN2022/081838

(51) Int. Cl. H04R 7/14; H04R 7/12

(52) U.S. Cl. CPC H04R 7/14; H04R 7/122

(57) ABSTRACT

One or more embodiments of the present disclosure relate to a loudspeaker, comprising a driving component configured to generate a vibration based on an electrical signal; and a vibration component configured to receive the vibration of the driving component to vibrate. The vibration component includes an elastic element and a reinforcing member. The elastic element includes a central region, a folded ring region disposed at a periphery of the central region, and a fixed region disposed at a periphery of the folded ring region. The elastic element is configured to vibrate in a direction perpendicular to the central region. The reinforcing member is connected with the central region. The reinforcing member includes a reinforcing part and a plurality of hollow parts. Vibrations of the reinforcing member and the elastic element generate at least two resonance peaks within an audible range of human ears.

### CROSS-REFERENCE TO RELATED APPLICATIONS

This application is a continuation of International Application No. PCT/CN2022/094544, filed on May 23, 2022, which claims priority of an International Patent Application No. PCT/CN2022/081838, filed on Mar. 18, 2022, the contents of each of which are hereby incorporated by reference.

### TECHNICAL FIELD

The present disclosure relates to the field of acoustic technology, and in particular to a vibration component and a loudspeaker.

### BACKGROUND

A loudspeaker generally includes three core parts: a driving part, a vibration part, and an auxiliary support part. The vibration part is also referred to as a load part of the loudspeaker, which mainly includes a diaphragm component. Under a constant driving force of the driving part, the load part and the driving part of the loudspeaker may achieve better mechanical impedance matching through reasonable design of the vibration part, thereby achieving output effects of a high sound pressure level and a wide bandwidth.

### SUMMARY

One aspect of the embodiments of the present disclosure provides a loudspeaker, comprising: a driving component configured to generate a vibration based on an electrical signal; and a vibration component configured to receive the vibration of the driving component to vibrate. The vibration component may include an elastic element and a reinforcing member. The clastic element may include a central region, a folded ring region disposed at a periphery of the central region, and a fixed region disposed at a periphery of the folded ring region. The elastic element may be configured to vibrate in a direction perpendicular to the central region. The reinforcing member may be connected with the central region. The reinforcing member may include a reinforcing part and a plurality of hollow parts. Vibrations of the reinforcing member and the elastic element may generate at least two resonance peaks within an audible range of human cars.

Another aspect of the embodiments of the present disclosure provides a vibration component, comprising: an elastic element including a central region, a folded ring region disposed at a periphery of the central region, and a fixed region disposed at a periphery of the folded ring region, the elastic element being configured to vibrate in a direction perpendicular to the central region; and a reinforcing member connected with the central region, the reinforcing member including a reinforcing part and a plurality of hollow parts. The reinforcing member may be configured such that the vibration component at least may generate a resonance peak within a range of 10000 Hz-18000 Hz during vibration.

Another aspect of the embodiments of the present disclosure provides a loudspeaker, comprising: a driving component configured to generate a vibration based on an electrical signal; and a vibration component configured to receive the vibration of the driving component to vibrate. The vibration component may include an elastic element and a reinforcing member. The clastic element may include a central region, a folded ring region disposed at a periphery of the central region, and a fixed region disposed at a periphery of the folded ring region. The clastic element may be configured to vibrate in a direction perpendicular to the central region. The reinforcing member may be connected with the central region. The reinforcing member may include a reinforcing part and a plurality of hollow parts. The reinforcing member may be configured such that the vibration component may at least generate a resonance peak within a range of 10000 Hz-18000 Hz during vibration.

Another aspect of the embodiments of the present disclosure provides a vibration component, comprising: an elastic element including a central region, a folded ring region disposed at a periphery of the central region, and a fixed region disposed at a periphery of the folded ring region, the elastic element being configured to vibrate in a direction perpendicular to the central region; and a reinforcing member, wherein a projection area of a maximum contour of the reinforcing member in a vibration direction of the elastic element may be less than a projection area of the central region in the vibration direction. The central region may include a suspension region disposed at a periphery of the reinforcing member. The folded ring region and the suspension region may be configured such that the vibration component may at least generate a resonance peak within a range of 3000 Hz-7000 Hz during vibration.

Another aspect of the embodiments of the present disclosure provides a loudspeaker, comprising: a driving component configured to generate a vibration based on an electrical signal; and a vibration component configured to receive the vibration of the driving component to vibrate. The vibration component may include an elastic element and a reinforcing member. The clastic element may include a central region, a folded ring region disposed at a periphery of the central region, and a fixed region disposed at a periphery of the folded ring region. The clastic element may be configured to vibrate in a direction perpendicular to the central region. A projection area of a maximum contour of the reinforcing member in a vibration direction of the clastic element may be less than a projection area of the central region in the vibration direction. The central region may include a suspension region disposed at a periphery of the reinforcing member. The folded ring region and the suspension region may be configured such that the vibration component may at least generate a resonance peak within a range of 3000 Hz-7000 Hz during vibration.

Another aspect of the embodiments of the present disclosure provides a vibration component, comprising: an elastic element including a central region, a folded ring region disposed at a periphery of the central region, and a fixed region disposed at a periphery of the folded ring region, the elastic element being configured to vibrate in a direction perpendicular to the central region; and a reinforcing member connected with the central region, wherein the reinforcing member may include one or more ring structures and one or more strip structures, and each of the one or more strip structures may be connected with at least one of the one or more ring structures. At least one of the one or more strip structures may extend toward a center of the central region. The reinforcing member may be configured such that the vibration component may at least generate a resonance peak within a range of 5000 Hz-12000 Hz during vibration.

Another aspect of the embodiments of the present disclosure provides a loudspeaker, comprising: a driving component configured to generate a vibration based on an electrical signal; and a vibration component configured to receive the vibration of the driving component to vibrate. The vibration component may include an elastic element and a reinforcing member. The elastic element may include a central region, a folded ring region disposed at a periphery of the central region, and a fixed region disposed at a periphery of the folded ring region. The clastic element may be configured to vibrate in a direction perpendicular to the central region. The reinforcing member may be connected with the central region. The reinforcing member may include one or more ring structures and one or more strip structures. Each of the one or more strip structures may be connected with at least one of the one or more ring structures. At least one of the one or more strip structures may extend toward a center of the central region. The reinforcing member may be configured such that the vibration component may at least generate a resonance peak within a range of 5000 Hz-12000 Hz during vibration.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating a vibration component and an equivalent vibration model thereof according to some embodiments of the present disclosure;

FIG. 2 is a schematic diagram illustrating a deformation of a vibration component at a first resonance peak according to some embodiments of the present disclosure;

FIG. 3 is a schematic diagram illustrating deformations of a vibration component at a second resonance peak according to some embodiments of the present disclosure;

FIG. 4 is a schematic diagram illustrating deformations of a vibration component at a third resonance peak according to some embodiments of the present disclosure;

FIG. 5 is a schematic diagram illustrating a deformation of a vibration component at a fourth resonance peak according to some embodiments of the present disclosure;

FIG. 6 is a schematic diagram illustrating frequency response curves of vibration components with different differences between a frequency of a third resonance peak and a frequency of a fourth resonance peak according to some embodiments of the present disclosure;

FIG. 7A is a schematic diagram illustrating a frequency response curve of a vibration component according to some embodiments of the present disclosure;

FIG. 7B is a schematic diagram illustrating a frequency response curve of a vibration component according to some embodiments of the present disclosure;

FIG. 7C is a schematic diagram illustrating a frequency response curve of a vibration component according to some embodiments of the present disclosure;

FIG. 7D is a schematic diagram illustrating a frequency response curve of a vibration component according to some embodiments of the present disclosure;

FIG. 8A is a schematic structural diagram illustrating a vibration component according to some embodiments of the present disclosure;

FIG. 8B is a schematic structural diagram illustrating frequency response curves of vibration components according to some embodiments of the present disclosure;

FIG. 9A is a schematic diagram illustrating a partial structure of a vibration component according to some embodiments of the present disclosure;

FIG. 9B is a schematic diagram illustrating frequency response curves of vibration components according to some embodiments of the present disclosure;

FIG. 9C is a schematic diagram illustrating frequency response curves of vibration components according to some embodiments of the present disclosure;

FIG. 10A is a schematic diagram illustrating a deformation of a vibration component at a fourth resonance peak according to some embodiments of the present disclosure;

FIG. 10B is a schematic diagram illustrating frequency response curves of vibration components according to some embodiments of the present disclosure;

FIG. 10C is a schematic diagram illustrating frequency response curves of vibration components according to some embodiments of the present disclosure;

FIG. 11 is a schematic diagram illustrating deformations of vibration components at a fourth resonance peak according to some embodiments of the present disclosure;

FIG. 12A is a schematic diagram illustrating frequency response curves of the vibration components in FIG. 11;

FIG. 12B is a schematic diagram illustrating frequency response curves of vibration components according to some embodiments of the present disclosure;

FIG. 13A is a schematic structural diagram illustrating a vibration component according to some embodiments of the present disclosure;

FIG. 13B is a schematic structural diagram illustrating a vibration component according to some embodiments of the present disclosure;

FIG. 14A is a schematic structural diagram illustrating a vibration component according to some embodiments of the present disclosure;

FIG. 14B is a schematic structural diagram illustrating a vibration component according to some embodiments of the present disclosure;

FIG. 14C is a schematic structural diagram illustrating a vibration component according to some embodiments of the present disclosure;

FIG. 14D is a schematic structural diagram illustrating a vibration component according to some embodiments of the present disclosure;

FIG. 15A is a schematic structural diagram illustrating a vibration component according to some embodiments of the present disclosure;

FIG. 15B is a schematic structural diagram illustrating a vibration component according to some embodiments of the present disclosure;

FIG. 16A is a schematic structural diagram illustrating a vibration component according to some embodiments of the present disclosure;

FIG. 16B is a schematic structural diagram illustrating a vibration component according to some embodiments of the present disclosure;

FIG. 16C is a schematic structural diagram illustrating a vibration component according to some embodiments of the present disclosure;

FIG. 16D is a schematic structural diagram illustrating a vibration component according to some embodiments of the present disclosure;

FIG. 16E is a schematic structural diagram illustrating a vibration component according to some embodiments of the present disclosure;

FIG. 16F is a schematic structural diagram illustrating frequency response curves of vibration components according to some embodiments of the present disclosure;

FIG. 17A is a schematic structural diagram illustrating a vibration component according to some embodiments of the present disclosure;

FIG. 17B is a schematic structural diagram illustrating a vibration component according to some embodiments of the present disclosure;

FIG. 17C is a schematic diagram illustrating frequency response curves of vibration components according to some embodiments of the present disclosure;

FIG. 18A is a schematic structural diagram illustrating a vibration component according to some embodiments of the present disclosure;

FIG. 18B is a schematic structural diagram illustrating a vibration component according to some embodiments of the present disclosure;

FIG. 18C is a schematic structural diagram illustrating a vibration component according to some embodiments of the present disclosure;

FIG. 19 is a schematic structural diagram illustrating a vibration component according to some embodiments of the present disclosure;

FIG. 20A is a schematic structural diagram illustrating a vibration component according to some embodiments of the present disclosure;

FIG. 20B is a schematic structural diagram illustrating frequency response curves of vibration components according to some embodiments of the present disclosure;

FIG. 21A is a schematic structural diagram illustrating a vibration component according to some embodiments of the present disclosure;

FIG. 21B is a schematic structural diagram illustrating a vibration component according to some embodiments of the present disclosure;

FIG. 21C is a schematic structural diagram illustrating a vibration component according to some embodiments of the present disclosure;

FIG. 21D is a schematic structural diagram illustrating a vibration component according to some embodiments of the present disclosure;

FIG. 21E is a schematic structural diagram illustrating a vibration component according to some embodiments of the present disclosure;

FIG. 22 is a schematic structural diagram illustrating a vibration component according to some embodiments of the present disclosure;

FIG. 23 is a schematic structural diagram illustrating a vibration component according to some embodiments of the present disclosure;

FIG. 24A is a schematic structural diagram illustrating a vibration component according to some embodiments of the present disclosure;

FIG. 24B is a schematic structural diagram illustrating a vibration component according to some embodiments of the present disclosure;

FIG. 24C is a schematic structural diagram illustrating frequency response curves of vibration components according to some embodiments of the present disclosure;

FIG. 25A is a schematic structural diagram illustrating a vibration component according to some embodiments of the present disclosure;

FIG. 25B is a schematic structural diagram illustrating a vibration component according to some embodiments of the present disclosure;

FIG. 25C is a schematic structural diagram illustrating a vibration component according to some embodiments of the present disclosure;

FIG. 26A is a schematic structural diagram illustrating a vibration component according to some embodiments of the present disclosure;

FIG. 26B is a schematic structural diagram illustrating a vibration component according to some embodiments of the present disclosure;

FIG. 26C is a schematic structural diagram illustrating a vibration component according to some embodiments of the present disclosure;

FIG. 26D is a schematic structural diagram illustrating a vibration component according to some embodiments of the present disclosure;

FIG. 26E is a schematic diagram illustrating a cross-sectional structure of a reinforcing member according to some embodiments of the present disclosure; and

FIG. 27 is a schematic structural diagram illustrating an exemplary loudspeaker according to some embodiments of the present disclosure.

Illustration of reference signs: vibration component: 100, 2710; elastic element: 110, 2711; central region: 112, 2711A; suspension region: 1121, 2711E; folded ring region: 114, 2711B; connection region: 115, 2711D; fixed region: 116, 2711C; reinforcing member: 120, 2712; ring structure: 122; first ring structure: 1221; second ring structure: 1222; third ring structure: 1223; central connection part: 123; strip structure: 124; first strip structure: 1241; second strip structure: 1242; third strip structure: 1243; reinforcing part: 125; local mass structure: 126; hollow part: 127; first resonance peak: 210; second resonance peak: 220; third resonance peak: 230; fourth resonance peak: 240; frequency response curve: 710; frequency response curve: 720; frequency response curve: 810, 820, 830, 910, 920, 940, 950, 1010, 1020, 1030, 1040, 1050, 1060, 1210, 1220, 1230; loudspeaker: 2700; driving component: 2720; driving unit: 2722; vibration transmission unit: 2724; housing: 2730; front cavity: 2731; first hole: 2732; rear cavity: 2733; second hole: 2734; damping mesh: 27341; and support element: 2740.

### DETAILED DESCRIPTION

In order to more clearly illustrate the technical solutions of the embodiments of the present disclosure, the following briefly introduces the drawings that need to be used in the description of the embodiments. Apparently, the accompanying drawings in the following description are only some examples or embodiments of the present disclosure, and those skilled in the art can also apply the present disclosure to other similar scenarios according to the drawings without creative efforts. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

The embodiments of the present disclosure provide a vibration component that is applicable to various acoustic output devices including, but not limited to, a loudspeaker, a hearing aid, etc. The vibration components provided in the embodiments of the present disclosure may mainly include an elastic element and a reinforcing member. The elastic element or the reinforcing member may be connected with a driving part of the loudspeaker. An edge of the elastic element may be fixed (e.g., connected with a housing of the loudspeaker). The driving part of the loudspeaker may serve as an electrical energy-mechanical energy conversion unit, which provides driving force for the loudspeaker by converting electrical energy into mechanical energy. The vibration component may receive a force or displacement transmitted by the driving part and generate a corresponding vibration output, thereby pushing the air to move to generate a sound pressure. The elastic element may be regarded being connected with an air inertia load through a spring and/or damping to radiate the sound pressure by pushing the air to move.

The clastic element may mainly include a central region, a folded ring region disposed at a periphery of the central region, and a fixed region disposed at a periphery of the folded ring region. In some embodiments, in order to make the loudspeaker have a relatively flat sound pressure level output within a relatively large range (e.g., 20 Hz-20 kHz), preset patterns may be designed in the folded ring region of the elastic element to destroy a vibration mode of the folded ring region of the elastic element in a corresponding frequency range, thereby avoiding sound cancellation caused by local segmented vibration of the elastic element. Meanwhile, a local stiffness of the clastic element may be increased by the design of the patterns. Furthermore, by designing a thickened structure in the central region of the clastic element, a stiffness of the central region of the clastic element may be increased, thereby avoiding sound cancellation caused by a segmented vibration mode of the central region of the clastic element of the loudspeaker within a range of 20 Hz-20 kHz. However, designing the thickened structure directly in the central region of the clastic element may increase an overall mass of the vibration component, increasing the load of the loudspeaker, and causing an impedance mismatch between a driving end and a load end, resulting in a reduction in the sound pressure level output by the loudspeaker. The vibration component provided by the embodiments of the present disclosure provides a structural design of the elastic element and the reinforcing member. The reinforcing member may include one or more ring structures and one or more strip structures. Each of the one or more strip structures may be connected with at least one of the one or more ring structures, so that the vibration component may present a required high-order mode at medium and high frequencies (above 3 kHz), thereby generating a plurality of resonance peaks on a frequency response curve of the vibration component, and making the vibration component having a relatively high sensitivity within a wide frequency range. Meanwhile, by the structural design of the reinforcing member, the mass of the vibration component may be smaller, which improves an overall sensitivity of the vibration component. In addition, by reasonably providing the reinforcing member and providing a plurality of hollow regions in the central region of the elastic element, the local stiffness of the central region of the elastic element is controllable and adjustable, thereby realizing controllable adjustment of the plurality of resonance peaks output by the vibration component using the segmented vibration modes of the plurality of hollow regions of the central region, and making the vibration component have a relatively flat sound pressure level curve. More details regarding the vibration component, the clastic element, and the reinforcing member may be found in the descriptions hereinafter.

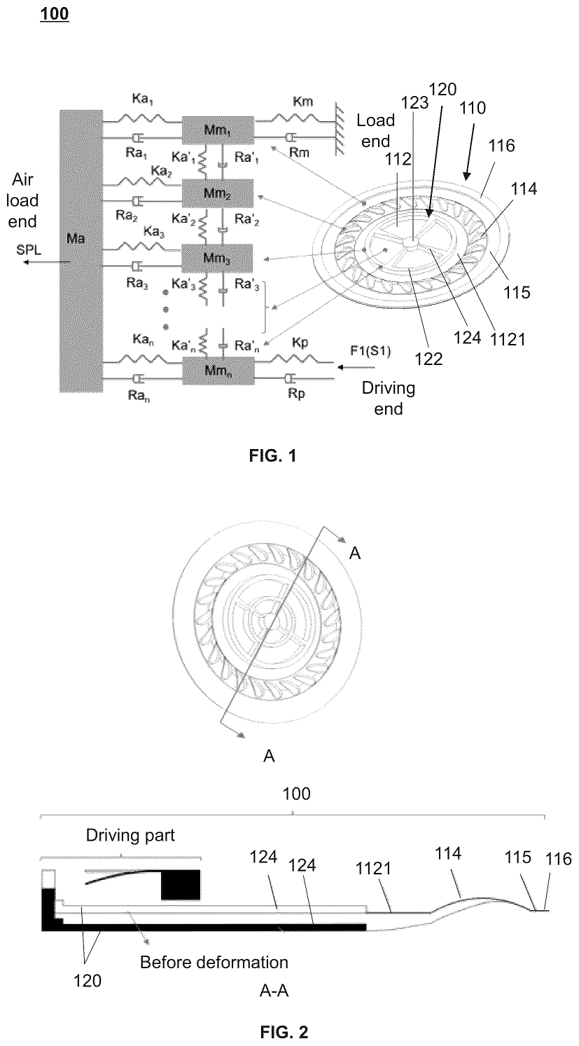

Referring to FIG. 1, FIG. 1 is a schematic diagram illustrating a vibration component and an equivalent vibration model thereof according to some embodiments of the present disclosure.

In some embodiments, a vibration component 100 may mainly include an elastic element 110. The clastic element 110 may include a central region 112, a folded ring region 114 disposed at a periphery of the central region 112, and a fixed region 116 disposed at a periphery of the folded ring region 114. The elastic element 110 may be configured to vibrate in a direction perpendicular to the central region 112 to transmit a force and displacement received by the vibration component 100 to push the air to move. The reinforcing member 120 may be connected with the central region 112. The reinforcing member may 120 include one or more ring structures 122 and one or more strip structures 124. Each of the one or more strip structures 124 may be connected with at least one of the one or more ring structures 122. At least one of the one or more strip structures 124 may extend toward a center of the central region 112. By reasonably configuring the reinforcing member 120 and providing a plurality of hollow regions in the central region 112 of the clastic element 110, a local stiffness of the central region 112 of the clastic element 110 is controllable and adjustable, thereby realizing controllable adjustment of a plurality of resonance peaks output by the vibration component using segmented vibration modes of the plurality of hollow regions of the central region 112, and making the vibration component 100 have a relatively flat sound pressure level curve. Meanwhile, the one or more ring structure 122 and the one or more strip structures 124 may cooperate with each other, so that the reinforcing member 120 may have an appropriate proportion of reinforcing parts and hollow parts (i.e., hollow parts), thereby reducing a mass of the reinforcing member 120 and improving an overall sensitivity of the vibration component 100. In addition, by designing shapes, dimensions, and counts of the one or more ring structures 122 and the one or more strip structures 124, positions of the plurality of resonance peaks of the vibration component 100 may be adjusted, thereby controlling a vibration output of the vibration component 100.

The elastic element 110 refers to an element capable of elastically deforming under the action of an external load. In some embodiments, the clastic element 110 may be a high-temperature-resistant material, so that the elastic element 110 may maintain performance during a manufacturing process when the vibration component 100 is applied to a loudspeaker. In some embodiments, when the clastic element 110 is in an environment of 200° C.-300° C., a Young's modulus and a shear modulus of the clastic element 110 may have no change or a very small change (e.g. a change within 5%). The Young's modulus characterizes a deformation capacity of the elastic element 110 when the elastic element 110 is stretched or compressed. The shear modulus characterizes a deformation capacity of the elastic element 110 when the clastic element 110 is sheared. In some embodiments, the clastic element 110 may be a material with a good elasticity (i.e., easy to elastically deform), so that the vibration component 100 may have a good vibration response capability. In some embodiments, a material of the clastic element 110 may be one or more of an organic polymer material, a glue material, or the like. In some embodiments, the organic polymer material may include polycarbonate (PC), polyamides (PA), acrylonitrile butadiene styrene (ABS), polystyrene (PS), high impact polystyrene (HIPS), polypropylene (PP), polyethylene terephthalate (PET), polyvinyl chloride (PVC), polyurethanes (PU), polyethylene (PE), phenol formaldehyde (PF), urea-formaldehyde (UF), melamine-formaldehyde (MF), polyarylate (PAR), polyetherimide (PEI), polyimide (PI), polyethylene naphthalate two formic acid glycol ester (PEN), polyetheretherketone (PEEK), carbon fibers, graphene, silica gel, or the like, or any combination thereof. In some embodiments, the organic polymer material may also include various adhesives, including but are not limited to gels, organic silica gels, acrylics, polyurethanes, rubbers, epoxy adhesives, hot melt adhesives, light curing adhesives, or the like. In some embodiments, the organic polymer material may include silicone bonding glues or silicone scaling glues.

In some embodiments, a Shore hardness of the clastic element 110 may be within a range of 1-50 HA. In some embodiments, the Shore hardness of the elastic element 110 may be within a range of 1-15 HA. In some embodiments, the Shore hardness of the clastic element 110 may be within a range of 14.9-15.1 HA.

In some embodiments, a Young's modulus of the clastic element 110 may be within a range of 5E8 Pa-1E10 Pa. In some embodiments, the Young's modulus of the clastic element 110 may be within a range of 1E9 Pa-5E9 Pa. In some embodiments, the Young's modulus of the clastic element 110 may be within a range of 1E9 Pa-4E9 Pa. In some embodiments, the Young's modulus of the clastic element 110 may be within a range of 2E9 Pa-5E9 Pa.

In some embodiments, a density of the elastic element 110 may be within a range of 1E3 kg/m³-4E3 kg/m³. In some embodiments, the density of the elastic element 110 may be within a range of 1E3 kg/m³-2E3 kg/m³. In some embodiments, the density of the clastic element 110 may be within a range of 1E3 kg/m³-3E3 kg/m³. In some embodiments, the density of the elastic element 110 may be within a range of 1E3 kg/m³-1.5 E3 kg/m³. In some embodiments, the density of the elastic element 110 may be within a range of 1.5E3 kg/m³-2E3 kg/m³.

In some embodiments, when the vibration component is applied to the loudspeaker, the central region 112 of the elastic element 110 may be directly connected with a driving part of the loudspeaker. In some embodiments, the reinforcing member 120 disposed in the central region 112 of the elastic element 110 may be directly connected with the driving part of the loudspeaker. The central region 112 of the elastic element 110 and the reinforcing member 120 may transmit a force and displacement of the driving part to push the air to move and output a sound pressure.

The central region 112 refers to a region of the elastic element 110 extending from a center (e.g., a centroid) to a circumferential side for a certain area. The reinforcing member 120 may be connected with the central region 112. The elastic element 110 may be configured to vibrate in a direction perpendicular to the central region 112. The central region 112 may serve as a main vibration region of the elastic element 110 to transmit the force and the displacement and output a vibration response.

The folded ring region 114 may be located at an outer side of the central region 112. In some embodiments, the folded ring region 114 may be designed with patterns of a specific shape, thereby destroying a vibration mode of the folded ring region 114 of the elastic element 110 within a corresponding frequency range, and avoiding sound cancellation caused by local segmented vibrations of the clastic element 110. In addition, a local stiffness of the elastic element 110 may be increased by the design of the patterns.

In some embodiments, the folded ring region 114 may include a folded ring structure. In some embodiments, by adjusting a folded ring width, a folded ring arch height, and other parameters of the folded ring structure, a stiffness of the folded ring region 114 corresponding to the folded ring structure may be different, and a frequency range of a corresponding high-frequency local segmented vibration mode may also be different. The folded ring width refers to a radial width of a projection of the folded ring region 114 in a vibration direction of the clastic element 110. The folded ring arch height refers to a height of the folded ring region 114 protruding from the central region 112 or the fixed region 116 in the vibration direction of the clastic element 110.

In some embodiments, a maximum area of a projection of the one or more ring structures 122 of the reinforcing member 120 in the vibration direction of the elastic element 110 may be smaller than an area of the central region 112. That is, a region not supported by the reinforcing member 120 may be provided between an outermost side of a projection of the reinforcing member 120 and the folded ring region 114. According to the present disclosure, a part of the central region 112 between the folded ring region 114 and the reinforcing member 120 may be referred to as a suspension region 1121. In some embodiments, an area of the suspension region 1121 may be adjusted by adjusting a maximum contour of the reinforcing member 120, thereby adjusting a modal vibration mode of the vibration component.

The fixed region 116 may be disposed at a periphery of the folded ring region 114. The elastic element 110 may be connected and fixed through the fixed region 116. For example, the clastic element 110 may be connected and fixed to a housing of the loudspeaker, or the like, through the fixed region 116. In some embodiments, the fixed region 116 may be installed and fixed in the housing of the loudspeaker and may be regarded as not participating in a vibration of the elastic element 110. In some embodiments, the fixed region 116 of the elastic element 110 may be connected to the housing of the loudspeaker through a support element. In some embodiments, the support element may include a soft material that is easy to deform, so that the support element may also deform during the vibration of the vibration component 100, thereby providing a greater displacement amount for the vibration of the vibration component 100. In some embodiments, the support element may also include a rigid material that is not easy to deform.

In some embodiments, the clastic element 110 may further include a connection region 115 disposed between the folded ring region 114 and the fixed region 116. In some embodiments, the connection region 115 may provide an additional stiffness and damping for the vibration of the clastic element 110, thereby adjusting the modal vibration mode of the vibration component 100.

In order to enable the elastic element 110 to provide an appropriate stiffness, a thickness and an elastic coefficient of the elastic element 110 may be set within a reasonable range. In some embodiments, the thickness of the elastic element 110 may be within a range of 3 um-100 um. In some embodiments, the thickness of the elastic element 110 may be within a range of 3 um-50 um. In some embodiments, the thickness of the elastic element 110 may be within a range of 3 um-30 um.

The reinforcing member 120 refers to an element configured to increase the stiffness of the elastic member 110. In some embodiments, the reinforcing member 120 may be connected with the central region 112. The reinforcing member 120 and/or the central region 112 may be connected with the driving part of the loudspeaker to transmit the force and/or displacement, thereby causing the vibration component 100 to push the air to move and output the sound pressure. The reinforcing member 120 may include the one or more ring structures 122 and the one or more strip structures 124. Each of the one or more strip structures 124 may be connected with at least one of the one or more ring structures 122 to form a staggered support in the central region 112 of the elastic element 110. At least one of the one or more strip structures 124 may extend toward the center of the central region 112. In some embodiments, the one or more strip structures 124 may pass through the center of the central region 112 to support the center of the central region 112. In some embodiments, the reinforcing member 120 may further include a central connection part 123. The one or more strip structures 124 may not pass through the center of the central region 112. The central connection part 123 may cover the center of the central region 112. The one or more strip structures 124 may be connected with the central connecting part 123.

The one or more ring structures 122 refer to structures extending around a specific center. In some embodiments, the center around which the one or more ring structures 122 extend may be the center of the central region 112. In some embodiments, the center around which the one or more ring structures 122 extend may also be another position of the central region 112 that is off-center. In some embodiments, the one or more ring structures 122 may be structures with closed contour lines. In some embodiments, projection shapes of the one or more ring structures 122 in the vibration direction of the elastic element 110 may include, but are not limited to, any one of a circular ring shape, a polygonal ring shape, a curved ring shape, or an elliptical ring shape, or any combination thereof. In some embodiments, the one or more structures 122 may also be structures with contour lines that are not closed. For example, the one or more ring structures 122 may include, but are not limited to, any one of a circular ring shape with a notch, a polygonal ring shape with a notch, a curved ring shape with a notch, or an elliptical ring shape with a notch, or any combination thereof. In some embodiments, a count of the one or more ring structures 122 may be one. In some embodiments, the count of the one or more structures 122 may exceed one and the one or more structures 122 may have a same centroid. In some embodiments, the count of the one or more ring structures 122 may be within a range of 1-10. In some embodiments, the count of the one or more ring structures 122 may be within a range of 1-5. In some embodiments, the count of the one or more ring structures 122 may be within a range of 1-3. If the count of the one or more ring structures 122 is too large, a mass of the reinforcing member 120 may be too large, thereby reducing the overall sensitivity of the vibration component 100. In some embodiments, the mass and the stiffness of the reinforcing member 120 may be adjusted by designing the count of the one or more ring structures 122. In some embodiments, a dimension of a ring structure 122 located at an outermost periphery of the reinforcing member 120 may be regarded as a maximum dimension of the reinforcing member. In some embodiments, a dimension (or an area) of the suspension region 1121 between the folded ring region 114 and the reinforcing member 120 may be adjusted by adjusting the dimension of the ring structure 122 located at the outermost periphery of the reinforcing member 120, thereby changing the modal vibration mode of the vibration component 100.

In some embodiments, the one or more ring structures 122 may include a first ring structure and a second ring structure. A radial dimension of the first ring structure may be less than a radial dimension of the second ring structure. In some embodiments, the first ring structure may be disposed at an inner side of the second ring structure. In some embodiments, a centroid of the first ring structure may coincide with a centroid of the second ring structure. In some embodiments, the centroid of the first ring structure may not coincide with the centroid of the second ring structure. In some embodiments, the first ring structure and the second ring structure may be connected through the one or more strip structures 124. In some embodiments, the first ring structure and the second ring structure may be adjacent ring structures. In some embodiments, the first ring structure and the second ring structure may also be non-adjacent ring structures. The one or more ring structures may be disposed between the first ring structure and the second ring structure.

The one or more strip structures 124 refer to structures with a certain extension rule. In some embodiments, the one or more strip structures 124 may extend along a straight line. In some embodiments, the one or more strip structures 124 may also extend along a curve. In some embodiments, a curve extension may include, but is not limited to, an arc-shaped extension, a spiral extension, a spline-shaped extension, a circular-arc-shaped extension, an S-shaped extension, or the like. In some embodiments, the one or more strip structures 124 may be connected with the one or more ring structures 122 to divide the reinforcing member 120 into a plurality of hollow parts. In some embodiments, regions of the central region 112 corresponding to the plurality of hollow parts may be referred to as hollow regions. In some embodiments, a count of the one or more strip structures 124 may be one. For example, one strip structure 124 may be arranged along any diameter direction of one ring structure 122 (e.g., any one of the one or more ring structures). In some embodiments, one strip structure 124 may be simultaneously connected with the center of the central region (i.e., the centroid of any one of the one or more ring structures 122) and any one of the one or more ring structures 122. In some embodiments, the one or more strip structures 124 may include a plurality of strip structures 124. In some embodiments, the plurality of strip structures 124 may be disposed in a plurality of diameter directions of the one or more ring structures 122. In some embodiments, at least a part of the plurality of strip structures 124 may extend toward the center of the central region 112, which may be the centroid of the elastic element 110. In some embodiments, the plurality of strip structures 124 may include another part of strip structures 124 extending in other directions. In some embodiments, at least a part of the plurality of strip structures 124 may be connected to the center of the central region and form the central connection part 123 at the center. In some embodiments, the central connection part 123 may also be a separate structure, and at least a part of the plurality of strip structures 124 may be connected with the central connection part 123. In some embodiments, a shape of the central connection part 123 may include, but is not limited to, a circle, a square, a polygon, an ellipse, or the like. In some embodiments, the shape of the central connection part 123 may also be set arbitrarily. In some embodiments, when the one or more ring structures 122 include the plurality of ring structures 122, adjacent ring structures 122 may be connected through the one or more strip structures 124. In some embodiments, the strip structures 124 connected between the adjacent ring structures 122 may extend toward the center of the central region 112, or may not extend toward the center of the central region 112.

In some embodiments, the count of the one or more strip structures 124 may be within a range of 1-100. In some embodiments, the count of the one or more strip structures 124 may be within a range of 1-50. In some embodiments, the count of the one or more strip structures 124 may be within a range of 1-50. In some embodiments, the count of the one or more strip structures 124 may be within a range of 1-30. By setting the count of the one or more strip structures 124, the overall mass of the vibration component 100, the stiffness of the reinforcing member 120, and the area of the plurality of hollow regions of the elastic element 110 may be adjusted, thereby changing the modal vibration mode of the vibration component.

In some embodiments, a shape of a projection of the one or more strip structures 124 in the vibration direction of the elastic element 110 may include at least one of a rectangle, a trapezoid, a curve, an hourglass shape, and a petal shape. By designing different shapes of strip structures 124, a mass distribution (e.g. a centroid position) of the reinforcing member 120, the stiffness of the reinforcing member 120, and the area of the plurality of hollow regions may be adjusted, thereby changing the modal vibration mode of the vibration component.

It should be noted that the structural description of the one or more ring structures 122 and the one or more strip structures 124 in the embodiments of the present disclosure is only an optional structure selected to facilitate the reasonable arrangement of the structure of the reinforcing member 120, and should not be understood as a limitation to the shapes of the reinforcing member 120 and components thereof. In fact, the reinforcing member 120 in the embodiments of the present disclosure may form a reinforcing part and a plurality of hollow parts (i.e., the plurality of hollow part corresponding to the plurality of hollow regions of the central region 112) located between the one or more ring structures 122 and the one or more strip structures 124. A region where the one or more ring structures 122 are located and a region where the one or more strip structures 124 are located may form the reinforcing part. Within a projection range of a largest contour of the reinforcing member 120 in the vibration direction of the clastic element 110, regions not covered by the one or more ring structures 122 and the one or more strip structures 124 may form the plurality of hollow parts. By adjusting parameters (e.g., an area, a thickness of the reinforcing part, etc.) of the reinforcing part and the plurality of hollow parts, vibration characteristics (e.g., a count and a frequency range of resonance peaks) of the vibration component 100 may be adjusted. In other words, any shape of reinforcing member with the reinforcing part and the plurality of hollow parts may be set using a parameter setting manner of the reinforcing part and the plurality of hollow parts provided in present disclosure to adjust vibration performance (e.g., the count and positions of the resonance peaks, a shape of a frequency response curve, etc.) of the vibration component, which should be included in the scope of the present disclosure.

In some embodiments, referring to FIG. 1, the connection region 115 between the fixed region 116 of the clastic element 110 and the folded ring region 114 may be suspended. An equivalent mass of the connection region 115 may be Mm₁. Since the elastic element 110 can provide elasticity and damping, the connection region 115 may be equivalent to be fixedly connected with the housing through a spring Km and damping Rm. Meanwhile, the connection region 115 may be connected with a front air load of the clastic element 110 through a spring Ka₁ and damping Ra₁ to transmit the force and the displacement, thereby pushing the air to move.

In some embodiments, the folded ring region 114 of the elastic element 110 may have a local equivalent mass Mm₂, and the folded ring region 114 may be connected with the connection region 115 of the clastic element 110 through a spring Ka₁′ and damping Ra₁′. Meanwhile, the folded ring region 114 may be connected with the front air load of the clastic element 110 through a spring Ka₂ and damping Ra₂ to transmit the force and the displacement, thereby pushing the air to move.

In some embodiments, the reinforcing member 120 may be disposed in the central region 112 of the clastic element 110. The reinforcing member 120 may be connected with the central region 112 of the clastic element 110. A contact area between the reinforcing member 120 and the central region 112 is less than an area of the central region 112, so that a part of suspension region 1121 may be disposed between a region of the central region 112 of the elastic element 110 supported by the reinforcing member 120 and the folded ring region 114. The suspension region 1121 may have a local equivalent mass Mm₃ and may be connected with the folded ring region 114 through a spring Ka₂′ and damping Ra₂′. Meanwhile, the region where the reinforcing member 120 is located may be connected with the front air load of the clastic element 110 through a spring Ka₃ and damping Ra₃ to transmit the force and the displacement, thereby pushing the air to move.

In some embodiments, due to the design of the reinforcing member 120, the central region 112 of the clastic element 110 corresponding to the reinforcing member 120 may have no less than one hollow region. Each hollow region may be equivalent to a mass-spring-damping system and have an equivalent mass Mmᵢ, equivalent stiffnesses Kai and Kai′, and equivalent damping Raᵢ and Raᵢ′. The hollow region may be connected with an adjacent hollow region through the spring Kaᵢ′ and the damping Raᵢ′. The hollow region may also be connected with, through the spring Kai′ and the damping Rai′, the suspension region 1121 disposed between the region supported by the reinforcing member 120 in the central region 112 and the folded ring region 114. Meanwhile, the suspension region 1121 may be connected with the front air load of the elastic element 110 through the spring Kaᵢ and the damping Raᵢ to transmit the force and the displacement, thereby pushing the air to move.

In some embodiments, the reinforcing member 120 may have an equivalent mass Mmₙ, and the reinforcing member 120 may be connected with the central region 112 through a spring Kaₙ′ and damping Raₙ′, while the reinforcing member 120 may be connected with the front air load of the clastic element 110 through a spring Kaₙ and damping Raₙ. When the reinforcing member 120 generates a resonance, the reinforcing member 120 may drive the central region 112 to drive the clastic element 110 to produce a relatively large movement speed and displacement, thereby producing a relatively large sound pressure level.

According to the dynamic characteristics of the mass-spring-damping system, each mass-spring-damping system has its own resonance peak frequency f₀. A large movement speed and displacement may occur at f₀. By designing different parameters (e.g., structural parameters of the clastic elements 110 and/or the reinforcing member 120) of the vibration component 100, the mass-spring-damping system formed by structures at different positions of the vibration component 100 may resonate within a required frequency range, thereby causing a frequency response curve of the vibration component 100 to have a plurality of resonance peaks, which greatly broadens an effective frequency band of the vibration component 100. In addition, by designing the reinforcing member 120, the vibration component 100 may have a lighter mass, and the vibration component 100 may have a higher sound pressure level output.

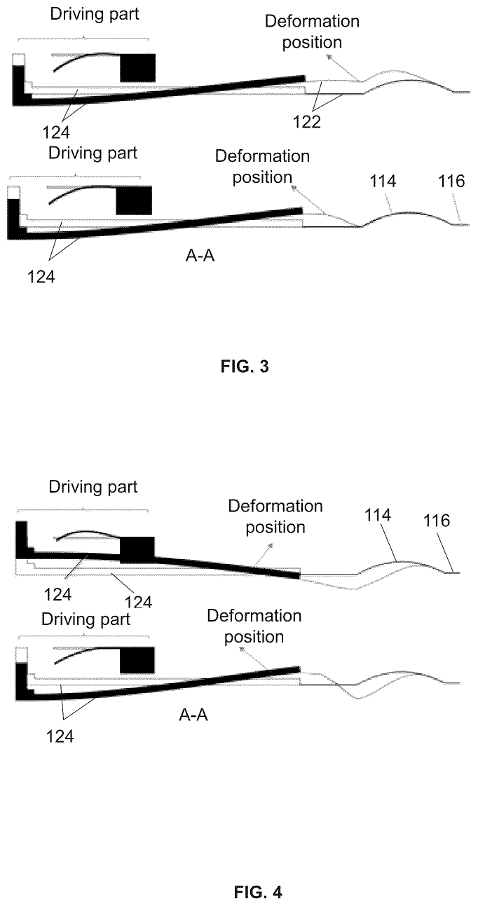

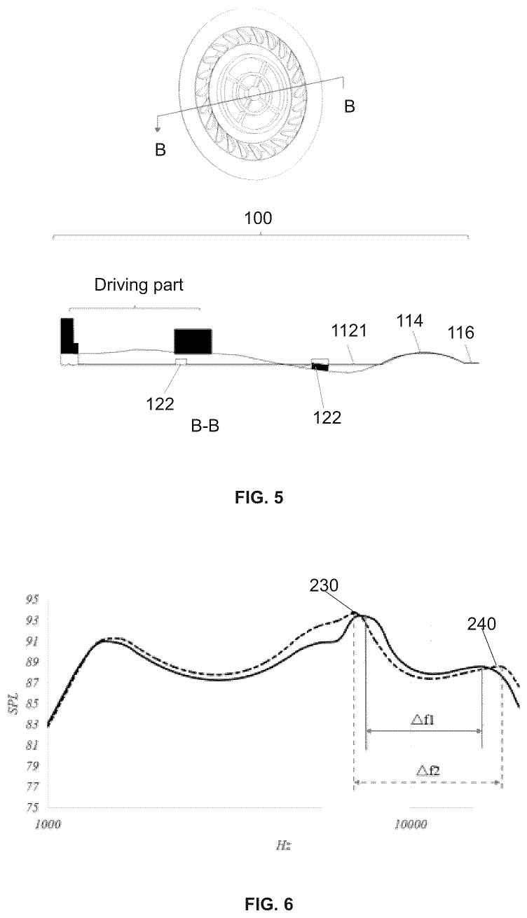

FIG. 2 is a schematic diagram illustrating a deformation of a vibration component at a first resonance peak according to some embodiments of the present disclosure. FIG. 3 is a schematic diagram illustrating deformations of a vibration component at a second resonance peak according to some embodiments of the present disclosure. FIG. 4 is a schematic diagram illustrating deformations of a vibration component at a third resonance peak according to some embodiments of the present disclosure. FIG. 5 is a schematic diagram illustrating a deformation of a vibration component at a fourth resonance peak according to some embodiments of the present disclosure.

According to the schematic diagram of the equivalent vibration model of the vibration component 100 illustrated in FIG. 1, each part of the vibration component 100 may generate speed resonances in different frequency ranges, causing to output a relatively large speed value in a corresponding frequency band, thereby causing the frequency response curve of the vibration component 100 to have a relatively large sound pressure value in the corresponding frequency range and have a corresponding resonance peak. Meanwhile, a frequency response of the vibration component 100 may have a relatively high sensitivity within an audible range (e.g., 20 Hz-20 kHz) through the plurality of resonance peaks.

As illustrated in FIG. 1 and FIG. 2, in some embodiments, a mass of the reinforcing member 120, a mass of the clastic element 110, an equivalent air mass, and a driving end equivalent mass may be combined to form a total equivalent mass Mt, and the equivalent damping of each part may form a total equivalent damping Rt. The clastic element 110 (especially the folded ring region 114, and the clastic element 110 in the suspension region between the folded ring region 114 and the reinforcing member 120) may have a great compliance, providing a stiffness Kt for the system, thereby forming a mass Mt-spring Kt-damping Rt system having a resonance frequency. When a driving end excitation frequency is close to a speed resonance frequency of the system, the system may generate a resonance (as illustrated in FIG. 2), and output a relatively large speed value vₐ within a frequency range near the speed resonance frequency of the Mt-Kt-Rt system. Since an output sound pressure amplitude of the vibration component 100 is positively correlated to the sound speed (pₐ∝vₐ), a resonance peak may appear in the frequency response curve. The resonance peak is defined as a first resonance peak of the vibration component 100 in present disclosure. In some embodiments, referring to FIG. 2, FIG. 2 illustrates a vibration condition of the vibration component 100 at an A-A cross-sectional position. A white structure in FIG. 2 represents a shape and a position of the reinforcing member 120 before deformation, and a black structure in FIG. 2 represents a shape and a position of the reinforcing member 120 at the first resonance peak. It should be noted that FIG. 2 only illustrates a structural condition of the vibration component 100 from a center of the reinforcing member 120 to one edge of the clastic element 110 on the A-A cross section, i.e., a half of the A-A cross section. The other half of the A-A cross section not shown is symmetrically to the structural condition illustrated in FIG. 2. It can be seen from the vibration of the vibration component 100 at the A-A cross-sectional position that at the position of the first resonance peak, a main deformation position of the vibration component 100 may be a part of the clastic element 110 connected with the fixed region 116. In some embodiments, a frequency of the first resonance peak of the vibration component 100 (also referred to as a first resonance frequency) may be related to a ratio of a mass of the vibration component 100 to an elastic coefficient of the elastic element 110. In some embodiments, the frequency of the first resonance peak may be within a range of 180 Hz-3000 Hz. In some embodiments, the frequency of the first resonance peak may be within a range of 200 Hz-3000 Hz. In some embodiments, the frequency of the first resonance peak may be within a range of 200 Hz-2500 Hz. In some embodiments, the frequency of the first resonance peak may be within a range of 200 Hz-2000 Hz. In some embodiments, the frequency of the first resonance peak may be within a range of 200 Hz-1000 Hz. In some embodiments, by configuring the structure of the reinforcing member 120, the first resonance peak of the vibration component 100 may be located within the above frequency range.

As illustrated in FIG. 1 and FIG. 3, the connection region 115 between the fixed region 116 of the clastic element 110 and the folded ring region 114 may be suspended. This region may have an equivalent mass Mm₁, and this region may be fixedly connected with the housing through a spring Km and damping Rm. Meanwhile, the connection region 115 may be connected with a front air load of the clastic element 110 through a spring Ka₁ and damping Ra₁ to transmit a force and a displacement, thereby pushing the air to move.

The folded ring region 114 may have a local equivalent mass Mm₂, and this region may be connected with the connection region 115 through a spring Ka₁′ and damping Ra₁′. Meanwhile, the folded ring region 114 may be connected with the front air load of the elastic element 110 through a spring Ka₂ and damping Ra₂ to transmit the force and the displacement, thereby pushing the air to move.

The suspension region 1121 may be disposed between a region of the central region 112 provided with the reinforcing member 120 and the folded ring region 114. The suspension region 1121 may have a local equivalent mass Mm₃, and the suspension region 1121 may be connected with the folded ring region 114 through a spring Ka₂′ and damping Ra₂′. Meanwhile, the region where the reinforcing member 120 is located may be connected with the front air load of the clastic element 110 through a spring Ka₃ and damping Ra₃ to transmit the force and the displacement, thereby pushing the air to move.

The above three parts may form an equivalent mass Ms, an equivalent stiffness Ks, and equivalent damping Rs, forming a mass Ms-spring Ks-damping Rs system. Furthermore, the system may have a resonance frequency. When a driving end excitation frequency is close to a speed resonance frequency of the Ms-Ks-Rs system, the system may generate a resonance and output a relatively large speed value vₐ within a frequency range near a speed resonance frequency of the Ms-Ks-Rs system. Since an output sound pressure amplitude of the vibration component 100 is positively correlated to the sound speed (pₐ∝vₐ), a resonance peak may appear in a frequency response curve, which is defined as a second resonance peak of the vibration component 100 in present disclosure. The second resonance peak may be mainly generated by a vibration mode of the connection region 115, the folded ring region 114, and the suspension region disposed between the region of the central region 112 provided with the reinforcing member 120 and the folded ring region 114. As illustrated in FIG. 3, FIG. 3 illustrates deformation positions of the vibration component 100 before the second resonance peak (an upper structural diagram in FIG. 3) and after the second resonance peak (a lower structural diagram in FIG. 3), respectively. In some embodiments, as illustrated in FIG. 3, it can be seen from the vibration of the vibration component 100 at the A-A cross-sectional position that before and after a frequency of the second resonance peak, main deformation positions of the vibration component 100 may be the folded ring region 114 and the suspension region 1121. In some embodiments, the frequency (also referred to as the second resonance frequency) of the second resonance peak of the vibration component 100 may be related to a ratio of a mass of the clastic element 110 to an elastic coefficient of the clastic element 110. In some embodiments, the frequency of the second resonance peak of the vibration component 100 may be within a range of 1000 Hz-10000 Hz. In some embodiments, the frequency of the second resonance peak of the vibration component 100 may be within a range of 3000 Hz-7000 Hz. In some embodiments, the frequency of the second resonance peak of the vibration component 100 may be within a range of 3000 Hz-6000 Hz. In some embodiments, the frequency of the second resonance peak of the vibration component 100 may be within a range of 4000 Hz-6000 Hz. In some embodiments, by arranging the structure of the reinforcing member 120, the frequency of the second resonance peak of the vibration component 100 may be within the above frequency range.

As illustrated in FIG. 1 and FIG. 4, the reinforcing member 120 may have an equivalent mass Mmₙ, and the reinforcing member 120 may be connected with the central region 112 through the spring Kaₙ′ and the damping Raₙ′, while the reinforcing member 120 may be connected with the front air load of the clastic element 110 through the spring Kaₙ and the damping Raₙ. When the reinforcing member 120 generates the resonance, the reinforcing member 120 may drive the central region 112 to drive the elastic element 110 to produce a relatively large movement speed and displacement, thereby producing a relatively large sound pressure level.

The reinforcing member 120, the connection region 115, the folded ring region 114, the suspension region 121 disposed between the region of the central region 112 provided with the reinforcing member 120 and the folded ring region 114, an equivalent air mass, and a driving end equivalent mass combination may form a total equivalent mass Mt₁, and the equivalent damping of each part may form total equivalent damping Rt₁. The reinforcing member 120 and the clastic element 110 (especially the region of the central region 112 covered by the reinforcing member 120) may have a relatively large stiffness, providing a stiffness Kt₁ for the system, thereby forming a mass Mt₁-spring Kt₁-damping Rt₁ system. The system may have a vibration mode of flipping motion in which a ring region in a diameter direction of the central region 112 is taken as an equivalent fixed fulcrum and movements inside and outside the ring region are in opposite directions. The connection region 115, the folded ring region 114, the suspension region 121 disposed between the region of the central region 112 provided with the reinforcing member 120 and the folded ring region may be driven by the reinforcing member 120 to vibrate, thereby achieving a resonance mode with the flipping motion as the vibration mode (as illustrated in FIG. 4). The resonance may also be a resonance frequency point of the equivalent mass Mt₁-spring Kt₁-damping Rt₁ system. When the driving end excitation frequency is close to the speed resonance frequency of the system, the Mt₁-Kt₁-Rt₁ system may generate a resonance, and output a relatively large speed value vₐ within a frequency range near the speed resonance frequency of the Mt₁-Kt₁-Rt₁ system. Since an output sound pressure amplitude of the vibration component 100 is positively correlated to the sound speed (pₐ∝vₐ), a resonance peak may appear in a frequency response curve, which is defined as a third resonance peak of the vibration component 100 in present disclosure. As illustrated in FIG. 4, FIG. 3 illustrates deformation positions of the vibration component 100 before the third resonance peak (an upper structural diagram in FIG. 4) and after the third resonance peak (a lower structural diagram in FIG. 4), respectively. It can be seen from the vibration of the vibration component 100 at the A-A cross-sectional position that before and after a frequency of the third resonance peak, main deformation positions of the vibration component 100 may be the flipping deformation of the reinforcing member 120. In some embodiments, the third resonance peak of the vibration component may be correlated to a stiffness of the reinforcing member 120. In some embodiments, a frequency of the third resonance peak may be within a range of 5000 Hz-12000 Hz. In some embodiments, the frequency of the third resonance peak may be within a range of 6000 Hz-12000 Hz. In some embodiments, the frequency of the third resonance peak may be within a range of 6000 Hz-10000 Hz. In some embodiments, by arranging the structure of the reinforcing member 120, the frequency of the second resonance peak of the vibration component 100 may be within the above frequency range.

As illustrated in FIG. 1 and FIG. 5, the central region 112 of the elastic element 110 corresponding to the reinforcing member 120 may have not less than one hollow region. Each hollow region may be equivalent to a mass-spring-damping system and have an equivalent mass Mmᵢ, equivalent stiffnesses Kai and Kai′, and equivalent damping Raᵢ and Raᵢ′. The hollow region may be connected with an adjacent hollow region through the spring Kaᵢ′ and the damping Raᵢ′. The hollow region may also be connected with, through the spring Kai′ and the damping Rai′, the suspension region 1121 disposed between the region supported by the reinforcing member 120 in the central region 112 and the folded ring region 114. Meanwhile, the suspension region 1121 may be connected with the front air load of the clastic element 110 through the spring Kaᵢ and the damping Raᵢ to transmit the force and the displacement, thereby pushing the air to move.

Since the one or more hollow regions are separated by the one or more strip structures 124 of the reinforcing member 120, each hollow region may form a different resonance frequency, and separately push an air domain connected with the hollow region to move to generate a corresponding sound pressure. Furthermore, by designing a position, a dimension, and a count of each strip structure 124 of the reinforcing member 120, various hollow regions with different resonance frequencies may be realized, so that the frequency response curve of the vibration component 100 may have not less than one high-frequency resonance peak (i.e., a fourth resonance peak). In some embodiments, a frequency of the not less than one high-frequency resonance peak (i.e., the fourth resonance peak) as described above may be within a range of 10000 Hz-18000 Hz.

Furthermore, in order to increase the sound pressure level output by the vibration component 100 at a high frequency (10000 Hz-20000 Hz), the position, the dimension, and the count of the strip structure 124 may be designed to make the resonance frequency of each hollow region equal or close. In some embodiments, a frequency difference between the resonance frequencies of the one or more hollow regions may be within a range of 4000 Hz, so that the frequency response curve of the vibration component 100 may have a high-frequency resonance peak with a relatively large output sound pressure level, which is defined as the fourth resonance peak (as illustrated in FIG. 5) of the vibration component 100 in the present disclosure. In some embodiments, as illustrated in FIG. 5, it can be known from the vibration of the vibration component 100 at a B-B cross-sectional position that main deformation positions of the vibration component 100 may be deformations caused by the one or more hollow regions of the central region 112 near a frequency of the fourth resonance peak (also referred to as a fourth resonance frequency). In some embodiments, the frequency of the fourth resonance peak may be within a range of 8000 Hz-20000 Hz. In some embodiments, the frequency of the fourth resonance peak may be within a range of 10000 Hz-18000 Hz. In some embodiments, the frequency of the fourth resonance peak may be within a range of 12000 Hz-18000 Hz. In some embodiments, the frequency of the fourth resonance peak may be within a range of 15000 Hz-18000 Hz. In some embodiments, by designing an area of the one or more hollow regions and a thickness of the elastic element 110, the resonance frequency of each of the one or more hollow regions may be adjusted, so that the fourth resonance peak of the vibration component 100 may be located within the above frequency range. In some embodiments, in order to make the frequency of the fourth resonance peak of the vibration component 100 fall within the above frequency range, a ratio of the area of each of the one or more hollow regions to the thickness of the elastic element 110 may be within a range of 100 mm-1000 mm. In some embodiments, in order to make the frequency of the fourth resonance peak of the vibration component 100 fall within the above frequency range, the ratio of the area of each of the one or more hollow regions to the thickness of the clastic element 110 may be within a range of 120-900 mm. In some embodiments, in order to make the frequency of the fourth resonance peak of the vibration component 100 fall within the above frequency range, the ratio of the area of each of the one or more hollow regions to the thickness of the clastic element 110 may be within a range of 150 mm-800 mm. In some embodiments, in order to make the frequency of the fourth resonance peak of the vibration component 100 fall within the above frequency range, the ratio of the area of each of the one or more hollow regions to the thickness of the clastic element 110 may be within a range of 150 mm-700 mm.

As illustrated in FIG. 6, FIG. 6 illustrates frequency response curves of vibration components 100 with different differences between a frequency of a third resonance peak and a frequency of a fourth resonance peak according to some embodiments of the present disclosure. An abscissa represents a frequency (Hz), and an ordinate represents sensitivity (SPL). By designing structures of the reinforcing members 120 and the clastic element 110, the vibration component 100 may generate a plurality of resonance peaks within an audible range. Furthermore, with a combination of the plurality of resonance peaks, etc., the vibration component 100 may have a relatively high sensitivity within the entire audible range. By designing the one or more strip structures 124 and the one or more ring structures 122 of the reinforcing member 120, the fourth resonance peak 240 of the vibration component 100 may be located within different frequency ranges. By designing a difference Δf between the frequency of the fourth resonance peak 240 and the frequency of the third resonance peak 230, a relatively flat frequency response curve and a relatively high sound pressure level within a frequency range between the fourth resonance peak 240 and the third resonance peak 230 may be output, thereby avoiding a valley in the frequency response curve. As illustrated in FIG. 6, if the difference Δf between the frequency of the fourth resonance peak 240 and the frequency of the third resonance peak 230 is excessively large (e.g., Δf₂ as illustrated in FIG. 6), the valley may occur within the frequency range between the fourth resonance peak 240 and the third resonance peak 230, and the output sound pressure level may decrease. If the difference Δf between the frequency of the fourth resonance peak 240 and the frequency of the third resonance peak 230 is excessively small (e.g., Δf₁ as illustrated in FIG. 6), the frequency of the fourth resonance peak 240 may decrease, a sound pressure level within a high-frequency frequency range (e.g., 12 kHz-20 kHz) may decrease, and a frequency band of the vibration component 100 may be narrowed. By adjusting the structures of the reinforcing member 120 and the clastic element 110, the third resonance peak 230 may be moved to the left and/or the fourth resonance peak 240 may be moved to the right, thereby increasing the difference Δf between the frequency of the fourth resonance peak 240 and the frequency of the third resonance peak 230. In some embodiments, the difference Δf between the frequency of the fourth resonance peak 240 and the frequency of the third resonance peak 230 may be within a range of 80 Hz-15000 Hz. In some embodiments, the difference Δf between the frequency of the fourth resonance peak 240 and the frequency of the third resonance peak 230 may be within a range of 100 Hz-13000 Hz. In some embodiments, the difference Δf between the frequency of the fourth resonance peak 240 and the frequency of the third resonance peak 230 may be within a range of 200 Hz-12000 Hz. In some embodiments, the difference Δf between the frequency of the fourth resonance peak 240 and the frequency of the third resonance peak 230 may be within a range of 300 Hz to 11000 Hz. In some embodiments, the difference Δf between the frequency of the fourth resonance peak 240 and the frequency of the third resonance peak 230 may be within a range of 400 Hz-10000 Hz. In some embodiments, the difference Δf between the frequency of the fourth resonance peak 240 and the frequency of the third resonance peak 230 may be within a range of 500 Hz-9000 Hz. In some embodiments, the difference Δf between the frequency of the fourth resonance peak 240 and the frequency of the third resonance peak 230 may be within a range of 200 Hz-11000 Hz. In some embodiments, the difference Δf between the frequency of the fourth resonance peak 240 and the frequency of the third resonance peak 230 may be within a range of 200 Hz-10000 Hz. In some embodiments, the difference Δf between the frequency of the fourth resonance peak 240 and the frequency of the third resonance peak 230 may be within a range of 2000 Hz-15000 Hz. In some embodiments, the difference Δf between the frequency of the fourth resonance peak 240 and the frequency of the third resonance peak 230 may be within a range of 3000 Hz-14000 Hz. In some embodiments, the difference Δf between the frequency of the fourth resonance peak 240 and the frequency of the third resonance peak 230 may be within a range of 4000 Hz-13000 Hz.

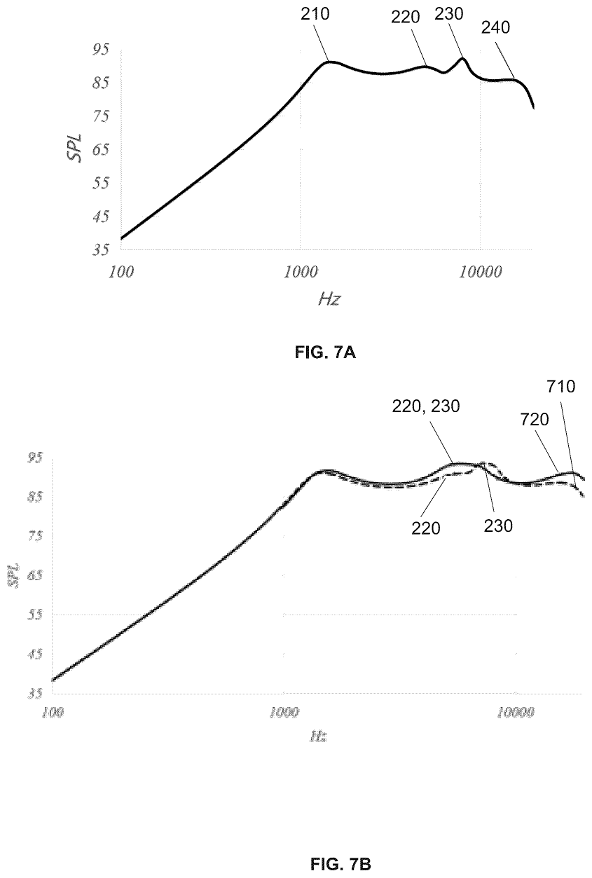

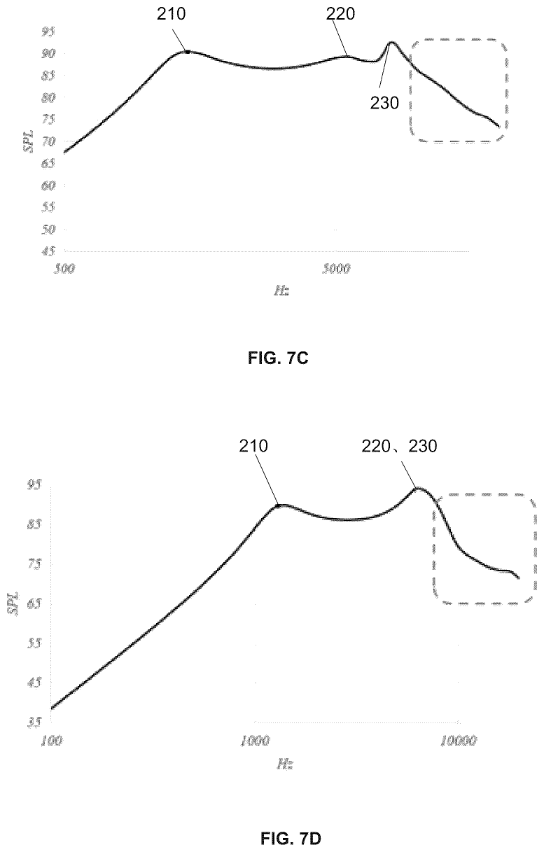

As illustrated in FIG. 7A, by designing the structures of the reinforcing member 120 and the clastic element 110, the vibration component 100 may present a required high-order mode within the audible range (20 Hz-20000 Hz) of the human cars, and the first resonance peak 210, the second resonance peak 220, the third resonance peak 230, and the fourth resonance peak 240 may appear on the frequency response curve of the vibration component 100, i.e., four resonance peaks may be generated on the frequency response curve of the vibration component 100 within the frequency range of 20 Hz-20000 Hz, which makes the vibration component 100 have a relatively high sensitivity within a relatively wide frequency range.

In some embodiments, by designing the structures of the reinforcing member 120 and the clastic element 110, the vibration component 100 may have only three resonance peaks within the audible range (20 Hz-20000 Hz). For example, when a difference between a frequency of the second resonance peak and a frequency of the third resonance peak of the vibration component 100 is less than 2000 Hz, the second resonance peak and the third resonance peak may present as one resonance peak on a frequency response curve of the vibration component 100. As another example, the central region 112 corresponding to the reinforcing member 120 may have not less than one suspension region. When the resonance frequency of each hollow region is higher than the audible range, or the resonance frequency of each hollow region is different and vibration phases of different suspension regions within different frequency ranges are different within a high frequency range (10000 Hz-18000 Hz), resulting in an effect of sound superposition and cancellation, a high-frequency roll-off effect may be obtained, and the fourth resonance may not be reflected on the frequency response curve of the vibration component 100.

As illustrated in FIG. 7B, FIG. 7B is a schematic diagram illustrating overlapping of a second resonance peak and a third resonance peak according to some embodiments of the present disclosure. In some embodiments, by designing a structure and a dimension of the reinforcing member 120, including an overall dimension of the reinforcing member 120, a count and a dimension of the one or more strip structures 124, an arrangement position of the one or more strip structures 124, an area of the suspension region disposed between the region of the central region 112 provided with the reinforcing member 120, a pattern design (e.g., a folded ring width, a folded ring arch height, and a folded ring arch) of the folded ring region 114, and an area of the connection region 115, the difference between the frequency of the second resonance peak 220 and the frequency of the third resonance peak 230 may be adjusted. In some embodiments, when the difference between the frequency of the second resonance peak 220 and the frequency of the third resonance peak 230 is within a range of 2000 Hz-3000 Hz, a valley may not occur between the second resonance peak 220 and the third resonance peak 230 on the frequency response curve (e.g., a frequency response curve 710) of the vibration component 100, and the second resonance peak 220 and the third resonance peak 230 (corresponding to dotted lines in the figure) may still be distinguished on the frequency response curve. In some embodiments, when the difference between the frequency of the second resonance peak 220 and the frequency of the third resonance peak 230 further decreases, for example, less than 2000 Hz, the second resonance peak 220 and the third resonance peak 230 may present as one resonance peak (corresponding to a solid line in the figure) on the frequency response sound pressure level curve (e.g., a frequency response curve 720) of the vibration component 100, making the vibration component have a relatively high sensitivity in a medium and high frequency range (3000 Hz-10000 Hz).

By designing the one or more ring structures 122 and the one or more strip structure 124 of the reinforcing member 120, the central region 112 corresponding to the reinforcing member 120 may have not less than one hollow region. Each hollow region may be a mass-spring-damping system. By designing a position, a dimension, and a count of each of the one or more strip structures 124 of the reinforcing member 120, the resonance frequency of each hollow region may be equal or close to each other. In some embodiments, a difference between the resonance frequencies of the one or more hollow regions may be within a range of 4000 Hz, so that one or more high-frequency resonance peaks (i.e., the fourth resonance peak) with large output sound pressure levels may be generated on the frequency response curve of the vibration component 100.

In some embodiments, as illustrated in FIG. 7C, by designing a position, a dimension, and a count of each of the one or more strip structure 124 of the reinforcing member 120, a resonance frequency of each of one or more hollow regions may be higher than an audible range, or the resonance frequency of each of the one or more hollow regions may be different, and vibration phases of different hollow regions within different frequency ranges of a high frequency range (10000 Hz-18000 Hz) may be different, resulting in an effect of sound superposition and cancellation, so that a high-frequency roll-off effect may be obtained, and the fourth resonance may not be reflected on the sound pressure level frequency response curve of the vibration component 100.

As illustrated in FIG. 7D, FIG. 7D is a schematic diagram illustrating a frequency response curve of the vibration component 100 having two resonance peaks according to some embodiments of the present disclosure. In some embodiments, by designing a structure of the reinforcing member 120, when a difference between a frequency of the second resonance peak 220 and a frequency of the third resonance peak 230 is less than 2000 Hz, the second resonance peak 220 and the third resonance peak 230 may present as one resonance peak on the frequency response sound pressure level curve of the vibration component 100. In addition, by designing a position, a dimension, and a count of each of the one or more strip structure 124 of the reinforcing member 120, a resonance frequency of each of one or more hollow regions may be higher than an audible range, or the resonance frequency of each of the one or more hollow regions may be different, and vibration phases of different hollow regions within different frequency ranges of a high frequency range (10000 Hz-18000 Hz) may be different, resulting in an effect of sound superposition and cancellation, so that a high-frequency roll-off effect may be obtained, and the fourth resonance may not be reflected on the sound pressure level frequency response curve of the vibration component 100. Then the vibration component 100 may have output characteristics of a certain bandwidth and a relatively high sensitivity within a medium and high frequency range (3000 Hz-10000 Hz).

In some embodiments, by designing an area and a thickness of the suspension region 1121 and the folded ring region 114 of the elastic element 110, the second resonance peak of the vibration component 100 may be maintained in a required frequency range. In some embodiments, the second resonance peak of the vibration component 100 may be within a range of 1000 Hz-10000 Hz. In some embodiments, the second resonance peak of the vibration component 100 may be within a range of 3000 Hz-7000 Hz. In some embodiments, when designing the difference between the frequency of the second resonance peak and the frequency of the third resonance peak of the vibration component 100, the difference between the frequency of the second resonance peak and the frequency of the third resonance peak may be less than 3000 Hz.

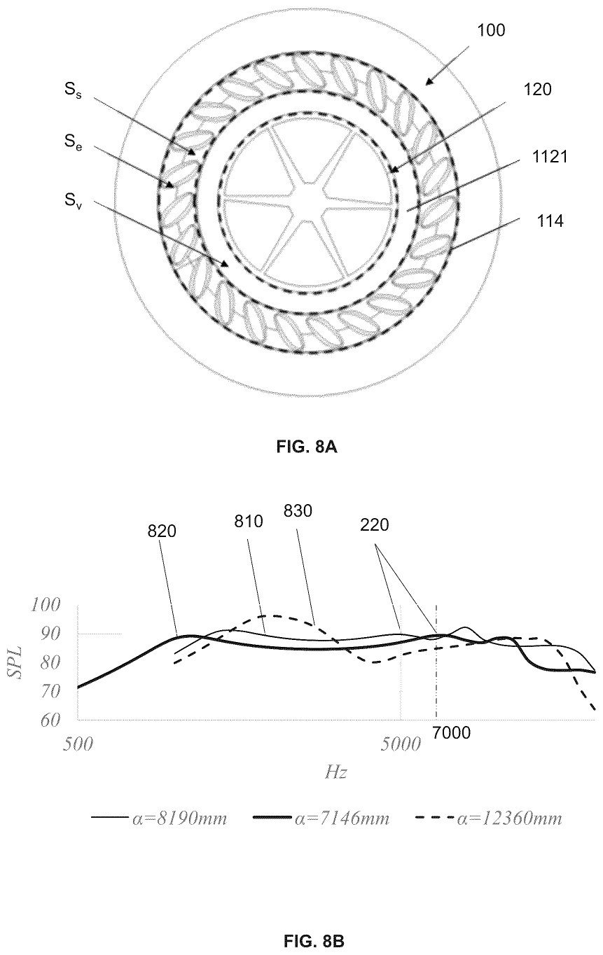

As illustrated in FIG. 8A, FIG. 8A is a schematic structural diagram illustrating a vibration component including a reinforcing member with a single-ring structure according to some embodiments of the present disclosure. In some embodiments, a horizontal plane projection area (i.e., a projection area of the suspension region 1121 in a vibration direction of the elastic element 110) of the suspension region 1121 is defined as Sᵥ, a horizontal plane projection area (i.e., a projection area of the folded ring region 114 in the vibration direction of the clastic element 110) of the folded ring region 114 is defined as Sₑ, and a sum of the horizontal plane projection area Sᵥ of the suspension region 1121 and the horizontal plane projection area Sₑ of the folded ring region 114 is defined as Sₛ. A physical quantity α (mm) is defined as a ratio of Sₛ to a thickness Hi of the elastic element 110 (also referred to as a diaphragm):

$$α = \frac{{S}_{s}}{{H}_{i}} . \qquad ( Equation 1 )$$

In some embodiments, in order to make the frequency of the second resonance peak of the vibration component 100 to be within a range of 3000 Hz-7000 Hz, the ratio α of Sₛ to the thickness Hi of the diaphragm may be within a range of 5000 mm-12000 mm. In some embodiments, in order to make the frequency of the second resonance peak of the vibration component 100 to be within a range of 3000 Hz-7000 Hz, the α may be within a range of 6000 mm-10000 mm. In some embodiments, in order to further adjust the frequency of the second resonance peak of the vibration component 100 to move to high frequency, the value range of α may be 6 000 mm-9 000 mm. In some embodiments, in order to further adjust the frequency range of the second resonance peak of the vibration component 100 to move to a high frequency, the α may be within a range of 6000 mm-8 000 mm. In some embodiments, in order to further adjust the frequency of the second resonance peak of the vibration component 100 to move to the high frequency, the α may be within a range of 6000 mm-7000 mm.

In some embodiments, a relationship between an area of the suspension region 1121 and the folded ring region 114 and the thickness of the clastic element 110 may affect a local equivalent mass Mm₃ and a local equivalent mass Mm₂, a local regional stiffness Ka₂′ and a local regional stiffness Ka₁′, which in turn affects an equivalent mass Ms, an equivalent stiffness Ks, and equivalent damping Rs formed by the connection region 115, the folded ring region 114, and the suspension region 1121, thereby controlling a range the second resonance peak of the vibration component 100. In some embodiments, the second resonance peak of the vibration component 100 may also be controlled through the design of a folded ring arch height of the folded ring region 114.

FIG. 8B is a schematic diagram illustrating frequency response curves of vibration components according to some embodiments of the present disclosure. In some embodiments, as illustrated in FIG. 8B, a frequency response curve 810 represents a frequency response curve of the vibration component when α=8190 mm; a frequency response curve 820 represents a frequency response curve of the vibration component when α=7146 mm; and frequency response curve 830 represents a frequency response curve of the vibration component when α=12360 mm. It can be known from the frequency response curve 820 that when α=7146 mm, the frequency of the second resonance peak 220 of the vibration component 100 may be approximately 7000 Hz. It can be known from the frequency response curve 810 that when α=8190 mm, the frequency of the second resonance peak 220 of the vibration component 100 may be approximately 5000 Hz. An amplitude of the second resonance peak 220 of the frequency response curve 810 may be close to an amplitude of the second resonance peak 220 of the frequency response curves 820. That is, as a increases, the resonance frequency of the second resonance peak 220 may decrease, and the amplitude may remain basically constant. It can be known from the frequency response curve 820 that when α=12360 mm, the vibration component 100 may have no obvious second resonance peak. In this case, the amplitude of the vibration component 100 within a of 3000 Hz-7000 Hz may decrease in comparison with those of the frequency response curve 810 and the frequency response curve 820, i.e., an output sound pressure level of the vibration component 100 is relatively low when α=12360 mm. Therefore, when the α is within a range of 6000 mm-10000 mm, the frequency of the second resonance peak of the vibration component 100 may be better controlled to be within a range of 3000 Hz-7000 Hz, so that the vibration component 100 may have a relatively high output sound pressure level within the range of 3000 Hz-7000 Hz.

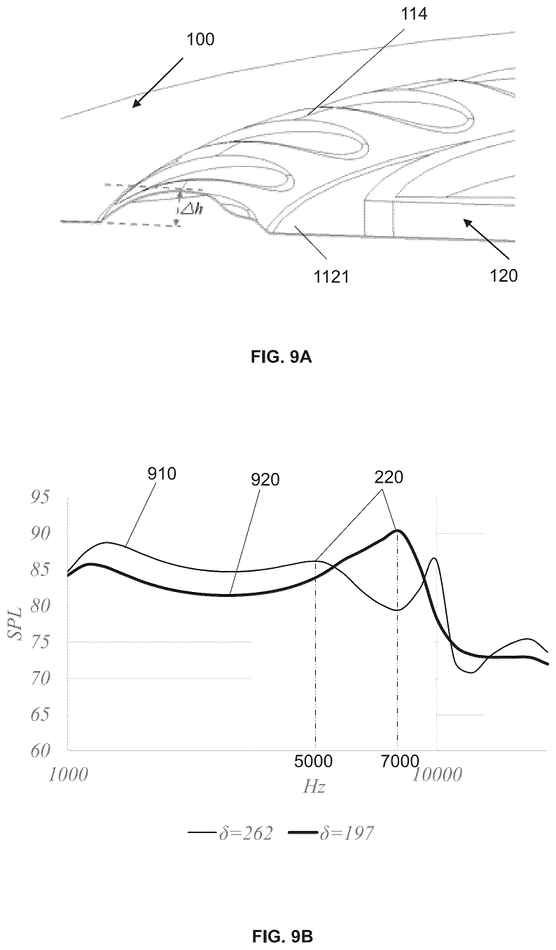

As illustrated in FIG. 9A, FIG. 9A is a partial structural diagram illustrating a vibration component according to some embodiments of present disclosure. In the present disclosure, a folded ring arch height Δh of the folded ring region 114 is defined. A physical quantity δ (mm) is defined as a ratio of Sₛ to the folded ring arch height Δh of the diaphragm:

$$δ = \frac{{S}_{s}}{Δ h} . \qquad ( Equation 2 )$$

In some embodiments, the δ may be within a range of 50 mm-600 mm. In some embodiments, the δ may be within a range of 100 mm-500 mm. In some embodiments, in order to make a frequency of a second resonance peak of the vibration component 100 to be within a range of 3000 Hz-7000 Hz, the δ may be within a range of 200 mm-400 mm. In some embodiments, in order to further move the frequency of the second resonance peak of the vibration component 100 to a low frequency within the range of 3000 Hz-7000 Hz, the δ may be within a range of 300 mm-400 mm. In some embodiments, in order to further move the frequency of the second resonance peak of the vibration component 100 to a low frequency within the range of 3000 Hz-7000 Hz, the δ may be within a range of 350 mm-400 mm. In some embodiments, in order to move the frequency of the second resonance peak of the vibration component 100 to a high frequency within the range of 3000 Hz-7000 Hz, the δ may be within a range of 200 mm-300 mm. In some embodiments, in order to further move the frequency of the second resonance peak of the vibration component 100 to a high frequency within the range of 3000 Hz-7000 Hz, the δ may be within a range of 200 mm-250 mm.

In some embodiments, by the design of the folded ring arch height, a three-dimensional dimension of the folded ring region 114 may be changed without changing horizontal projection areas of the folded ring region 114 and the suspension region 1121, so that the stiffness Ka₁′ of the folded ring region 114 may be changed, thereby controlling the second resonance peak of a loudspeaker. In some embodiments, the output sound pressure level of the loudspeaker may also be controlled by adjusting the dimension of the reinforcing member.

FIG. 9B is a schematic diagram illustrating frequency response curves of vibration components according to some embodiments of the present disclosure. In some embodiments, as illustrated in FIG. 9B, a frequency response curve 910 in the represents a frequency response curve of the vibration component 100 when δ=262 mm; and a frequency response curve 920 represents a frequency response curve of the vibration component 100 when δ=197 mm. It can be known from the frequency response curve 910 that when δ=262 mm, a frequency of the second resonance peak 220 of the vibration component 100 may be approximately 5000 Hz. It can be known from the frequency response curve 920 that when δ=197 mm, the frequency of the second resonance peak 220 of the vibration component 100 may be approximately 7000 Hz. Therefore, as δ increases, the resonance frequency of the second resonance peak 220 may decrease, and when the δ is within a range of 200 mm-400 mm, the frequency of the second resonance peak of the vibration component 100 may be better controlled to be within a range of 3000 Hz-7000 Hz.

In the present disclosure, a horizontal projection area of the central region 112 is defined as S_{c}, a horizontal projection area of a maximum contour of the reinforcing member 120 is defined as Sᵣₘ, and a horizontal projection area of the suspension region 1121 is defined as Sᵥ, wherein: Sᵣₘ=S_{c}−Sᵥ.

In the present disclosure, a physical quantity ϑ (unit is 1) is defined as a ratio of the horizontal projection area Sᵥ of the suspension region 1121 to the horizontal projection area S_{c} of the central region 112:

$$ϑ = \frac{{S}_{v}}{{S}_{c}} . \qquad ( Equation 3 )$$

In some embodiments, the ϑ may be within a range of 0.05-0.7. In some embodiments, the ϑ may be within a range of 0.1-0.5. In some embodiments, in order to make the frequency of the second resonance peak of the vibration component 100 to be within a range of 3000 Hz-7000 Hz, the ϑ may be within a range of 0.15-0.35. In some embodiments, in order to further move the second resonance peak of the vibration component 100 to a high frequency within the range of 3000 Hz-7000 Hz, the ϑ may be within a range of 0.15-0.25. In some embodiments, the ϑ may be within a range of 0.15-0.2. In some embodiments, in order to further move the second resonance peak of the vibration component 100 to a low frequency within the range of 3000 Hz-7000 Hz, the ϑ may be within a range of 0.25-0.35. In some embodiments, in order to further move the second resonance peak of the vibration component 100 to a low frequency within the range of 3000 Hz-7000 Hz, the ϑ may be within a range of 0.3-0.35.

In some embodiments, when the vibration component deforms near the frequency corresponding to the second resonance peak, the suspension region 1121 and the folded ring region 114 may generate a local resonance. In this case, by designing the dimension (i.e., a dimension of the maximum contour of the reinforcing member 120) of the reinforcing member 120, the reinforcing member 120 may achieve a certain bending deformation within the frequency range, thereby realizing superposition increment of the sound pressure in different regions of the diaphragm, and realizing a maximum sound pressure level output of the vibration component or the loudspeaker at the second resonance peak.

FIG. 9C is a schematic diagram illustrating frequency response curves of vibration components according to some embodiments of the present disclosure. In some embodiments, as illustrated in FIG. 9C, a frequency response curve 940 represents a frequency response curve of the vibration component 100 when ϑ=0.3; and a frequency response curve 950 represents a frequency response curve of the vibration component 100 when ϑ=0.19. It can be known from the frequency response curve 940 that when ϑ=0.3, a frequency of the second resonance peak 220 of the vibration component 100 may be 4000 Hz. It can be known from the frequency response curve 950 that when ϑ=0.19, the frequency of the second resonance peak 220 of the vibration component 100 may be 6000 Hz. Accordingly, as ϑ decreases, the resonant frequency of the second resonant peak 220 may increase, and when ϑ is within a range of 0.15-0.35, the frequency of the second resonance peak of the vibration component 100 may be better controlled to be within a range of 3000 Hz-7000 Hz.

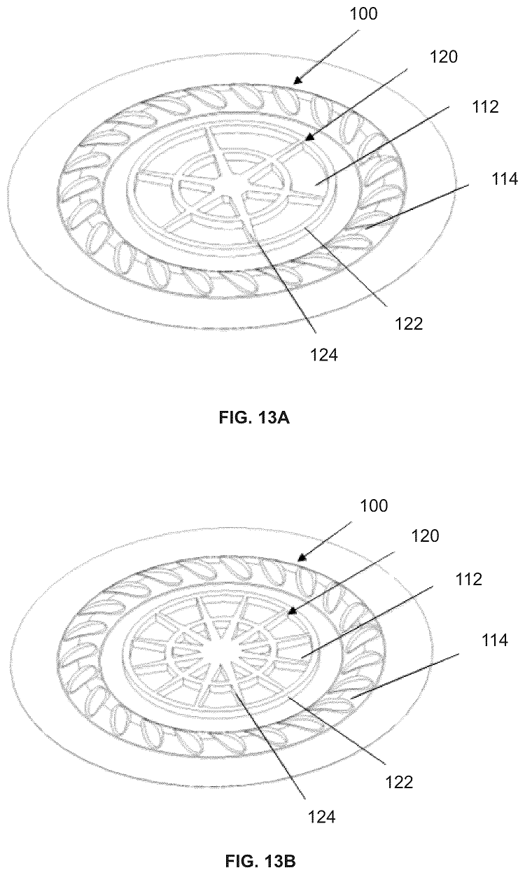

In some embodiments, the one or more strip structures 124 may have different widths, shapes, and counts, to change the one or more hollow regions (corresponding to the suspension region of the central region 112) of the reinforcing member 120, thereby adjusting the frequency response of a loudspeaker. More descriptions may be found in subsequent FIGS. 13A-18C and related descriptions thereof.

In some embodiments, the resonance frequency of the vibration component 100 may be controlled by designing areas of the one or more hollow regions (e.g., designing a count and positions of the one or more strip structures 124 of the reinforcing member 120, a count and positions of the one or more ring structures 122, etc.), to improve the use performance of the vibration component 100. In some embodiments, a fourth resonance peak of the vibration component 100 may be within a range of 8000 Hz-20000 Hz. In some embodiments, the fourth resonance peak of the vibration component 100 may be within a range of 10000 Hz-18000 Hz.

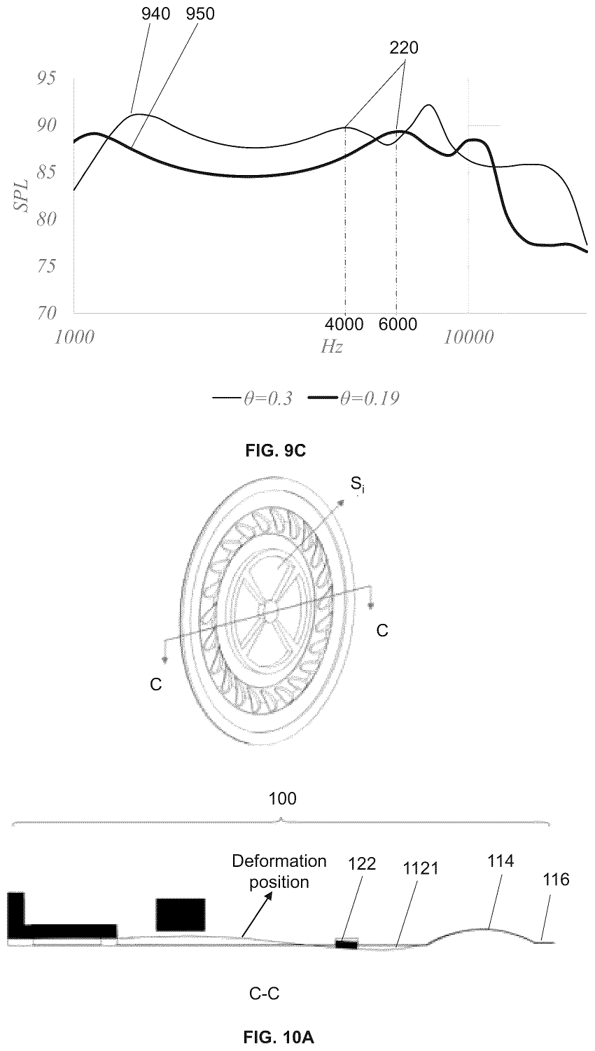

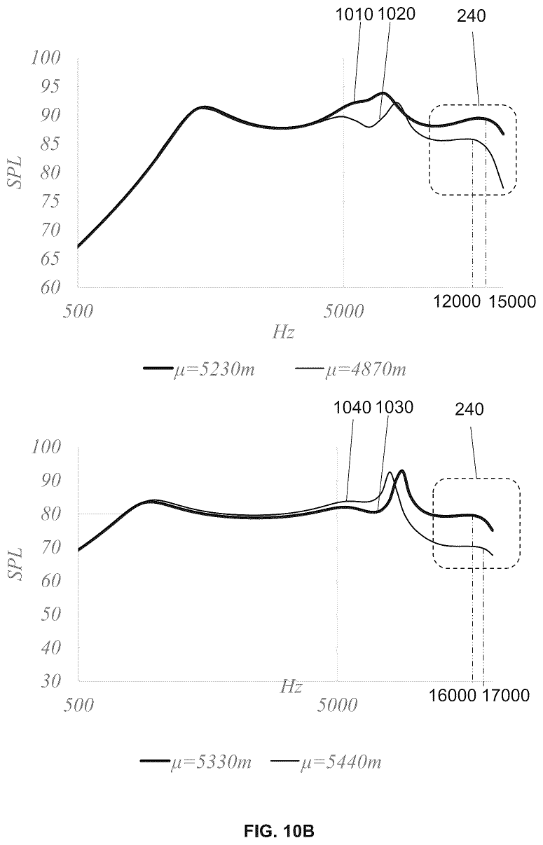

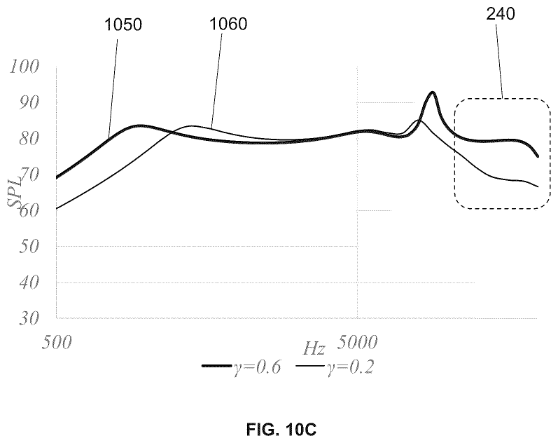

As illustrated in FIG. 6 and FIG. 10A, FIG. 10A is a schematic diagram illustrating a deformation of a C-C cross-section of a vibration component including a reinforcing member with a single-ring structure near a frequency of a fourth resonance peak according to some embodiments of the present disclosure. It can be seen from FIG. 6 that a difference Δf between a frequency of the fourth resonance peak 240 and a frequency of the third resonance peak 230 has a great influence on a flatness of a frequency response curve of the vibration component 100 in a high frequency range. In some embodiments, as illustrated in FIG. 10A, it can be seen from the vibration of the vibration component 100 at a C-C cross-sectional position that near the frequency of the fourth resonance peak, main deformation positions of the vibration component 100 may be deformations of one or more hollow regions of the central region 112. In some embodiments, the fourth resonance peak 240 of the vibration component 100 may be controlled by controlling an equivalent mass Mm; and an equivalent stiffness Kaᵢ corresponding to a mass-spring-damping system of each of the one or more hollow regions of the reinforcing member 120 corresponding to the central region. For example, an area of each of the one or more hollow regions of the central region 112 may be designed by designing a count and a dimension of the one or more strip structures 124 and the one or more ring structures 122. The area of each of the one or more hollow regions is defined as Sᵢ. It should be noted that although FIG. 10A illustrates the deformation of the vibration component 100 including the reinforcing member 120 with a single-ring structure corresponding to the fourth resonance peak, for a vibration component including the reinforcing member 120 with multi-ring structures, the conclusion is still applicable (e.g., the vibration component 100 in FIG. 5).

In order to make the frequency of the fourth resonance peak to be within an appropriate range (10000 Hz-18000 Hz), a physical quantity is defined in the present disclosure: a ratio of the area Sᵢ of any one of the one or more hollow regions (i.e., a projection area of any one of a plurality of hollow parts in a vibration direction of the clastic element 110) to a thickness Hᵢ of a diaphragm (e.g., the elastic element 110) of each of the one or more hollow regions is an area-thickness ratio μ (mm):

$$μ = \frac{{S}_{i}}{{H}_{i}} . \qquad ( Equation 4 )$$

In some embodiments, when a Young's modulus and a density of the diaphragm (e.g., the clastic element 110) are within a preset range, a frequency position of the fourth resonance peak of the vibration component may be adjusted by designing a value of μ. In some embodiments, the Young's modulus of the diaphragm may be within a range of 5*10\hat{ }8 Pa−1*10\hat{ }10 Pa. In some embodiments, the Young's modulus of the diaphragm may be within a range of 1*10\hat{ }9 Pa−5*10\hat{ }9 Pa. In some embodiments, the density of the diaphragm may be within a range of 1*10\hat{ }3 kg/m³−4*10\hat{ }3 kg/m³. In some embodiments, the density of the diaphragm may be within a range of 1*10\hat{ }3 kg/m³−2*10\hat{ }3 kg/m³.

In some embodiments, the area-thickness ratio μ may be within a range of 1000 mm-10000 mm. In some embodiments, the area-thickness ratio μ may be within a range of 1500 mm-9000 mm. In some embodiments, the area-thickness ratio μ may be within a range of 2000 mm-8000 mm. In some embodiments, the area-thickness ratio μ may be within a range of 2500 mm-7500 mm. In some embodiments, the area-thickness ratio μ may be within a range of 3000 mm-7000 mm. In some embodiments, the area-thickness ratio μ may be within a range of 3500 mm-6500 mm. In some embodiments, the area-thickness ratio μ may be within a range of 4000 mm-6000 mm.

In some embodiments, by designing the area of each of the one or more hollow regions and the thickness of the diaphragm, the equivalent mass Mmᵢ and the equivalent stiffness Kaᵢ of each of the one or more hollow regions may be controlled, thereby controlling the fourth resonance peak of a loudspeaker.

FIG. 10B is a schematic diagram illustrating frequency response curves of vibration components according to some embodiments of the present disclosure. In some embodiments, as illustrated in FIG. 10B, a frequency response curve 1010 represents a frequency response curve of a vibration component when μ=5230 mm; a frequency response curve 1020 represents a frequency response curve of the vibration component when μ=4870 mm; a frequency response curve 1030 represents a frequency response curve of the vibration component when μ=5330 mm; and a frequency response curve 1040 represents a frequency response curve of the vibration component when μ=5440 mm. As illustrated in FIG. 10B, a frequency of a fourth resonance peak of the frequency response curve 1010 corresponding to μ=5230 mm may be approximately 15000 Hz. The frequency of the fourth resonance peak of the frequency response curve 1020 corresponding to μ=4870 mm may be approximately 12000 Hz. The frequency of the fourth resonance peak of the frequency response curve 1030 corresponding to μ=5330 mm may be approximately 16000 Hz. The frequency of the fourth resonance peak of the frequency response curve 1040 corresponding to μ=5440 mm may be approximately 17000 Hz. Accordingly, when the value u is within a range of 4000 mm-6000 mm, the frequency of the fourth resonance peak of the vibration component 100 may be better controlled to be within a range of 10000 Hz-18000 Hz.

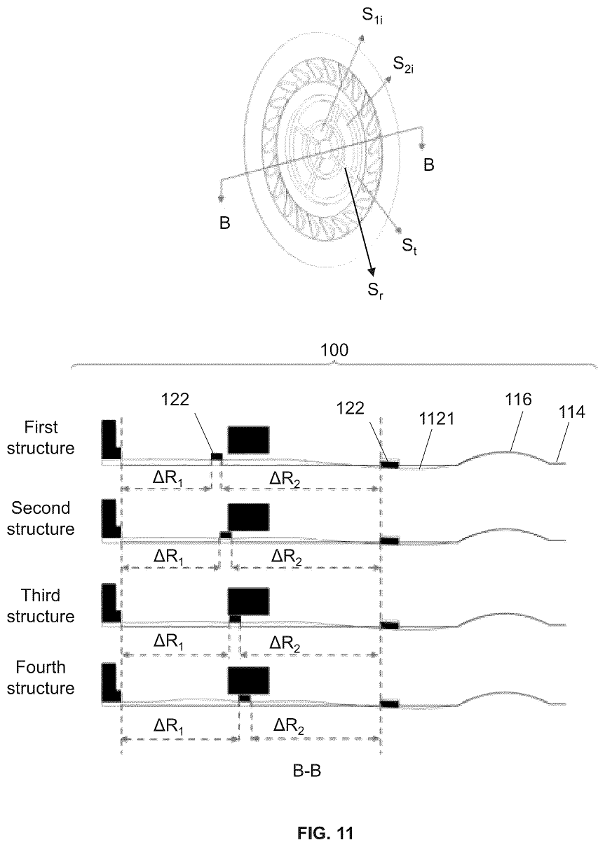

As illustrated in FIG. 11, in some embodiments, the reinforcing member 120 may have a multi-ring structure (e.g., a double-ring structure), i.e., the reinforcing member 120 may include a plurality of radially adjacent ring structures (e.g., a first ring structure, a second ring structure, etc.). A diameter of each of the plurality of ring structures may be different. Ring structures of the plurality of ring structures with relatively small diameters may be arranged at inner sides of ring structure of the plurality of ring structures with relatively large diameters. According to the present disclosure, an area of each of the one or more hollow regions of the elastic element 110 in the first ring structure is defined as S₁ᵢ. When the first ring structure and the second ring structure are adjacent ring structures, an area of each of the one or more hollow regions of the elastic element 110 between the first ring structure and the second ring structure is defined as S₂ᵢ. In some embodiments, the reinforcing member 120 may also have more ring structures 122. An area of each of the one or more hollow regions of the elastic element 110 between an n−1th ring structure and an nth ring structure is sequentially defined as Sₙᵢ from inside to outside. The one or more hollow regions located between the ring structures of different diameters may include a first hollow region and a second hollow region. A distance between a centroid of the first hollow region and a center of the central region and a distance between a centroid of the second hollow region and the center of the central region may be different. According to the present disclosure, a ratio γ (unit: 1) of areas of the one or more hollow regions of the elastic element 110 is defined as a ratio of an area Sₖᵢ of the first hollow region to an area Sⱼᵢ of the second hollow regions:

$$γ = \frac{{S}_{ki}}{{S}_{ji}} . \qquad ( Equation 5 )$$

Wherein k>j. By designing a value of γ, the frequency position of the fourth resonance peak of the vibration component and an output sound pressure level may be adjusted.

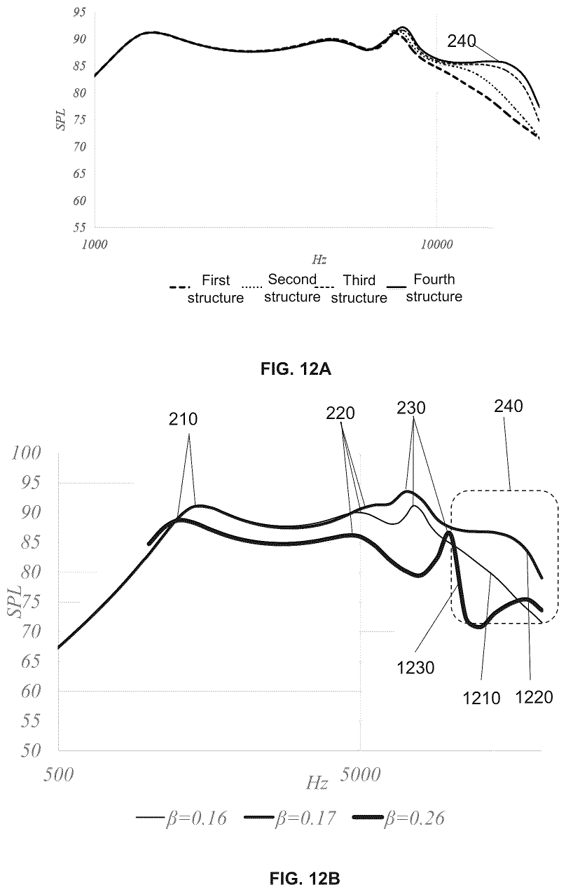

As illustrated in FIG. 11 and FIG. 12A, FIG. 12A illustrates frequency response curves of vibration components corresponding to FIG. 11. From a first structure to a fourth structure, an area ratio γ of an area S₂ᵢ (i.e., a first hollow region) of each of the one or more hollow regions between a first ring region and a second ring region to an area S₁ᵢ (i.e., a second hollow region) of each of the one or more hollow regions in the first ring region may be 5.9, 4.7, 3.9, and 3.2 in sequence. It can be seen from FIG. 11 that at the position of a fourth resonance peak of the vibration component 100, from the first structure to the fourth structure, as γ decreases, a radius ΔR₁ of the first hollow region located within the ring structures 122 located on the inner side may gradually increase, and a radius ΔR₂ of the second hollow region between the ring structures 122 located on the inner side and the ring structures 122 located on the outer side may gradually decrease. In some embodiments, further referring to FIG. 12A, from the first structure to the fourth structure, a sound pressure amplitude output at the fourth resonance peak of the frequency response curve of the vibration component gradually increases. Accordingly, the ratio of the areas of the one or more hollow regions of the central region 112 may affect the resonance frequency of each of the one or more hollow regions. Finally, an effect of sound pressure superposition in the high frequency range may be obtained. That is, the high frequency sensitivity of the vibration component 100 may be adjusted by setting the value of γ.

In some embodiments, the ratio of the areas of the one or more hollow regions in the central region 112 may be as small as possible. For example, the ratio γ of the area Sₖᵢ of the first hollow region to the area Sⱼᵢ of the second hollow region may be within a range of 0.1-10. In some embodiments, the ratio γ of the area Sₖᵢ of the first hollow region to the area Sⱼᵢ of the second hollow region may be within a range of 0.16-6. In some embodiments, the ratio γ of the area Sₖᵢ of the first hollow region to the area Sⱼᵢ of the second hollow region may be within a range of 0.2-5. In some embodiments, the ratio γ of the area Sₖᵢ of the first hollow region to the area Sⱼᵢ of the second hollow region may be within a range of 0.25-4. In some embodiments, the ratio γ of the area Sₖᵢ of the first hollow region to the area Sⱼᵢ of the second hollow region may be within a range of 0.25-1. In some embodiments, the ratio γ of the area Sₖᵢ of the first hollow region to the area Sⱼᵢ of the second hollow region may be within a range of 0.25-0.6. In some embodiments, the ratio γ of the area Sₖᵢ of the first hollow region to the area Sⱼᵢ of the second hollow region may be within a range of 0.1-4. In some embodiments, the ratio γ of the area Sₖᵢ of the first hollow region to the area Sⱼᵢ of the second hollow region may be within a range of 0.1-3. In some embodiments, the ratio γ of the area Sₖᵢ of the first hollow region to the area Sⱼᵢ of the second hollow region may be within a range of 0.1-2. In some embodiments, the ratio γ of the area Sₖᵢ of the first hollow region to the area Sⱼᵢ of the second hollow region may be within a range of 0.1-1.

In some embodiments, the ratio of the areas of the one or more hollow regions of the elastic elements 110 may affect a difference between resonance frequencies of the one or more hollow regions. The resonance frequencies of the one or more hollow regions may be equal or close to each other such that sound pressures of the one or more hollow regions may be superimposed, thereby increasing an output sound pressure level of a loudspeaker at the fourth resonance peak.

FIG. 10C is a schematic diagram illustrating frequency response curves of vibration components according to some embodiments of the present disclosure. In some embodiments, as illustrated in FIG. 10C, a frequency response curve 1050 represents a frequency response curve of a vibration component when γ=0.6; and a frequency response curve 1060 represents a frequency response curve of the vibration component when γ=0. As illustrated in FIG. 10C, an output sound pressure level (amplitude) of the frequency response curve 1050 at a fourth resonance peak is relatively high, and an output sound pressure level (amplitude) of the frequency response curve 1060 at the fourth resonance peak is relatively low. Accordingly, when γ is within a range of 0.25-4, the vibration component 100 may have a relatively high output sound pressure level within a high frequency range (e.g., 10000 Hz-18000 Hz).

In some embodiments, a mass, a centroid, and a stiffness of the reinforcing member 120, and a mass and a stiffness of one or more hollow regions of the central region 112 may be adjusted by designing a projection area of the reinforcing member 120 in a vibration direction and a projection area of a maximum contour of the reinforcing member 120 in the central region 112 in the vibration direction, thereby adjusting a first resonance peak, a third resonance peak, and the fourth resonance peak of the vibration component 100.

In the present disclosure, as illustrated in FIG. 11, a ratio β (unit: 1) of a horizontal area of the reinforcing part of the reinforcing member 120 to a horizontal area of the reinforcing member 120 is defined as a ratio of a projection area Sᵣ of the reinforcing part to a projection area St of a maximum contour of the reinforcing member 120 in the central region 112 in a projection of the reinforcing member 120 in the vibration direction:

$$β = \frac{{S}_{r}}{{S}_{t}} . \qquad ( Equation 6 )$$

In some embodiments, the ratio β of the horizontal area of the reinforcing part of the reinforcing member 120 to the horizontal area of the reinforcing member 120 may be within a range of 0.1-0.8. In some embodiments, the ratio β of the horizontal area of the reinforcing part of the reinforcing member 120 to the horizontal area of the reinforcing member 120 may be within a range of 0.2-0.7. In some embodiments, the ratio β of the horizontal area of the reinforcing part of the reinforcing member 120 to the horizontal area of the reinforcing member 120 may be within a range of 0.1-0.7. In some embodiments, the ratio β of the horizontal area of the reinforcing part of the reinforcing member 120 to the horizontal area of the reinforcing member 120 may be within a range of 0.2-0.6. In some embodiments, the ratio β of the horizontal area of the reinforcing part of the reinforcing member 120 to the horizontal area of the reinforcing member 120 may be within a range of 0.3-0.6. In some embodiments, the ratio β of the horizontal area of the reinforcing part of the reinforcing member 120 to the horizontal area of the reinforcing member 120 may be within a range of 0.4-0.5. In some embodiments, the ratio β of the horizontal area of the reinforcing part of the reinforcing member 120 to the horizontal area of the reinforcing member 120 may be within a range of 0.3-0.5. In some embodiments, the ratio β of the horizontal area of the reinforcing part of the reinforcing member 120 to the horizontal area of the reinforcing member 120 may be within a range of 0.2-0.5. In some embodiments, the ratio β of the horizontal area of the reinforcing part of the reinforcing member 120 to the horizontal area of the reinforcing member 120 may be within a range of 0.1-0.5.

In some embodiments, by designing the projection area of the reinforcing member 120 in the vibration direction and the projection area of the maximum contour of the reinforcing member 120 in the vibration direction, the mass, the centroid, and the stiffness of the reinforcing member 120 may be controlled, and the mass and the stiffness of the one or more hollow regions of the central region 112 may be adjusted, thereby controlling a total equivalent mass Mt formed by the combination of the mass of the reinforcing member 120, the mass of the clastic element 110, the equivalent air mass, and the driving end equivalent mass, and then adjusting the first resonance peak, the third resonance peak, and the fourth resonance peak of the loudspeaker.

FIG. 12B is a schematic diagram illustrating frequency response curves of vibration components according to some embodiments of the present disclosure. In some embodiments, as illustrated in FIG. 12B, a frequency response curve 1210 represents a frequency response curve of a vibration component when β=0.16; a frequency response curve 1220 represents a frequency response curve of the vibration component when β=0.17; and a frequency response curve 1230 represents a frequency response curve of the vibration component when β=0.26. As illustrated in FIG. 12B, the frequency response curve 1210, the frequency response curve 1220, and the frequency response curve 1230 may have the first resonant peak 210, the second resonant peak 220, the third resonant peak 230, and the fourth resonant peak 240. When a value of β changes, frequencies of the first resonance peak 210, the third resonance peak 230, and the fourth resonance peak 240 may change greatly, while a frequency of the second resonance peak 220 may change little. When β=0.16, the frequency response curve 1210 may not reflect the fourth resonance peak 240. When β increases to 0.17, the first resonance peak 210 and the second resonance peak 220 of the vibration component may change little, the third resonance peak 230 may move to a high frequency, and a high frequency output sound pressure level may increase, which reflects the obvious fourth resonance peak 240. When β increases to 0.26, the first resonance peak 210 may move to a low frequency, the third resonance peak 230 may move to the high frequency, the fourth resonance peak 240 may move to the high frequency, and an overall output sound pressure level of the vibration component may decrease. Accordingly, when the value of β changes, the first resonance peak, the third resonance peak, and the fourth resonance peak of the vibration component 100 may be adjusted. In order to make the first resonance peak, the third resonance peak and the fourth resonance peak of the vibration component 100 to be within an appropriate range (e.g., a range illustrated in the embodiments of the present disclosure) and enable the vibration component to have a relatively high output sound pressure level, the value of β may be within a range of 0.1-0.5.

As illustrated in FIG. 13A and FIG. 13B, FIG. 13A and FIG. 13B are schematic structural diagrams illustrating vibration components including different counts of strip structures according to some embodiments of the present disclosure. In some embodiments, an total mass of the vibration component 100 may be adjusted by adjusting the count of the one or more strip structures 124, so that a total equivalent mass Mt formed by the combination of a mass of the reinforcing member 120, a mass of the clastic element 110, an equivalent air mass, and a driving end equivalent mass may change, and a resonance frequency of a mass Mt-spring Kt-damping Rt system may change, which in turn causes a first-order resonance frequency of the vibration component 100 to change, resulting in a change of a sensitivity within a low frequency range before the first resonance frequency of the vibration component 100 and a medium frequency range after the first resonance frequency of the vibration component 100. In some embodiments, a larger number of strip structures 124 may be designed, so that the total equivalent mass Mt may be increased, and the first resonance frequency of the vibration component 100 may be advanced, thereby increasing a sensitivity within a low frequency range before the first resonance frequency of the vibration component 100, such as a frequency range before 3000 Hz, a frequency range before 2000 Hz, a frequency range before 1000 Hz, a frequency range before 500 Hz, and a frequency range before 300 Hz. In some embodiments, a small number of strip structures 124 may be designed, so that the total equivalent mass Mt may be decreased, and the first resonance frequency of the vibration component 100 may be moved backward, thereby increasing the sensitivity within the medium frequency range after the first resonance frequency of the vibration component 100. As another example, a sensitivity within a frequency range after 3000 Hz may be increased. As another example, a sensitivity within a frequency range after 2000 Hz may be increased. As another example, a sensitivity within a frequency range after 1000 Hz may be increased. As another example, a sensitivity within a frequency range after 500 Hz may be increased. As another example, a sensitivity within a frequency range after 300 Hz may be increased.

In some embodiments, the stiffness of the reinforcing member 120 may also be adjusted by adjusting the count of strip structures 124, so that the stiffness Kt₁ provided to the system by the reinforcing member 120 and the elastic element 110 may change, and for a Mt₁-spring Kt₁-damping Rt₁ system form by a total equivalent mass Mt₁ and a total equivalent damping Rt₁, in which the total equivalent mass Mt₁ is formed by the combination of the reinforcing member 120, the connection region 115, the folded ring region 114, the suspension region disposed between a region of the central region 112 covered by the reinforcing member 120 and the folded ring region 114, an equivalent air mass, and a driving end equivalent mass and the total equivalent damping Rt₁ is formed by equivalent damping of each part, a resonance frequency of a flipping motion of the Mt₁-spring Kt₁-damping Rt₁ system which takes a ring region in a diameter direction of the reinforcing member 120 as an equivalent fixed fulcrum may change, thereby causing a third resonance position of the vibration component 100 to change.

In some embodiments, an area of no less than one suspension region of the central region 112 corresponding to the reinforcing member 120 may also be adjusted by adjusting the count of the one or more strip structures 124, so that an equivalent mass Mmᵢ of each of the one or more hollow regions, equivalent stiffnesses Kai and Kai′, equivalent damping Raᵢ and Raᵢ′ may change, thereby causing the fourth resonance peak of the vibration component to change. In some embodiments, an area-thickness ratio μ of the vibration component and a ratio β of a horizontal area of the reinforcing part of the reinforcing member 120 to a horizontal area of the reinforcing member 120 may also be adjusted by adjusting the count of the one or more strip structures 124, thereby adjusting the position of the fourth resonance peak of the vibration component.

In some embodiments, the count of the one or more strip structures 124 of the reinforcing member 120 is adjustable, and the positions of the first resonance peak, the third resonance peak, and the fourth resonance peak of the vibration component 100 may be adjusted based on actual application requirements, so that a frequency response of the vibration component 100 is controllably adjustable.

In some embodiments, since a shape of a projection the one or more strip structures 124 in a vibration direction of the elastic element 110 includes at least one of a rectangle, a trapezoid, a curve, an hourglass shape, and a petal shape, the area of the one or more hollow regions (corresponding to the suspension region of the central region 112 within the projection range of the reinforcing member 120) of the reinforcing member 120 may be changed by adjusting the shape of the one or more strip structures 124, such that a relationship (the area-thickness ratio μ) between the area of the one or more hollow regions and the thickness of the elastic element 110 may be adjusted, thereby adjusting the fourth resonance peak. In addition, a relationship (the ratio γ of the areas of the one or more hollow regions) between the areas of the one or more hollow regions of different ring structures 122 of the reinforcing member 120 may be changed to adjust the fourth resonance peak. Furthermore, a relationship (the ratio β of the horizontal area of the reinforcing part of the reinforcing member 120 to the horizontal area of the reinforcing member 120) between the horizontal area of the reinforcing part of the reinforcing member 120 and the horizontal area of the reinforcing member 120 may be changed to adjust the first resonant peak, the third resonant peak, and the fourth resonant peak.

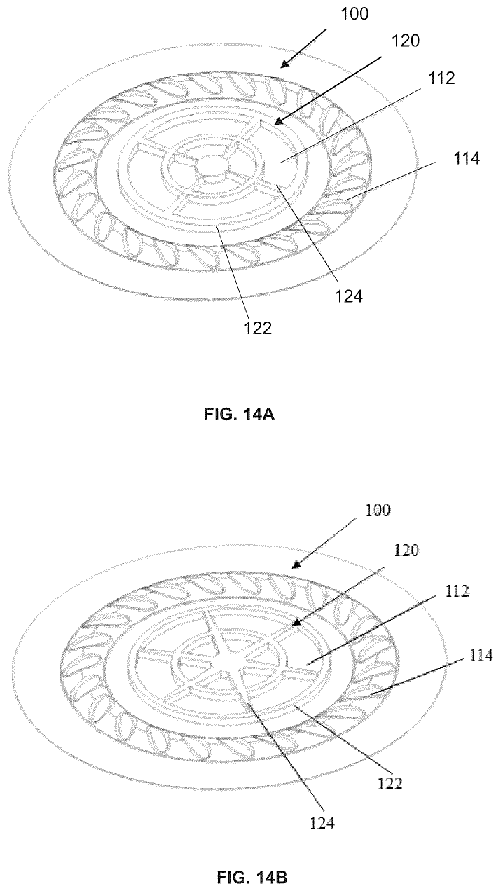

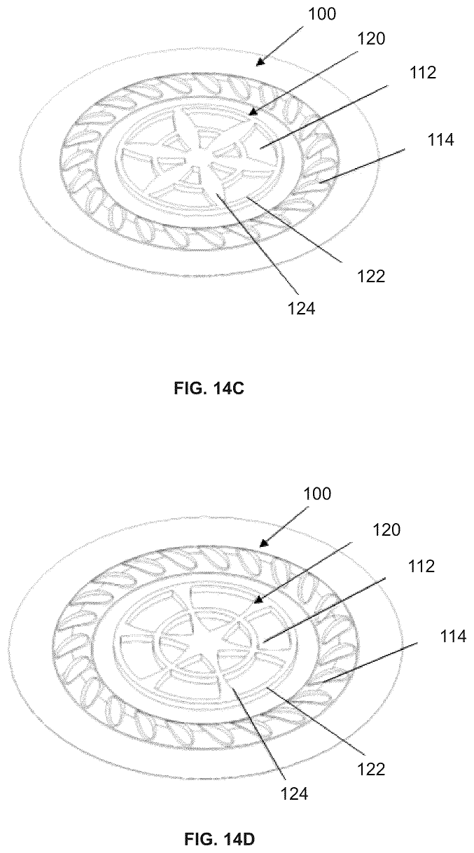

As illustrated in FIGS. 14A-14D, FIGS. 14A-14D are schematic structural diagrams illustrating vibration components including one or more strip structures of different widths according to some embodiments of the present disclosure. The one or more strip structures in FIG. 14A may be inverted trapezoids (i.e., a short side of the trapezoid is close to a center of the reinforcing member 120). The one or more strip structures 124 in FIG. 14 B may be trapezoids (i.e., the short side of the trapezoid is far away from the center of the reinforcing member 120). The one or more strip structures 124 in FIG. 14 C may be outer arc shapes. The one or more strip structures 124 in FIG. 14 D may be inner arc shapes. In some embodiments, by designing the one or more strip structures 124 with different horizontal widths, a position of a centroid of the reinforcing member 120 may be effectively adjusted. In some embodiments, the stiffness of the reinforcing member 120 may also be changed without changing the mass of the reinforcing member 120, so that the stiffness Kt₁ provided by the reinforcing member 120 and the elastic element 110 (especially the region of the central region 112 covered by the reinforcing member 120) to the system may change, further causing the resonance frequency of the flipping motion of the mass Mt₁-spring Kt₁-damping Rt₁ system to change, thereby causing the third resonance frequency of the vibration component 100 to change.

In some embodiments, by changing a width design of the one or more strip structures 124, the one or more strip structures 124 may have different local stiffnesses at different positions extending from a center to a periphery. When a driving end frequency is close to the resonance frequency of the Mt₁-spring Kt₁-damping Rt₁ system, the connection region 115 between the fixed region 116 and the folded ring region 114, the folded ring region 114, and the suspension region disposed between the region of the central region 112 covered by the reinforcing member 120 and the folded ring region 114 may be driven by the reinforcing member 120 to vibrate and generate a resonance peak with an adjustable 3 dB bandwidth.

As illustrated in FIGS. 14A-14D, in some embodiments, by designing the inverted trapezoidal strip structures 124 and the outer arc-shaped (defined as an outer arc shape that protrudes outwardly and an inner arc shape that is concave inwardly, the outer arc shape including an arc, an ellipse, a high-order function arc, or any other arc) strip structures 124, the third resonance peak of the vibration component 100 with a relatively large 3 dB bandwidth may be obtained, which is applicable to scenarios requiring a low Q value and a wide bandwidth. In some embodiments, by designing the trapezoidal, rectangular, or an inner arc-shaped (defined as the arc shape that protrudes outwardly and the inner arc shape that is concave inwardly, the inner arc shape including an arc, an ellipse, a high-order function arc, or any other arc) strip structures 124, the third resonance peak of the vibration component 100 with a high sensitivity and a small 3 dB bandwidth may be obtained, which is applicable to scenarios requiring a high Q value and a local high sensitivity.

By designing the one or more strip structures 124 with different horizontal widths, the area of no less than one suspension region of the central region 112 corresponding to the reinforcing member 120 may also be adjusted, so that each equivalent mass Mmᵢ, equivalent stiffness Kaᵢ and Kai′, and equivalent damping Raj and Raj′ may change. Furthermore, the position of the fourth resonance peak of the vibration component 100 may change.

Therefore, by designing the one or more strip structures 124 with different horizontal widths, the position of the third resonance peak frequency of the vibration component 100, the 3 dB bandwidth at the resonance peak, the sensitivity of the vibration component 100 at the resonance peak, and the position of the fourth resonance peak of the vibration component 100 may be adjusted.

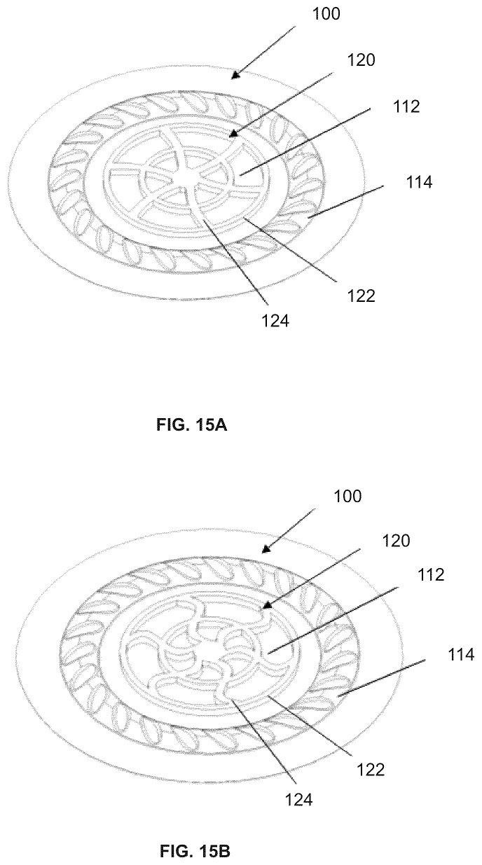

As illustrated in FIG. 15A and FIG. 15B, FIG. 15A and FIG. 15B are schematic structural diagrams illustrating vibration components including one or more strip structures of different shapes according to some embodiments of the present disclosure. The one or more strip structures 124 in FIG. 15A may be spiral. The one or more strip structures 124 in FIG. 15B may be S-shaped. In some embodiments, by designing the one or more strip structures 124 with different horizontal shapes, a stiffness of the reinforcing member 120 may be adjusted, so that a stiffness Kt₁ provided by the reinforcing member 120 and the elastic element 110 (especially a region of the central region 112 covered by the reinforcing member 120) to the system may change, which in turn causes a resonance frequency of a flipping motion of a mass Mt₁-spring Kt₁-damping Rt₁ system to change, thereby causing a position of the third resonance position of the vibration component 100 to change. In some embodiments, an area of no less than one suspension region of the central region 112 corresponding to the reinforcing member may also be adjusted, so that each equivalent mass Mmᵢ, equivalent stiffnesses Kaᵢ and Kaᵢ′, and equivalent damping Raᵢ and Raᵢ′ may change, and the position of the fourth resonance peak of the vibration component 100 may change. In some embodiments, by designing the one or more strip structures 124 with different horizontal shapes, a stress distribution inside the reinforcing member 120 may also be adjusted, and a processing deformation of the reinforcing member 120 may be controlled.

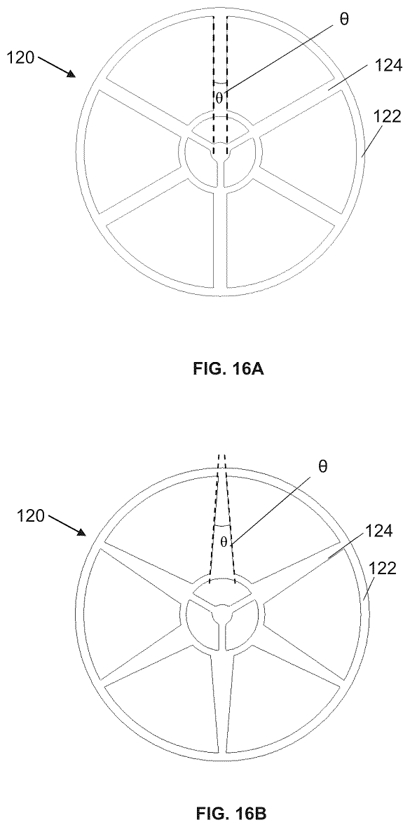

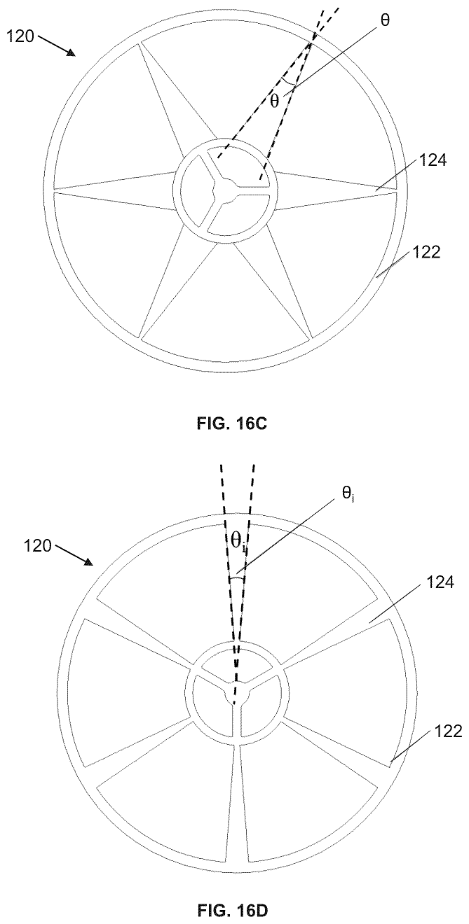

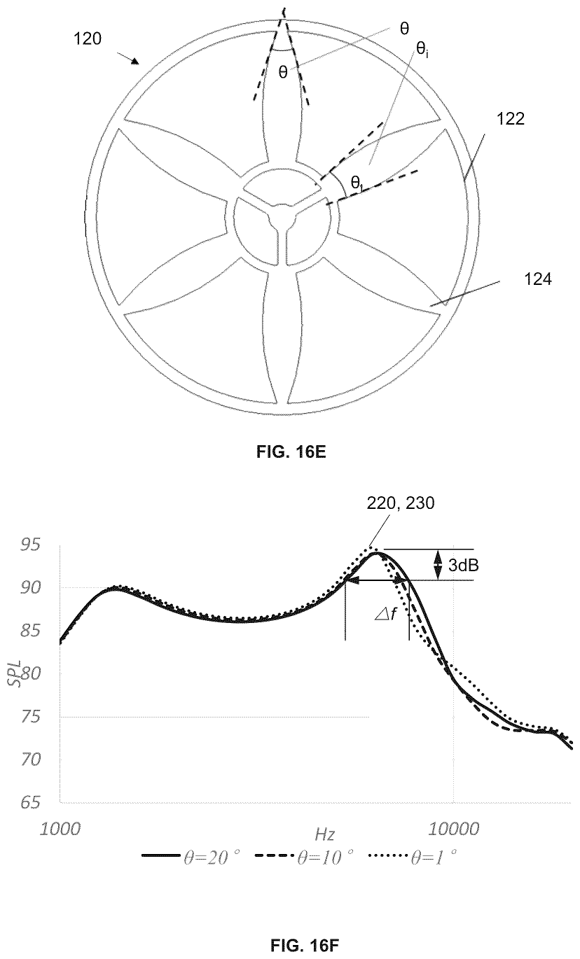

As illustrated in FIGS. 16A-16E, FIGS. 16A-16E are schematic structural diagrams illustrating reinforcing members including one or more strip structures of different shapes according to some embodiments of the present disclosure. In some embodiments, in order to accurately adjust the influence of the one or more strip structures of different shapes on resonance peaks (e.g., a first resonance peak, a third resonance peak, and a fourth resonance peak) of the vibration component, for the one or more strip structures 124 with widths gradually decrease from a center to a periphery, an angle θ is defined as an angle between two sides of a shape of a projection of a strip structure on a projection plane perpendicular to a vibration direction. The resonance peak may be adjusted by setting a value of θ. In some embodiments, for the one or more strip structures 124 (as illustrated in FIGS. 16A-16C) with straight sides, the angle θ is an angle between two sides of a strip structure. In some embodiments, for the one or more strip structures 124 (as illustrated in FIG. 16E) with curved sides, the angle θ is an angle between tangent lines of the two sides of the strip structure 124. In some embodiments, in order to accurately adjust the influence of the one or more strip structures of different shapes on the resonance peaks (e.g., the first resonance peak, the third resonance peak, and the fourth resonance peak) of the vibration component, as illustrated in FIG. 16D, for a strip structure of which a width gradually increases from a center to a periphery, an angle is defined as θᵢ. The resonance peak of the vibration component may be adjusted by setting a value of θᵢ. In some embodiments, for the one or more strip structures 124 with straight sides, the angle θᵢ is an angle between the two sides of the strip structure. In some embodiments, for the one or more strip structures 124 with curved sides, the angle θᵢ is an angle between tangent lines of the two sides of the strip structure.

In some embodiments, by designing the angle θ (or θᵢ) of the one or more strip structures 124, a stiffness of the reinforcing member 120 may be changed without changing or changing a mass of the reinforcing member 120, so that the stiffness Kt₁ provided to the system by the reinforcing member 120 and the clastic element 110 may change, which further causes a resonance frequency of a flipping motion of the mass Mt₁-spring Kt₁-damping Rt₁ system to change, thereby causing a position of the third resonance position of the vibration component 100 to change. Meanwhile, a 3 dB bandwidth of the third resonance peak of the vibration component 100 may also be controlled. In some embodiments, the 3 dB bandwidth of the third resonance peak of the vibration component 100 may be effectively increased by increasing the angle θ (or θᵢ) of the one or more strip structures 124.

For a frequency response of the vibration component 100 requiring a low Q value and a wide bandwidth, a relatively large angle θ (or θᵢ) of the one or more strip structures 124 may be designed. In some embodiments, the angle θ of the one or more strip structures 124 may be within a range of 0-150°. In some embodiments, the angle θ of the one or more strip structures 124 may be within a range of 0-120°. In some embodiments, the angle θ of the one or more strip structures 124 may be within a range of 0-90°. In some embodiments, the angle θ of the one or more strip structures 124 may be within a range of 0-80°. In some embodiments, the angle θ of the one or more strip structures 124 may be within a range of 0-60°. In some embodiments, the angle θᵢ of the one or more strip structures 124 may be within a range of 0-90°. In some embodiments, the angle θᵢ of the one or more strip structures 124 may be within a range of 0-80°. In some embodiments, the angle θᵢ of the one or more strip structures 124 may be within a range of 0-70°. In some embodiments, the angle θᵢ of the one or more strip structures 124 may be within a range of 0-60°. In some embodiments, the angle θᵢ of the one or more strip structures 124 may be within a range of 0-45°.

For a frequency response of the vibration component 100 requiring a high Q value and a narrow bandwidth, a relatively small angle θ (or θᵢ) of the one or more strip structures 124 may be designed. In some embodiments, the angle θ of the one or more strip structures 124 may be within a range of 0-90°. In some embodiments, the angle θ of the one or more strip structures 124 may be within a range of 0-80°. In some embodiments, the angle θ of the one or more strip structures 124 may be within a range of 0-70°. In some embodiments, the angle θ of the one or more strip structures 124 may be within a range of 0-60°. In some embodiments, the angle θ of the one or more strip structures 124 may be within a range of 0-45°. In some embodiments, the angle θᵢ of the one or more strip structures 124 may be within a range of 0-60°. In some embodiments, the angle θᵢ of the one or more strip structures 124 may be within a range of 0-80°. In some embodiments, the angle θᵢ of the one or more strip structures 124 may be within a range of 0-90°. In some embodiments, the angle θᵢ of the one or more strip structures 124 may be within a range of 0-120°. In some embodiments, the angle θᵢ of the one or more strip structures 124 may be within a range of 0-150°.

In some embodiments, a relationship between θ and θᵢ is defined as:

$$θ = - {θ}_{i} . \qquad ( Equation 7 )$$

For a frequency response of a loudspeaker requiring a low Q value and a wide bandwidth, a relatively large angle θ of the one or more strip structures 124 may be designed. In some embodiments, the angle θ of the one or more strip structures 124 may be within a range of −90°-150°. In some embodiments, the angle θ of the one or more strip structures 124 may be within a range of −45°-90°. In some embodiments, the angle θ of the one or more strip structures 124 may be within a range of 0°-60°.

For a frequency response of a loudspeaker requiring a high Q value and a narrow bandwidth, a relatively small angle θ of the one or more strip structures 124 may be designed. In some embodiments, the angle θ of the one or more strip structures 124 may be within a range of −150°-90°. In some embodiments, the angle θ of the one or more strip structures 124 may be within a range of −90°-45°. In some embodiments, the angle θ of the one or more strip structures 124 may be within a range of −60°-0°.

In some embodiments, for some irregularly shaped strip structures 124, it is impossible to design the angle of the strip structures 124. In this case, an area of the strip structure 124 may be adjusted. A stiffness of the reinforcing member may be changed without changing or by changing a mass of the reinforcing member, so that the stiffness Kt₁ provided to the system by the reinforcing member 120 and the clastic element 110 may change, further causing a resonance frequency of a flipping motion of the mass Mt₁-spring Kt₁-damping Rt₁ system to change, thereby causing the position of the third resonance position of the vibration component 100 to change. Furthermore, a 3 dB bandwidth of the third resonance peak of the vibration component 100 may also be controlled.

FIG. 16F is a schematic diagram illustrating frequency response curves of vibration components according to some embodiments of the present disclosure. By structural design of the vibration component, the second resonance peak 220 and the third resonance peak 230 of the vibration component may be merged, so that the frequency response curve of the vibration component may only reflect two resonance peaks. FIG. 16F illustrates the frequency response curves of the vibration components when angle θ of the one or more strip structure 124 is 20°, 10°, and 1°, respectively. As illustrated in FIG. 16F, as the angle θ increases, a 3 dB bandwidth of a medium and high frequency resonance peak (e.g., a resonance peak obtained after the second resonance peak 220 and the third resonance peak 230 are merged) of the vibration component gradually increases. Accordingly, by adjusting a value of the angle θ of the one or more strip structures 124, the 3 dB bandwidth of medium-and-high frequency resonance peaks of the vibration component may be adjusted. In some embodiments, by setting the angle θ of the one or more strip structures 124 to be within a range of −60°-60°, the 3 dB bandwidth of at least one medium-and-high frequency resonance peak of the vibration component may not be less than 1000 Hz.

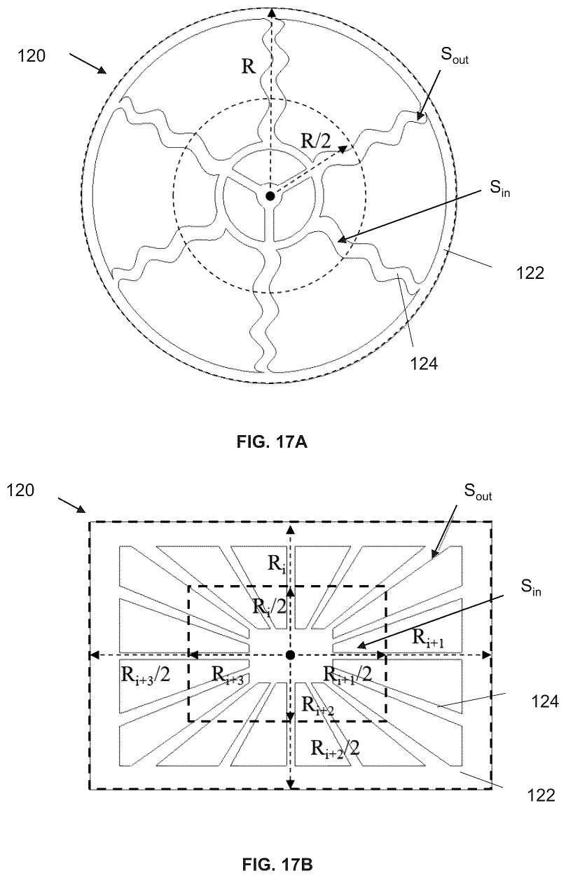

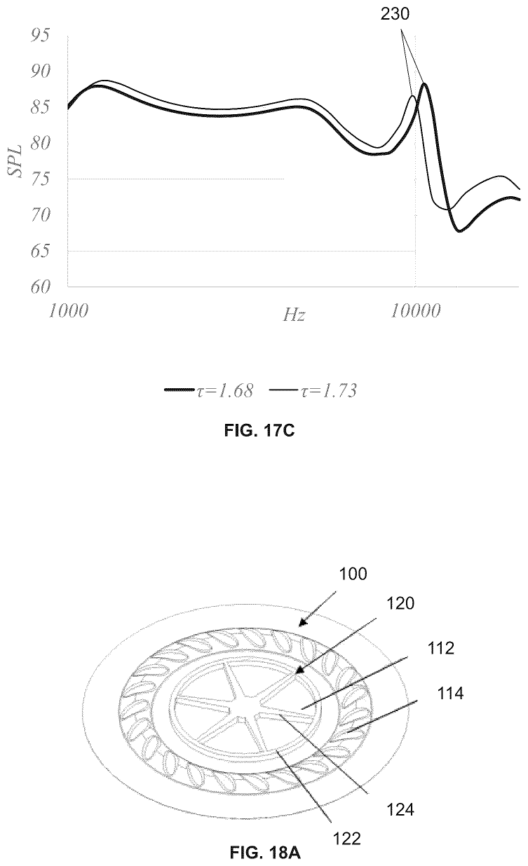

As illustrated in FIGS. 17A-17B, FIGS. 17A-17B are schematic structural diagrams illustrating reinforcing members including irregular strip structures according to some embodiments of the present disclosure. In some embodiments, in order to accurately design the irregular strip structures to adjust a resonance peak of the vibration component, as illustrated in FIG. 17A, a maximum contour of the reinforcing member 120 is defined as a circle with a radius R, and ½ of the radius R of the circle defined by the maximum contour is defined as a radius R/2. An area of a horizontal projection of the reinforcing member 120 within a range of radius R/2 is defined as Sᵢₙ, and an area of a horizontal projection (i.e. a projection in a vibration direction of the vibration component) of the reinforcing member 120 within a range between the circle with the radius R/2 and the circle with the radius R is defined as Sₒᵤₜ. A physical quantity τ is defined as a ratio of the area of the horizontal projection Sₒᵤₜ of the reinforcing member 120 to the area Sᵢₙ of the horizontal projection of the reinforcing member 120:

$${S}_{in} : τ = \frac{{S}_{out}}{{S}_{in}} .$$

In some embodiments, a mass distribution of the reinforcing member 120 may be controlled by adjusting the ratio of the area of the horizontal projection Sₒᵤₜ of the reinforcing member 120 to the area Sᵢₙ of the horizontal projection of the reinforcing member 120, thereby controlling a bandwidth of the third resonance peak of the vibration component 100. For other types of regular reinforcing members 120, as illustrated in FIG. 17B, such as an ellipse, a rectangle, a square, and other polygonal structures, a maximum contour of the reinforcing member 120 may be enveloped with a graphic similar to the reinforcing member 120, and the central region of the graphic is defined as a reference point. A distance from the reference point to each point on a contour envelope line may be R (e.g., Rᵢ, . . . , Rᵢ₊₃). All points corresponding to R/2 (e.g., Rᵢ/2, . . . , Rᵢ₊₃/2) may form a region in which the area of the horizontal projection of the reinforcing member 120 is Sᵢₙ, and a range between the distance R/2 and the distance R may form a region in which the area of the horizontal projection of the reinforcing member 120 is Sₒᵤₜ. For other irregular reinforcing members 120, a maximum contour of the reinforcing member may be enveloped with a regular graphic of a similar structure, and Sᵢₙ, Sₒᵤₜ, and the ratio τ may be defined similarly as above.

For frequency responses of some vibration components 100 requiring a low Q value and a wide bandwidth, a relatively large mass may be designed to be concentrated in the central region of the reinforcing member 120. In some embodiments, the ratio of the area Sₒᵤₜ of the horizontal projection to the area Sᵢₙ of the horizontal projection may be within a range of 0.3-2. In some embodiments, the ratio of the area Sₒᵤₜ of the horizontal projection to the area Sᵢₙ of the horizontal projection may be within a range of 0.5-1.5. In some embodiments, the ratio of the area Sₒᵤₜ of the horizontal projection to the area Sᵢₙ of the horizontal projection may be within a range of 0.5-1.2. In some embodiments, the ratio of the area Sₒᵤₜ of the horizontal projection to the area Sᵢₙ of the horizontal projection may be within a range of 0.5-1.3. In some embodiments, the ratio of the area Sₒᵤₜ of the horizontal projection to the area Sᵢₙ of the horizontal projection may be within a range of 0.5-1.4. In some embodiments, the ratio of the area Sₒᵤₜ of the horizontal projection to the area Sᵢₙ of the horizontal projection may be within a range of 0.3-1.2. In some embodiments, the ratio of the area Sₒᵤₜ of the horizontal projection to the area Sᵢₙ of the horizontal projection may be within a range of 0.3-1.6. In some embodiments, the ratio of the area Sₒᵤₜ of the horizontal projection to the area Sᵢₙ of the horizontal projection may be within a range of 0.5-2. In some embodiments, the ratio of the area Sₒᵤₜ of the horizontal projection to the area Sᵢₙ of the horizontal projection may be within a range of 0.5-2.2. In some embodiments, the ratio of the area Sₒᵤₜ of the horizontal projection to the area Sᵢₙ of the horizontal projection may be within a range of 0.3-2.2. In some embodiments, the ratio of the area Sₒᵤₜ of the horizontal projection to the area Sᵢₙ of the horizontal projection may be within a range of 0.3-2.

For frequency responses of some vibration components 100 requiring a high Q value and a narrow bandwidth, a relatively large mass may be designed to be concentrated in a peripheral region of the reinforcing member 120. In some embodiments, the ratio of the area Sₒᵤₜ of the horizontal projection to the area Sᵢₙ of the horizontal projection may be within a range of 1-3. In some embodiments, the ratio of the area Sₒᵤₜ of the horizontal projection to the area Sᵢₙ of the horizontal projection may be within a range of 1.2-2.8. In some embodiments, the ratio of the area Sₒᵤₜ of the horizontal projection to the area Sᵢₙ of the horizontal projection may be within a range of 1.4-2.6. In some embodiments, the ratio of the area Sₒᵤₜ of the horizontal projection to the area Sᵢₙ of the horizontal projection may be within a range of 1.6-2.4. In some embodiments, the ratio of the area Sₒᵤₜ of the horizontal projection to the area Sᵢₙ of the horizontal projection may be within a range of 1.8-2.2. In some embodiments, the ratio of the area Sₒᵤₜ of the horizontal projection to the area Sᵢₙ of the horizontal projection may be within a range of 1.2-2. In some embodiments, the ratio of the area Sₒᵤₜ of the horizontal projection to the area Sᵢₙ of the horizontal projection may be within a range of 1-2. In some embodiments, the ratio of the area Sₒᵤₜ of the horizontal projection to the area Sᵢₙ of the horizontal projection may be within a range of 2-2.8. In some embodiments, the ratio of the area Sₒᵤₜ of the horizontal projection to the area Sᵢₙ of the horizontal projection may be within a range of 2-2.5.

In some embodiments, by adjusting the ratio of the area Sₒᵤₜ of the horizontal projection to the area Sᵢₙ of the horizontal projection, a resonance frequency of a flipping motion of the vibration component during vibration may also be changed, thereby causing a position of the third resonance peak to change. FIG. 17C is a schematic diagram illustrating frequency response curves of vibration components according to some embodiments of the present disclosure. As illustrated in FIG. 17C, FIG. 17C illustrates frequency response curves of the vibration components when values of t are 1.68 and 1.73, respectively. 3 dB bandwidths of the two frequency response curves at the third resonance peak 230 are narrow. Furthermore, when the value of t increases from 1.68 to 1.73, the third resonance peak 230 moves to a low frequency. Accordingly, as the value of t increases, a frequency corresponding to the third resonance peak 230 may decrease. By adjusting the value of t of the vibration component, the bandwidth and the position of the third resonance peak may be effectively adjusted.

In some embodiments, an area of one or more hollow regions (corresponding to a suspension region of the central region 112 within a projection range of the reinforcing member 120) of the reinforcing member 120 may be changed by adjusting a count (e.g., within a range of 1-10) of the one or more ring structures 122, such that a relationship (the area-thickness ratio μ) between the area of the one or more hollow regions and a thickness of the elastic element 110 may be adjusted, so as to adjust the fourth resonance peak. A relationship (the ratio γ of the areas of the one or more hollowed regions) between the areas of the hollow regions of different ring structures 122 of the reinforcing member 120 may be changed to adjust the fourth resonance peak. A relationship (the ratio β of the horizontal area of the reinforcing part of the reinforcing member 120 to the horizontal area of the reinforcing member) between a horizontal area of a reinforcing part of the reinforcing member 120 and a horizontal area of the reinforcing member 120 may also be changed to adjust the first resonance peak, the third resonance peak, and the fourth resonance peak.

In some embodiments, the one or more ring structures 122 may include a first ring structure and a second ring structure of which centroids coincide with each other, in which case a radial dimension of the first ring structure may be less than a radial dimension of the second ring structure. In some embodiments, the one or more strip structures 124 may also include at least one first strip structure and at least one second strip structure. The at least one first strip structure may be disposed at an inner side the first ring structure and connected with the first ring structure. The at least one second strip structure may be disposed between the first ring structure and the second ring structure and connected with the first ring structure and the second ring structure, respectively, so that the reinforcing member 120 may form a plurality of different hollows regions.

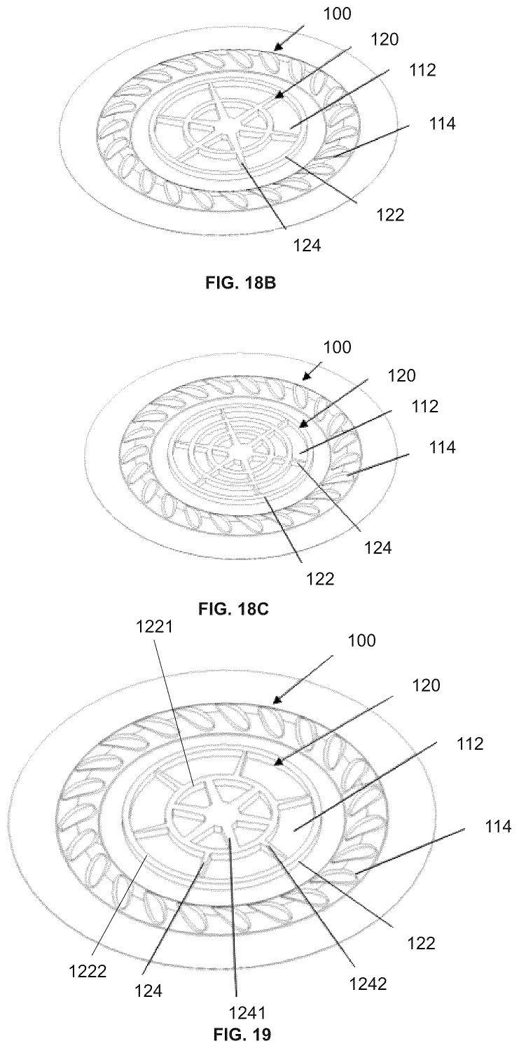

As illustrated in FIGS. 18A-18C, FIGS. 18A-18C are schematic structural diagrams illustrating vibration components including different counts of ring structures according to some embodiments of the present disclosure. The one or more ring structures 122 in FIG. 18A may be single-ring structures. The one or more ring structures 122 in FIG. 18B may be double-ring structures. The one or more ring structures 122 in FIG. 18C may be three-ring structures. By designing the count of the one or more ring structures 122, a mass and a stiffness of the reinforcing member 120 may be adjusted, and areas of one or more hollow regions of the central region 112 may be adjusted. In some embodiments, the count of the one or more ring structures 122 may be within a range of 1-10. In some embodiments, the count of the one or more ring structures 122 may be within a range of 1-5. In some embodiments, the count of the one or more ring structures 122 may be within a range of 1-3.

In some embodiments, by adjusting the count of the one or more ring structures 122, the mass of the reinforcing member 120 may be adjusted, so that a total equivalent mass Mt formed by the combination of the mass of the reinforcing member 120, a mass of the elastic element 110, an equivalent air mass, and a driving end equivalent mass may change, and a resonance frequency of a mass Mt-spring Kt-damping Rt system may change, thereby causing a first-order resonant frequency of the vibration component 100 to change.

In some embodiments, by adjusting the count of the one or more ring structures 122, the stiffness of the reinforcing member 120 may also be adjusted, so that the stiffness Kt₁ provided to the system by the reinforcing member 120 and the clastic element 110 (especially a region of the central region 112 covered by the reinforcing member 120) may change, which further causes a resonance frequency of a flipping motion of the mass Mt₁-spring Kt₁-damping Rt₁ system to change, thereby causing a position of the third resonance position of the vibration component 100 to change. In some embodiments, by adjusting the count of the one or more ring structures 122, a stiffness distribution of the one or more strip structures 124 extending to different positions from a center to a periphery may be different. When a driving end frequency is close to the resonance frequency of the mass Mt₁-spring Kt₁-damping Rt₁ system, the connection region 115, the folded ring region 114, and a local suspension region disposed between the region of the central region 112 covered by the reinforcing member 120 and the folded ring region may be driven by the reinforcing member 120 to vibrate, thereby obtaining a resonance peak with an adjustable 3 dB bandwidth.

In some embodiments, by adjusting the count of the one or more ring structures 122, the areas of the one or more hollow regions of the central region 112 may also be adjusted, so that an equivalent mass Mmᵢ, equivalent stiffnesses Kaᵢ and Kaᵢ′, and equivalent damping Raᵢ and Raᵢ′ of each of the one or more hollow regions may change, so that the position of the fourth resonance peak of the vibration component 100 may change.

In some embodiments, by adjusting the count of the one or more ring structures 122, a dimension of an outermost ring structure 122 may also be adjusted, and an area of a local hollow region between a region of the central region 112 covered by the reinforcing member 120 and the folded ring region 114 may be adjusted. The local hollow region, the connection region 115, and the folded ring region 114 may form an equivalent mass Ms, an equivalent stiffness Ks, and equivalent damping Rs. By adjusting an area of a local suspension region between the region of the central region 112 covered by the reinforcing member 120 and the folded ring region 114, a resonance frequency of the mass Ms-spring Ks-damping Rs system may be changed, thereby adjusting the position of the second resonance peak of the vibration component 100.

In some embodiments, by adjusting the count of the one or more ring structures 122, the fourth resonance peak of the vibration component 100 may be located within a range of 10 KHz-18 kHz. A ratio of an area Sᵢ of each of the one or more hollow regions to a thickness Hᵢ of a diaphragm of each of the one or more hollow regions may be an area-thickness ratio μ within a range of 150 mm-700 mm. A ratio γ of an area Sₖᵢ to an area Sⱼᵢ of the one or more hollow regions of any two elastic elements 110 may be within a range of 0.25-4. A ratio β of a horizontal area of the reinforcing part of the reinforcing member 120 to a horizontal area of the reinforcing member 120 may be within a range of 0.2-0.7. In some embodiments, by adjusting the count of the one or more ring structures 122, the fourth resonance peak of the vibration component 100 may be located within the range of 10 kHz-18 kHz. The ratio of the area Sᵢ of each of the one or more hollow regions to the thickness Hᵢ of the diaphragm of each of the one or more hollow regions may be the area-thickness ratio μ within a range of 100 mm-1000 mm. The ratio γ of the area Sₖᵢ to the area Sⱼᵢ of the one or more hollow regions of any two elastic elements 110 may be within a range of 0.1-10. The ratio β of the horizontal area of the reinforcing part of the reinforcing member 120 to the horizontal area of the reinforcing member 120 may be within a range of 0.1-0.8.

As illustrated in FIG. 19, FIG. 19 is a schematic structural diagram illustrating a vibration component including discontinuous strip structures corresponding to an inner ring and an outer ring according to some embodiments of the present disclosure. In some embodiments, when the vibration component 100 includes at least two ring structures, at least two ring structures 122 may divide one or more strip structures into a plurality of regions along a direction extending from a center of the one or more strip structures 124 to a periphery. The one or more strip structures 124 in each region may be arranged continuously or discontinuously. In some embodiments, the one or more ring structures 122 of the vibration component 100 may include at least a first ring structure 1221. For example, the one or more ring structures 122 may include the first ring structure 1221 and a second ring structure 1222 of which centroids coincide with each other, and a radial dimension of the first ring structure 1221 may be less than a radial dimension of the second ring structure 1222. In some embodiments, the one or more strip structures 124 may include at least one first strip structure 1241 and at least one second strip structure 1242. Any one of the at least one first strip structure 1241 may be disposed at a first position of an inner side of the first ring structure 1221 and connected with the first ring structure 1221. Any one of the at least one second strip structure 1242 may be connected with an outer side of the first ring structure 1221 at a second position. A plurality of first strip structures 1241 may be connected to a plurality of first positions, and a plurality of second strip structures 1242 may be connected to a plurality of second positions. In some embodiments, a connection line between at least one of the plurality of first positions and a center of the first ring structure 1221 may not pass through any one of the plurality of second positions. In some embodiments, a connection line between at least one of the plurality of second positions and the center of the first ring structure 1221 may not pass through any one of the plurality of first positions. In some embodiments, the plurality of first positions and the plurality of second positions may be different, i.e., the plurality of first positions, the plurality of second positions, and the center of the first ring structure 1221 may not be collinear, and the plurality of first strip structures 1241 and the plurality of second strip structures 1242 may be connected with the first ring structure 1221 at different positions. In some embodiments, a count of the plurality of first strip structures 1241 and a count of the plurality of second strip structures 1242 may be the same or different.

Through the discontinuous arrangement of the one or more strip structures 124 in the inner and outer regions of the one or more ring structures 122, the counts of the one or more strip structures 124 in the inner and outer regions of the one or more ring structures 122 may be different, horizontal widths of the one or more strip structures 124 in the inner and outer regions of the one or more ring structures 122 may be different, and horizontal shapes of the one or more strip structures 124 in the inner and outer regions of the one or more ring structures 122 may be different, so that the mass, the stiffness and the centroid distribution of the reinforcing member 120, the count and the area of the one or more hollow regions of the central region 112 may be adjusted within a relatively large range.

In some embodiments, by adjusting the mass of the reinforcing member 120, the total equivalent mass Mt may be controlled to change, so that a resonance frequency of a mass Mt-spring Kt-damping Rt system may change, thereby causing a first-order resonance frequency of the vibration component 100 to change. By adjusting the stiffness of the reinforcing member 120, a resonance frequency of a flipping motion of a Mt₁-spring Kt₁-damping Rt₁ system may be adjusted, thereby causing the position of the third resonance peak of the vibration component 100 to change, making a stiffness distribution of the one or more strip structures 124 extending to different positions from a center to a periphery different, and realizing an adjustable resonance peak with a 3 dB bandwidth of the vibration component 100. By adjusting the count and the areas of the one or more hollow regions of the central region 112, the position and a sensitivity of the fourth resonance peak of the vibration component 100 may be changed.

In some embodiments, the one or more strip structures 124 in the inner and outer regions of the one or more ring structures 122 may be arranged discontinuously, so that the fourth resonance peak of the vibration component 100 may be located within a range of 10 kHz-18 kHz, an area-thickness ratio μ of an area Si of each of the one or more hollow regions to a thickness Hᵢ of the elastic element 110 of each of the one or more hollow regions may be within a range of 150 mm-700 mm, a ratio γ of an area Sₖᵢ to an area Sⱼᵢ of the one or more hollow regions of any two elastic elements 110 may be within a range of 0.25-4, and a ratio β of a horizontal area of the reinforcing part of the reinforcing member 120 to a horizontal area of the reinforcing member 120 may be within a range of 0.2-0.7. In some embodiments, the one or more strip structures 124 in the inner and outer regions of the one or more ring structures 122 may be arranged discontinuously, so that the fourth resonance peak of the vibration component 100 may be located within the range of 10 kHz-18 kHz, the area-thickness ratio μ of the area Si of each of the one or more hollow regions to the thickness Hᵢ of the diaphragm of each of the one or more hollow regions may be within a range of 100 mm-1000 mm, the ratio γ of the area Sₖᵢ to the area Sⱼᵢ of the one or more hollow regions of any two elastic elements 110 may be within a range of 0.1-10, and the ratio β of the horizontal area of the reinforcing part of the reinforcing member 120 to the horizontal area of the reinforcing member 120 may be within a range of 0.1-0.8.

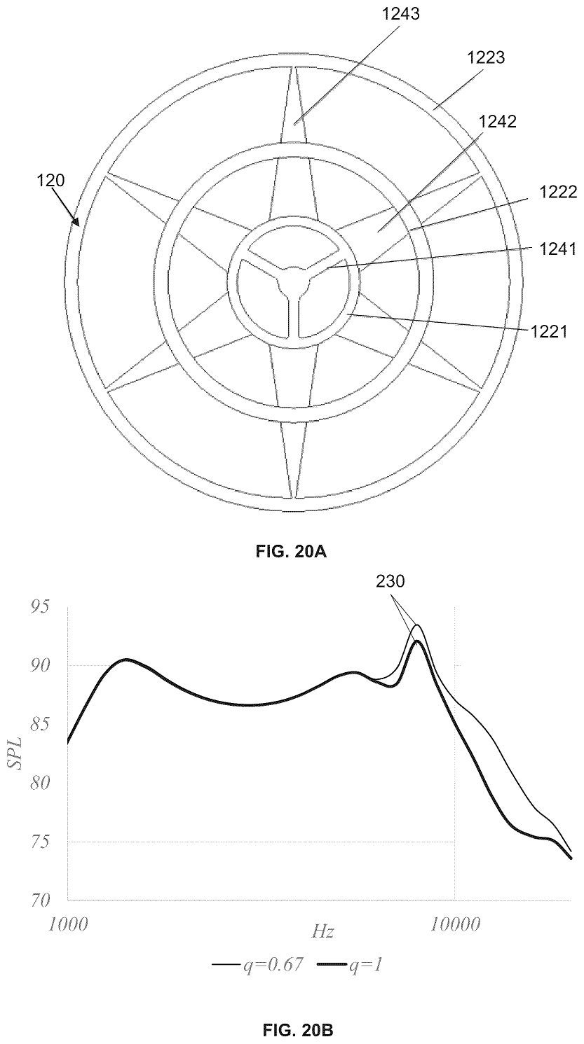

As illustrated in FIG. 20A, FIG. 20A is a schematic structural diagram illustrating a vibration component including one or more ring structures according to some embodiments of the present disclosure. In some embodiments, spacing regions of the one or more ring structures 122 may be designed by designing the one or more ring structures 122. A mass distribution of the reinforcing member 120 may be adjusted by designing a count of one or more strip structures 124 in different spacing regions. It should be noted that the count, shapes, and positions of the one or more strip structures 124 designed in the spacing regions of the one or more ring structure 122 may be different.

In some embodiments, the one or more ring structure 122 from a center outward may be defined as the first ring structure 1221, the second ring structure 1222, a third ring structure 1223, . . . , an nth ring structure. A strip structure 124 in a spacing region between the nth ring structure and an n−1th ring structure may be an nth strip structure (e.g., the first strip structure 1241, the second strip structure 1242, and a third strip structure 1243). A count of the nth strip structures (i.e., the strip structures connected to an inner side of the nth ring structure) is defined as Qₙ, wherein n is a natural number. A physical quantity q is defined as a ratio of a count Qᵢ of ith strip structures to a count Qⱼ of jth strip structures:

$$q = \frac{{Q}_{i}}{{Q}_{j}} . \qquad ( Equation 8 )$$

In some embodiments, the ratio q of the count Qᵢ of the ith strip structures to the count Qⱼ of the jth strip structures may be within a range of 0.05-20. In some embodiments, the ratio q of the count Qᵢ of the ith strip structures to the count Qⱼ of the jth strip structures may be within a range of 0.1-10. In some embodiments, the ratio q of the count Qᵢ of the ith strip structures to the count Qⱼ of the jth strip structures may be within a range of 0.1-8. In some embodiments, the ratio q of the count Qᵢ of the ith strip structures to the count Qⱼ of the jth strip structures may be within a range of 0.1-6. In some embodiments, the ratio q of the count Qᵢ of the ith strip structures to the count Qⱼ of the jth strip structures may be within a range of 0.2-5. In some embodiments, the ratio q of the count Qᵢ of the ith strip structures to the count Qⱼ of the jth strip structures may be within a range of 0.3-4. In some embodiments, the ratio q of the count Qᵢ of the ith strip structures to the count Qⱼ of the jth strip structures may be within a range of 0.5-6. In some embodiments, the ratio q of the count Qᵢ of the ith strip structures to the count Qⱼ of the jth strip structures may be within a range of 1-4. In some embodiments, the ratio q of the count Qᵢ of the ith strip structures to the count Qⱼ of the jth strip structures may be within a range of 1-2. In some embodiments, the ratio q of the count Qᵢ of the ith strip structures to the count Qⱼ of the jth strip structures may be within a range of 0.5-2.

In some embodiments, the spacing regions of the one or more ring structures 122 may be designed by designing the one or more ring structures 122, and the mass distribution of the reinforcing member 120 may be achieved by designing the count of the one or more strip structures 124 in different spacing regions, so that under the condition that the mass of the reinforcing member 120 is constant or changes, the equivalent stiffness Kt₁ of the reinforcing member 120 and the diaphragm may be changed by changing the stiffness of the reinforcing member 120, then the resonance frequency of the flipping motion of the mass Mt₁-spring Kt₁-Rt₁ system may change, thereby causing the position of the third resonant peak of a loudspeaker to change.

FIG. 20B is a schematic diagram illustrating frequency response curves of vibration components according to some embodiments of the present disclosure. Two frequency response curves illustrated in FIG. 20B are frequency response curves of the vibration components when q=0.67 and q=0.1, respectively. Frequencies of third resonance peaks 230 of the two frequency response curves are close to each other. However, an amplitude of the third resonance peak 230 of the frequency response curve corresponding to q=0.67 is higher than an amplitude of the third resonance peak of the frequency response curve corresponding to q=0.1. Accordingly, it can be seen from FIG. 20B that by adjusting the value of q, the amplitude change of the third resonance peak may be controlled to change, thereby adjusting a sensitivity of the vibration component. In some embodiments, when the value of q is within a range of 0.2-5, the vibration component may have a relatively high sensitivity.

In some embodiments, a shape of the one or more ring structures 122 may include at least one of a circular ring, an elliptical ring, a polygonal ring, and a curved ring. By designing the one or more ring structures 122 of different shapes and/or different dimensions, a quality and a stiffness of the reinforcing member 120 may be adjusted, and areas of one or more hollow regions of the central region 112 may be adjusted.

In some embodiments, a dimension and a shape of the suspension region 1121 may be adjusted by adjusting a dimension and a shape of a region of the central region 112 covered by the reinforcing member 120 and a dimension and a shape of the reinforcing member 120. In some embodiments, a total area of a horizontal projection (i.e., a projection in a vibration direction of the vibration component) of the suspension region 1121 and the folded ring region 114 may be adjusted by adjusting an area and a shape of the folded ring region 114. A second resonance peak of the vibration component 100 may be accurately controlled to be located within a required frequency range by controlling the total area of the horizontal projection of the suspension region 1121 and the folded ring region 114, a thickness of the clastic element 110, a folded ring arch height and other data. In some embodiments, the second resonance peak of the vibration component 100 may be located within a range of 3000 Hz-7000 Hz. In some embodiments, a vibration displacement of a local region of the vibration component 100 in a second resonance peak frequency range may be adjusted by controlling a ratio of an area of the suspension region 1121 to an area of the folded ring region 114, thereby maximizing an output sensitivity of the vibration component 100 at the position of the second resonance peak.

In some embodiments, by adjusting a relationship between dimensions of the folded ring region 114 and the suspension region 1121 of the vibration component 100 and a thickness of the clastic element 110, a local equivalent mass Mm₃ and a local equivalent mass Mm₂, a local regional stiffness Ka₂′ and a local area stiffness Ka₁′ may be controlled to ensure that the second resonance peak of the vibration component 100 is within the required frequency range. In some embodiments, by changing shapes of the one or more ring structures 122, a ratio α of Sₛ to a thickness Hᵢ of a diaphragm may be within a range of 5000 mm-12000 mm, and the second resonance peak of the vibration component 100 may be located within a range of 3000 Hz-7000 Hz. In some embodiments, by changing the shapes of the one or more ring structures 122, the ratio α of Sₛ to the thickness Hᵢ of the diaphragm may be within a range of 6000 mm-10000 mm, and the second resonance peak of the vibration component 100 may be located within the range of 3000 Hz-7000 Hz.

In some embodiments, based on a relationship between dimensions of the folded ring region 114 and the suspension region 1121 and a dimension of the folded ring arch height of the folded ring region 114, the folded ring arch height may be adjusted such that a three-dimensional dimension of the folded ring region 114 of the elastic element 110 may be changed without changing areas of horizontal projections of the folded ring region 114 and the suspension region 1121, thereby changing the stiffness Ka₁′ of the folded ring region 114, and controlling the second resonance peak of the vibration component 100. In some embodiments, a ratio δ of Sₛ to a folded ring arch height Δh may be within a range of 50 mm-600 mm. In some embodiments, the ratio δ of Sₛ to the folded ring arch height Δh may be within a range of 100 mm to 500 mm. In some embodiments, the ratio δ of Sₛ to the folded ring arch height Δh may be within a range of 200 mm-400 mm.

In some embodiments, based on a relationship between the dimension of the suspension region 1121 and the area of the central region 112, the reinforcing member 120 may achieve a certain bending deformation in a specific frequency range, and sound pressures in different regions of the elastic element 110 may be increased and decreased by superposition to achieve a maximum sound pressure level output. In some embodiments, a ratio ϑ of an area Sᵥ of a horizontal projection of the suspension region 1121 to an area S_{c} of a horizontal projection of a diaphragm center of the vibration component 100 may be within a range of 0.05-0.7. In some embodiments, the ratio ϑ of the area Sᵥ of the horizontal projection of the suspension region 1121 to the area S_{c} of the horizontal projection of the diaphragm center of the vibration component 100 may be within a range of 0.1-0.5. In some embodiments, the ratio ϑ of the area Sᵥ of the horizontal projection of the suspension region 1121 to the area S_{c} of the horizontal projection of the diaphragm center of the vibration component 100 may be within a range of 0.15-0.35.

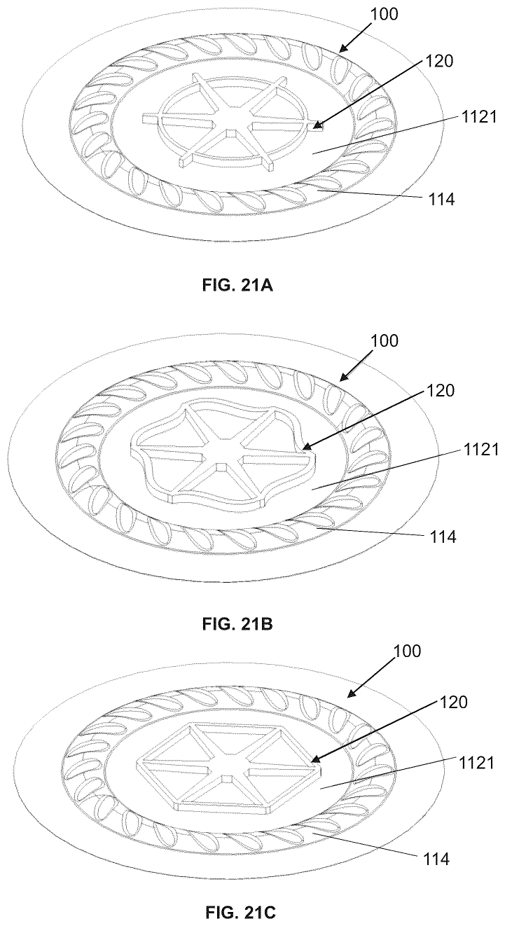

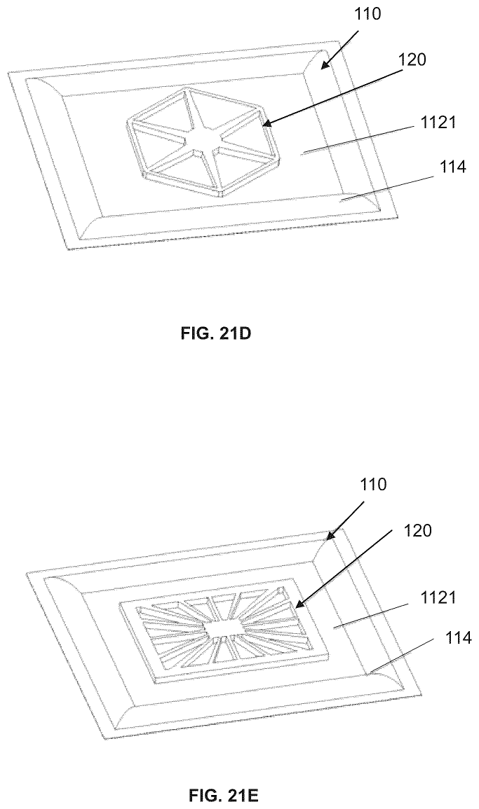

As illustrated in FIGS. 21A-21E, FIGS. 21A-21E are schematic structural diagrams illustrating vibration components with different structures according to some embodiments of the present disclosure. In some embodiments, an outer contour of the reinforcing member 120 may be a structure (as illustrated in FIG. 21A) including outwardly extending spokes, or may be a circular ring structure, an elliptical ring structure, or a curved ring structure (as illustrated in FIG. 21B), a polygon, other irregular ring structures, etc. The polygon may include a triangle, a quadrilateral, a pentagon, a hexagon (as illustrated in FIGS. 21C-21D), a heptagon, an octagon, a nonagon, a decagon, or the like. In some embodiments, the clastic element 110 may also be a polygon, such as a triangle, a quadrilateral (as illustrated in FIG. 21D and FIG. 21E), a pentagon, a hexagon, a heptagon, an octagon, a nonagon, a decagon, or the like, or other irregular shapes. The reinforcing member 120 may be designed to have a similar or dissimilar structure, thereby controlling the shape of the suspension region 1121 through the reinforcing member 120, the central region 112, and a shape of a folded ring of the folded ring region 114, and then adjusting the performance of the vibration component 100.

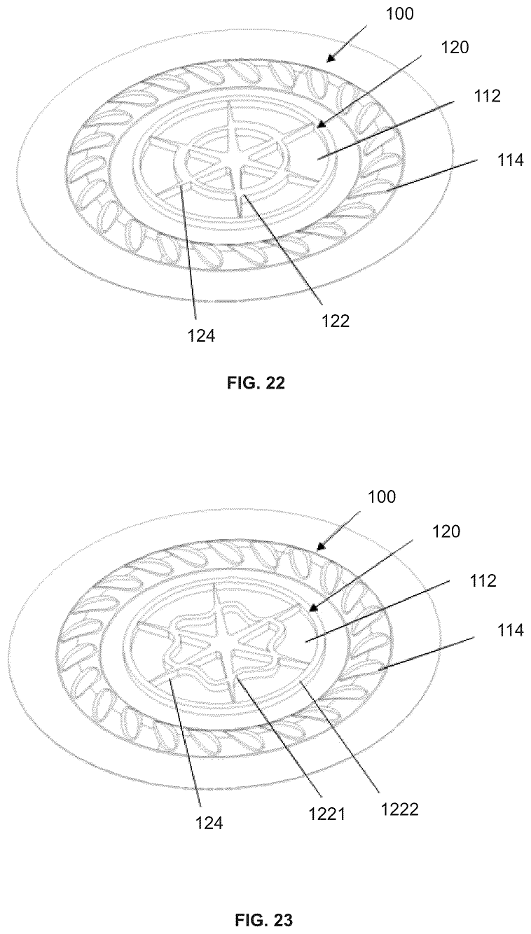

As illustrated in FIG. 22, FIG. 22 is a schematic structural diagram illustrating a vibration component including ring structures with variable width according to some embodiments of the present disclosure. In some embodiments, by designing local structures with unequal widths at different positions of any one of the one or more ring structures 122, a mass of the reinforcing members 120 may be effectively adjusted, and the total equivalent mass Mt may be adjusted, and thus a resonance frequency of the mass Mt-spring Kt-damping Rt system may change, thereby causing a first-order resonant frequency of the vibration component 100 to change. Meanwhile, by designing local structures with unequal widths at different positions (e.g., adjacent positions) of any one of the one or more ring structure 122, a stiffness and a centroid distribution of the reinforcing member 120 may be adjusted, thereby adjusting a resonance frequency of a flipping motion of the Mt1-spring Kt1-damping Rt1 system, causing a third resonance peak of the vibration component 100 to change. The design of the one or more ring structures 122 with unequal widths may also make a stiffness distribution of the one or more strip structures 124 extending to different positions from a center to a periphery different, thereby obtaining the third resonance peak with an adjustable 3 dB bandwidth of the vibration component 100. Furthermore, the design of the one or more ring structures 122 with unequal widths may also adjust a count and an area of the suspension region of the central region 112, so that a position and a sensitivity of the fourth resonance peak of the vibration component 100 may be changed. For example, two sides of at least one of the one or more ring structures 122 at a connection position with any one of the one or more strip structures 124 may have different radial widths, as illustrated in FIG. 22. As another example, at least one of the one or more ring structures 122 may have different circumferential widths between connection positions of the at least one ring structure 122 with any two of the one or more strip structures 124.

In some embodiments, local structures with unequal widths may be designed at any position (e.g., adjacent positions) of any one of the one or more ring structures 122, so that the fourth resonance peak of the vibration component 100 may be located within a range of 15 kHz-18 kHz, an area-thickness ratio μ of an area Sᵢ of each of the one or more hollow regions to a thickness Hᵢ of a diaphragm of each of the one or more hollow regions may be within a range of 150 mm-700 mm, a ratio γ of an area Sₖᵢ to an area Sⱼᵢ of the one or more hollow regions of any two clastic elements 110 may be within a range of 0.25-4, and a ratio β of a horizontal area of the reinforcing part of the reinforcing member 120 to a horizontal area of the reinforcing member 120 may be within a range of 0.2-0.7. In some embodiments, the local structures with unequal widths may be designed at any position of any one of the one or more ring structures 122, so that the fourth resonance peak of the vibration component 100 may be located within a range of 15 kHz-18 kHz, the area-thickness ratio μ of the area Sᵢ of each of the one or more hollow regions to the thickness Hᵢ of the diaphragm of each of the one or more hollow regions may be within a range of 100 mm-1000 mm, the ratio γ of the area Sₖᵢ to the area Sⱼᵢ of the one or more hollow regions of any two elastic elements 110 may be within a range of 0.1-10, and the ratio β of the horizontal area of the reinforcing part of the reinforcing member 120 to the horizontal area of the reinforcing member 120 may be within a range of 0.1-0.8.

As illustrated in FIG. 23, FIG. 23 is a schematic structural diagram illustrating a vibration component including irregular ring structures according to some embodiments of the present disclosure. In some embodiments, by designing local structures at different positions of different ring structures 122, such as a circle, a rectangle, a square, a triangle, a hexagon, an octagon, another polygon, an ellipse, and other irregular ring structures 122, dimensions, positions, and shapes of local regions of the one or more ring structure 122 may be more flexibly controlled, a mass of the reinforcing member 120 may be effectively adjusted, and a total equivalent mass Mt may be controlled to change, so that a resonance frequency of a mass Mt-spring Kt-damping Rt system may change, thereby causing a first resonance frequency of the vibration component 100 to change. By adjusting a stiffness of the reinforcing member 120 and a centroid distribution of the reinforcing member 120, a resonance frequency of a flipping motion of a Mt₁-spring Kt₁-damping Rt₁ system may be adjusted, thereby changing a position of a third resonance peak of the vibration component 100, making a stiffness distribution of the one or more strip structures 124 extending to different positions from a center to a periphery different, and thus obtaining the third resonance peak with an adjustable 3 dB bandwidth of the vibration component 100. Meanwhile, a count and an area of a suspension region of the central region 112 may be effectively adjusted, so that a position and a sensitivity of a fourth resonance peak of the vibration component 100 may change. In addition, by designing the irregular structures, stress concentration may be effectively avoided, resulting in a smaller deformation of the reinforcing member 120.

In some embodiments, as illustrated in FIG. 23, the reinforcing member 120 may include a double-ring structure, which includes a first ring structure 1221 located at an inner side and a second ring structure 1222 located at an outer side. In some embodiments, a shape of the first ring structure 1221 and a shape of the second ring structure 1222 may be different. In some embodiments, the shape of the first ring structure 1221 may be a curved ring shape, and the shape of the second ring structure 1222 may be a circular ring shape. In some embodiments, by designing the irregular ring structures 122, the fourth resonance peak of the vibration component 100 may be located within the range of 10 KHz-18 kHz, the area-thickness ratio μ of the area Sᵢ of each of the one or more hollow regions to the thickness Hᵢ of the diaphragm of each of the one or more hollow regions may be within the range of 150 mm-700 mm, the ratio γ of the area Sₖᵢ to the area Sⱼᵢ of the one or more hollow regions of any two elastic elements 110 may be within a range of 0.25-4, and the ratio β of the horizontal area of the reinforcing part of the reinforcing member 120 to the horizontal area of the reinforcing member 120 may be within a range of 0.2-0.7. In some embodiments, by designing the irregular ring structures 122, the fourth resonance peak of the vibration component 100 may be located within the range of 10 kHz-18 kHz, the area-thickness ratio μ of the area Sᵢ of each of the one or more hollow regions to the thickness Hᵢ of the diaphragm of each of the one or more hollow regions may be within a range of 100 mm-1000 mm, the ratio γ of the area Sₖᵢ to the area Sⱼᵢ of the one or more hollow regions of any two clastic elements 110 may be within a range of 0.1-10, and the ratio β of the horizontal area of the reinforcing part of the reinforcing member 120 to the horizontal area of the reinforcing member 120 may be within a range of 0.1-0.8.

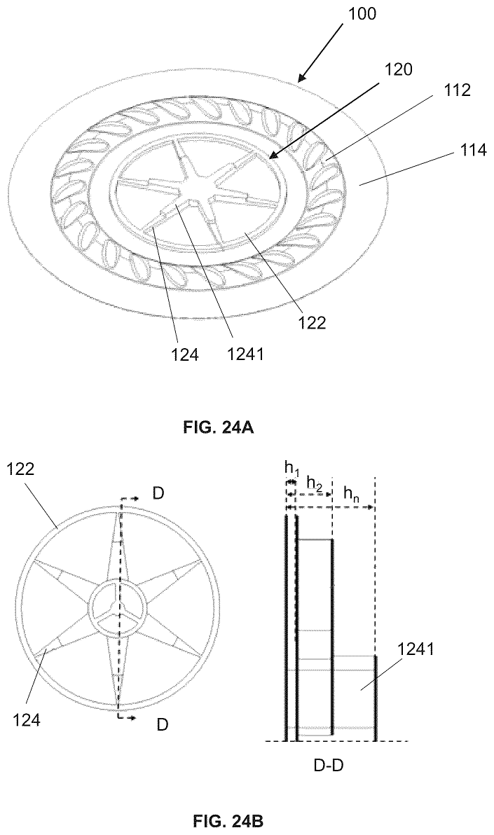

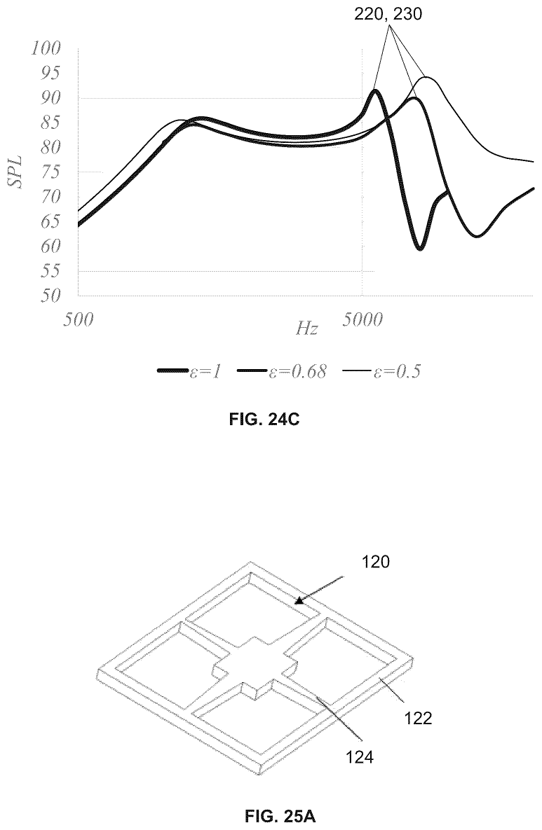

As illustrated in FIGS. 24A-24B, FIG. 24A is a schematic structural diagram illustrating a vibration component including one or more strip structures with step structures according to some embodiments of the present disclosure. FIG. 24B is a schematic structural diagram illustrating a vibration component including one or more strip structures with step structures according to some embodiments of the present disclosure. In some embodiments, as illustrated in FIG. 24A, by designing the reinforcing member 120 including the one or more strip structures 124 with the step structures, a stiffness, a mass, and a centroid distribution of the reinforcing member 120 may be changed without changing one or more hollow regions (affecting a fourth resonance peak of the vibration component 100) and the suspension region 1121 (affecting a second resonance peak of the vibration component 100) of the central region 112, thereby effectively adjusting a position of a first resonance peak, a position of a third resonance peak, and a bandwidth of the vibration component without changing the second resonance peak and the fourth resonance peak of the vibration component 100. Different frequency response curves may be adjusted based on actual application requirements.

In some embodiments, by designing thicknesses of different regions of the reinforcing member 120 from a thickness direction (i.e., in a vibration direction of the vibration component 100), a stiffness of the reinforcing member 120 may be changed without changing or changing a mass of the reinforcing member 120 based on an actual required mass distribution, so that the stiffness Kt₁ provided to the system by the reinforcing member 120 and the elastic element 110 may change, further causing a resonance frequency of a flipping motion of a mass Mt₁-spring Kt₁-damping Rt₁ system to change, thereby causing the position of the third resonance position of the vibration component 100 to change. Furthermore, a 3 dB bandwidth of the third resonance peak of the vibration component 100 may also be controlled.

In some embodiments, the one or more strip structures 124 may have a plurality of steps with different thicknesses in the vibration direction of the elastic element 110, i.e., the one or more strip structures 124 may have a stepped shape. In some embodiments, at least one of the one or more strip structures may have the stepped shape. In some embodiments, all of the one or more strip structures may have the stepped shape. FIG. 24B illustrates a structure including a reinforcing member 120 with one or more step-shaped strip structures 124, and a cross-sectional structure of a D-D cross section thereof. A thickness of an outmost edge step (i.e., a first step located at a radial outermost side of the one or more strip structures 124) of the reinforcing member 120 is defined as h₁, a thickness of a secondary outmost edge step of the reinforcing member 120 is defined as h₂, . . . , a thickness of a center step (i.e., a second step located at a radial innermost side of the one or more strip structures 124) is defined as hₙ, and a physical quantity ϵ is defined as a ratio of a thickness hⱼ to a thickness hₖ (k>j) of any two steps:

$$ϵ = \frac{{h}_{j}}{{h}_{k}} . \qquad ( Equation 9 )$$

A physical quantity φ is defined as a ratio of the thickness h₁ of the outmost edge step (i.e., the first step located at the radial outermost side of the one or more strip structures 124) of the reinforcing member 120 to the thickness hₙ of the center step (i.e., the second step located at the radial innermost side of the one or more strip structures 124):

$$φ = \frac{{h}_{1}}{{h}_{n}} . \qquad ( Equation 10 )$$

In some embodiments, the ratio ϵ of the thickness hⱼ to the thickness hₖ of any two steps may be within a range of 0.1-10. In some embodiments, the ratio ϵ of the thickness hⱼ to the thickness hₖ of any two steps may be within a range of 0.1-8. In some embodiments, the ratio ϵ of the thickness hⱼ to the thickness hₖ of any two steps may be within a range of 0.2-8. In some embodiments, the ratio ϵ of the thickness hⱼ to the thickness hₖ of any two steps may be within a range of 0.1-7. In some embodiments, the ratio ϵ of the thickness hⱼ to the thickness hₖ of any two steps may be within a range of 0.1-6. In some embodiments, the ratio ϵ of the thickness hⱼ to the thickness hₖ of any two steps may be within a range of 0.2-6. In some embodiments, the ratio ϵ of the thickness hⱼ to the thickness hr of any two steps may be within a range of 0.2-5. In some embodiments, the ratio ϵ of the thickness hⱼ to the thickness hₖ of any two steps may be within a range of 0.25-4.

In some embodiments, by designing the thicknesses of different regions of the reinforcing member 120, a mass distribution of the reinforcing member 120 may be adjusted, thereby changing a stiffness of the reinforcing member 120 without changing or changing a mass of the reinforcing member 120, so that a stiffness Kt₁ provided to the system by the reinforcing member 120 and the clastic element 110 may change, thus adjusting a position of a third resonance peak of the vibration component 100, and controlling a 3 dB bandwidth of the third resonance peak of the vibration component 100.

FIG. 24C illustrates frequency response curves of vibration components according to other embodiments of the present disclosure. By the structural design of the vibration component, the second resonance peak 220 and the third resonance peak 230 of the vibration component may be merged. The frequency response curve of the vibration component may only reflect two resonance peaks. FIG. 24C illustrates frequency response curves of the vibration components corresponding to ϵ=1, ϵ=0.68, and ϵ=0.5, respectively. As illustrated in FIG. 24C, positions of medium and high frequency resonance peaks (e.g., the resonance peak obtained after the second resonance peak 220 and the third resonance peak 230 are merged) of the frequency response curves corresponding to ϵ=1, ϵ=0.68, and ϵ=0.5 are different, and 3 dB bandwidths at the resonance peaks are also different. In addition, as a value of ϵ decreases, resonance frequencies of the medium and high frequency resonance peaks (e.g., the resonance peak obtained after the second resonance peak 220 and the third resonance peak 230 are merged) gradually increase, and the 3 dB bandwidths gradually increase. Accordingly, by adjusting the value of ϵ, the frequency positions and the 3 dB bandwidths of the medium and high frequency resonance peaks may be adjusted. In some embodiments, the ratio ϵ of the thickness hⱼ to the thickness hₖ of any two steps may be within a range of 0.25-4, which makes the medium and high frequency resonance peaks of the vibration component to be located within a range of 3000 Hz-12000 Hz, and the resonance peaks may have a relatively large 3 dB bandwidth.

For frequency responses of some vibration components 100 requiring a low Q value and a wide bandwidth, a relatively large mass may be designed to be concentrated near a center of the reinforcing member 120. In some embodiments, the ratio φ of the thickness h₁ of the outmost edge step of the reinforcing member 120 to the thickness hₙ of the center step may be within a range of 0.1-1. In some embodiments, the ratio φ of the thickness h₁ of the outmost edge step of the reinforcing member 120 to the thickness hₙ of the center step may be within a range of 0.2-0.8. In some embodiments, the ratio φ of the thickness h₁ of the outmost edge step of the reinforcing member 120 to the thickness hₙ of the center step may be within a range of 0.2-0.6. In some embodiments, the ratio φ of the thickness hⱼ of the outmost edge step of the reinforcing member 120 to the thickness hₙ of the center step may be within a range of 0.2-0.4.

For frequency responses of some vibration components 100 requiring a high Q value and a narrow bandwidth, a relatively large mass may be designed to be concentrated in an edge region of the reinforcing member 120. In some embodiments, the ratio φ of the thickness h₁ of the outmost edge step of the reinforcing member 120 to the thickness hₙ of the center step may be within a range of 1-10. In some embodiments, the ratio φ of the thickness h₁ of the outmost edge step of the reinforcing member 120 to the thickness hₙ of the center step may be within a range of 1.2-6. In some embodiments, the ratio φ of the thickness h₁ of the outmost edge step of the reinforcing member 120 to the thickness hₙ of the center step may be within a range of 2-6. In some embodiments, the ratio φ of the thickness h₁ of the outmost edge step of the reinforcing member 120 to the thickness hₙ of the center step may be within a range of 3-6. In some embodiments, the ratio φ of the thickness h₁ of the outmost edge step of the reinforcing member 120 to the thickness hₙ of the center step may be within a range of 4-6. In some embodiments, the ratio φ of the thickness h₁ of the outmost edge step of the reinforcing member 120 to the thickness hₙ of the center step may be within a range of 5-6.

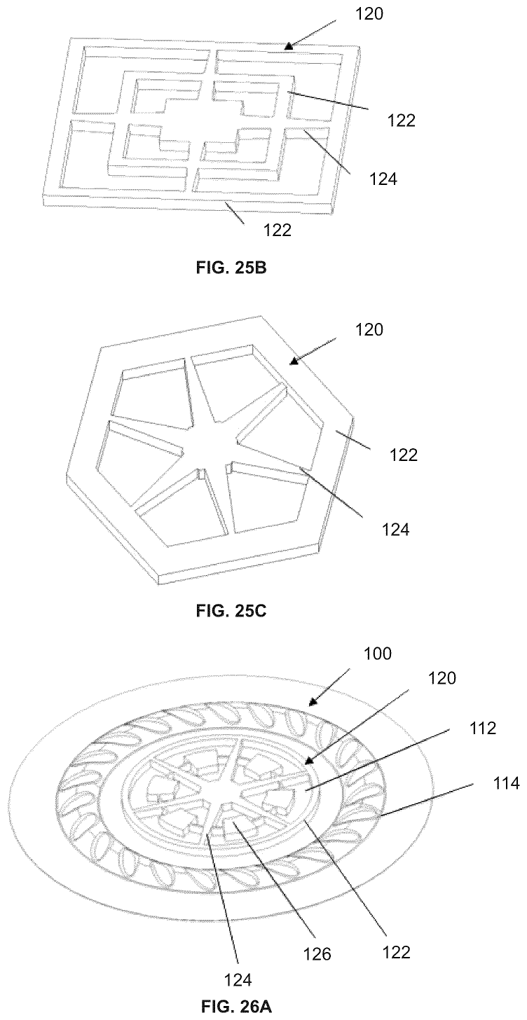

As illustrated in FIGS. 25A-25C, FIGS. 25A-25C are schematic structural diagrams illustrating vibration components including different shapes of reinforcing members according to some embodiments of the present disclosure. In FIG. 25A, a shape of the reinforcing member 120 may be a rectangle, the one or more ring structures 122 may be single-ring rectangular structures, and the one or more strip structures 124 may be trapezoidal structures. In FIG. 25B, a shape of the reinforcing member 120 may be a rectangle, the one or more ring structures 122 may be double-ring rectangular structures, and the one or more strip structures 124 may be trapezoidal structures. In FIG. 25C, a shape of the reinforcing member 120 in may be a hexagon, the one or more ring structures 122 may be single-ring hexagonal structures, and the one or more strip structures 124 may be trapezoidal structures. In some embodiments, the shape of the reinforcing member 120 of the vibration component 100 may match a shape of the clastic element 110. The clastic element 110 may also have various structures, such as a circle, a square, a polygon, etc. The shape of the reinforcing member 120 may also be designed into different shapes, including but not limited to a circle, a square (e.g., a rectangle and square), a triangle, a hexagon, an octagon, another polygon, an ellipse, and other irregular shapes.

Different shapes of reinforcing member 120 and different shapes of elastic element 110 may be flexibly designed to change a mass and a stiffness of the reinforcing member 120, a mass and a stiffness of the vibration component 100, etc., thereby changing a resonance frequency of the vibration component 100.

In some embodiments, the shape of the reinforcing member 120 and the shape of the clastic element 110 may include various shapes. In this case, different widths and different shapes may be defined for a horizontal direction of the one or more strip structures 124 extending from the central region 112 to a periphery. Different shapes, counts, and dimensions of the one or more ring structures may also be designed. The one or more ring structures 122 may be designed as entire rings or local ring structures 122. Different ring structures 122 may divide the one or more strip structures 124 into different regions, in which the one or more strips structures 124 from a center to a periphery may be continuous or staggered, and a count of the one or more strips structures 124 may be equal or unequal. In some embodiments, the one or more ring structures 122 may also be designed as a circle, a square (e.g., a rectangle and a square), a triangle, a hexagon, an octagon, another polygon, an ellipse, and other irregular structures.

In some embodiments, by designing the vibration component 100 including different shapes of reinforcing members 120, a fourth resonance peak of the vibration component 100 may be located within a range of 10 kHz-18 kHz, an area-thickness ratio μ of an area Sᵢ of each of one or more hollow regions to a thickness Hᵢ of the elastic element 110 of each of the one or more hollow regions may be within a range of 150 mm-700 mm, a ratio γ of an area Sₖᵢ to an area Sⱼᵢ of the one or more hollow regions of any two elastic elements 110 may be within a range of 0.25-4, and ratio β of a horizontal area of a reinforcing part of the reinforcing member 120 to a horizontal area of the reinforcing member 120 may be within a range of 0.2-0.7. In some embodiments, by designing the vibration component 100 including different shapes of reinforcing members 120, a fourth resonance peak of the vibration component 100 may be located within the range of 10 KHz-18 kHz, the area-thickness ratio μ of the area Sᵢ of each of the one or more hollow regions to the thickness Hᵢ of the elastic element 110 of each of the one or more hollow regions may be within a range of 100 mm-1000 mm, the ratio γ of the area Sₖᵢ to the area Sⱼᵢ of suspension regions of any two elastic elements 110 may be within a range of 0.1-10, and the ratio β of the horizontal area of the one or more hollow regions to the horizontal area of the reinforcing member 120 may be within a range of 0.1-0.8.

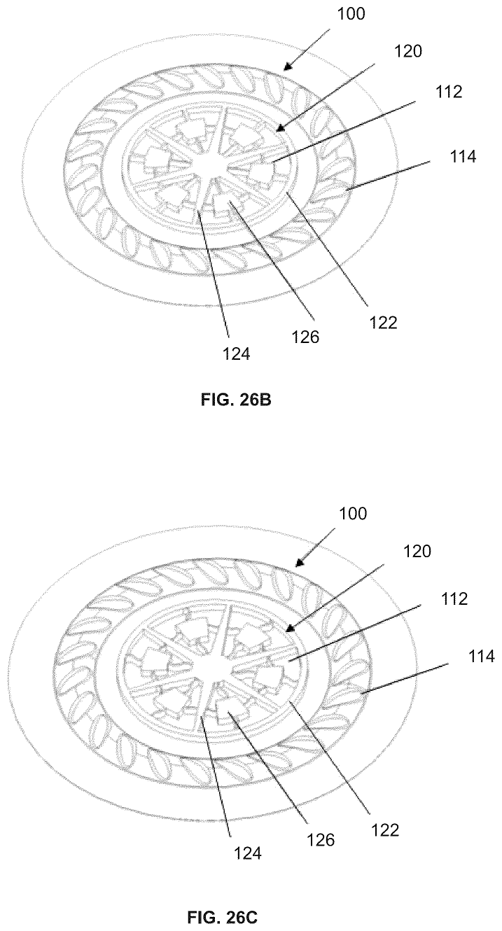

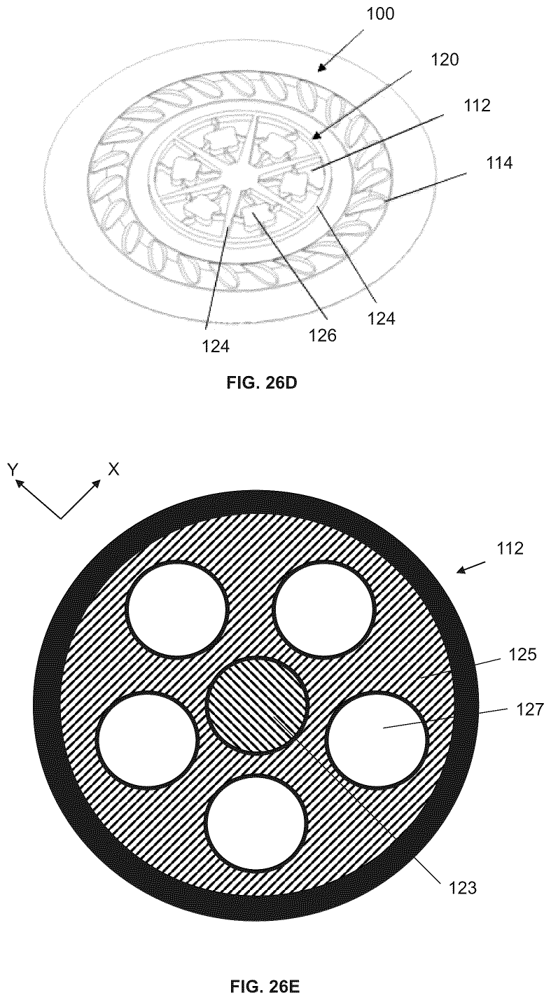

As illustrated in FIGS. 26A-26D, FIGS. 26A-26D are schematic structural diagrams illustrating vibration components 100 including local mass structures according to some embodiments of the present disclosure. FIG. 26A illustrates a local mass structure 126 of a double-clastic connection. FIG. 26B illustrates the local mass structure 126 of a four-clastic connection. FIG. 26C illustrates the local mass structure of an S-shaped four-clastic connection. FIG. 26D illustrates an irregular local mass structure 126 of the S-shaped four-clastic connection. In some embodiments, the local mass structure 126 may be designed in a suspension region of the central region 112 to flexibly adjust an equivalent mass Mmᵢ, equivalent stiffness Kaᵢ and Kaᵢ′, and equivalent damping Raᵢ and Raᵢ′ of each of the one or more hollow regions, so that a fourth resonance peak of the vibration component 100 may be effectively adjusted. Meanwhile, by designing the local mass structure 126, a mass and a stiffness of the reinforcing member 120 may also be adjusted within a wide range, thereby adjusting a first resonance peak and a third resonance peak of the vibration component 100.

In some embodiments, the local mass structure 126 may be circumferentially connected to adjacent strip structures 124 through two clastic structures (as illustrated in FIG. 26A), or may be circumferentially connected to adjacent strip structures 124 through the two elastic structures. In some embodiments, each local mass structure 126 may not be connected to the one or more strip structures 124 or the one or more ring structures 122, but only connected to the elastic element 110. In some embodiments, a part of the local mass structures 126 may be connected to the clastic element 110, and the other part of the local mass structures 126 may be connected to the one or more ring structures 122 and/or the one or more strip structures 124.

In some embodiments, the local mass structure 126 may also be connected to the adjacent strip structure 124 and the adjacent ring structure 122 simultaneously through the four clastic structures (as illustrated in FIG. 26B).

In some embodiments, a planar shape of the clastic structure may be a regular shape (as illustrated in FIG. 26A and FIG. 26B) or an irregular shape (as illustrated in FIG. 26C).

In some embodiments, the local mass structure 126 may be a regular shape (as illustrated in FIGS. 26A-26C) or in any irregular shape (as illustrated in FIG. 26D).

In some embodiments, by designing a dimension, a position, a count, and a shape of the local mass structure 126 and a dimension, a position, a count, and a shape of the clastic connection structure, a fourth resonance peak of the vibration component 100 may be located within a range of 10 kHz-18 kHz, an area-thickness ratio μ of an area Sᵢ of each of one or more hollow regions to a thickness Hᵢ of the elastic element 110 of each of the one or more hollow regions may be within a range of 150 mm-700 mm, a ratio γ of an area Sₖᵢ to an area Sⱼᵢ of suspension regions of any two elastic elements 110 may be within a range of 0.25-4, and a ratio β of a horizontal area of the one or more hollow regions to a horizontal area of the reinforcing member 120 may be within a range of 0.2-0.7. In some embodiments, by designing the dimension, the position, the count, and the shape of the local mass structure 126 and the dimension, the position, the count, and the shape of the elastic connection structure, the fourth resonance peak of the vibration component 100 may be located within a range of 10 kHz-18 kHz, the area-thickness ratio μ of the area Sᵢ of each of the one or more hollow regions to the thickness Hᵢ of the elastic element 110 of each of the one or more hollow regions may be within a range of 100 mm-1000 mm, the ratio γ of the area Sₖᵢ to the area Sⱼᵢ of suspension regions of any two clastic elements 110 may be within a range of 0.1-10, and the ratio β of the horizontal area of the one or more hollow regions to the horizontal area of the reinforcing member 120 may be within a range of 0.1-0.8.

FIG. 26E is a schematic structural diagram illustrating a cross-section of a reinforcing member according to some embodiments of the present disclosure. As illustrated in FIG. 26E, the reinforcing member 120 may include a central connection part 123, a reinforcing part 125, and a plurality of hollow parts 127. In some embodiments, the plurality of hollow parts 127 may be obtained by carving out part of a material from the reinforcing member 120. A part of the reinforcing member 120 that is not carved out may form the reinforcing part 125. In some embodiments, the plurality of hollow parts 127 may be configured as a circular shape. In some embodiments, the plurality of hollow parts 127 may be configured as other shapes. In some embodiments, the central connection part 123 and the reinforcing part 125 may have different thicknesses in a vibration direction of the elastic element 110. In some embodiments, a thickness of the central connection part 123 in the vibration direction of the elastic element 110 may be greater than a thickness of the reinforcing part 125 in the vibration direction of the elastic element 110.

The embodiments of the present disclosure further provide a loudspeaker. The loudspeaker may include the vibration component provided by the embodiments of the present disclosure. By reasonably arranging structures and parameters of the vibration component (e.g., an elastic element and a reinforcing member), the loudspeaker may generate a plurality of resonance peaks within an audible range (e.g., 20 kHz-20 kHz) of the human cars, thereby improving a frequency band and a sensitivity of the loudspeaker, and improving a sound pressure level output by the loudspeaker.

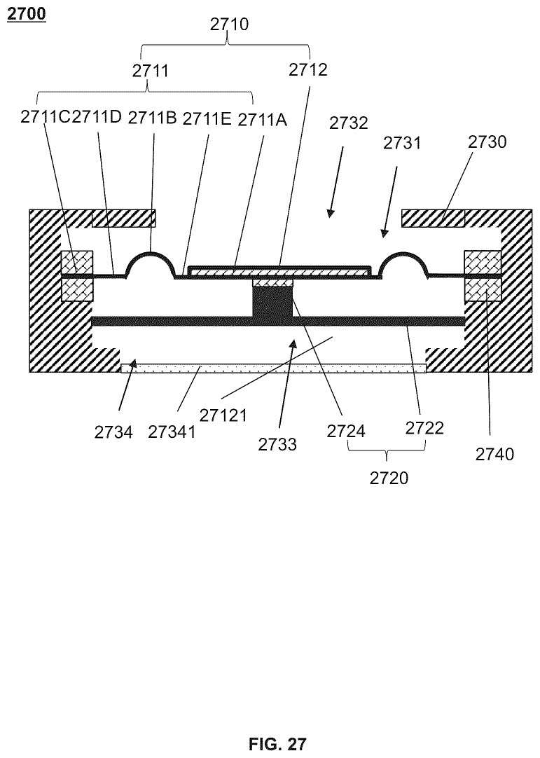

FIG. 27 is a structural diagram illustrating an exemplary loudspeaker according to some embodiments of the present disclosure. In some embodiments, as illustrated in FIG. 27, a loudspeaker 2700 may include a housing 2730, a driving component 2720, and a vibration component 2710. The driving component 2720 may be configured generate a vibration based on an electrical signal. The vibration component 2710 may be configured to receive the vibration of the driving component 2720 to vibrate. The housing 2730 may form a cavity. The driving component 2720 and the vibration component 2710 may be disposed in the cavity. A structure of the vibration component 2710 may be the same as any vibration component described in the embodiments of the present disclosure.

In some embodiments, the vibration component 2710 may mainly include an elastic element 2711 and a reinforcing member 2712. The clastic element 2711 may mainly include a central region 2711A, a folded ring region 2711B disposed at a periphery of the central region 2711A, and a fixed region 2711C disposed at a periphery of the folded ring region 2711B. The clastic element 2711 may be configured to vibrate in a direction perpendicular to the central region 2711A. The reinforcing member 2712 may be connected with the central region 2711A. The reinforcing member 2712 may include a reinforcing part and a plurality of hollow parts. Vibrations of the reinforcing member 2712 and the clastic element 2711 may generate at least two resonance peaks within an audible range (20 Hz-20 kHz) of human cars.

The driving component 2720 may be an acoustic device with an energy conversion function. In some embodiments, the drive component 2720 may be electrically connected with other components (e.g., a signal processor) of the loudspeaker 2700 to receive the electrical signal and convert the electrical signal into a mechanical vibration signal. The mechanical vibration signal may be transmitted to the vibration component 2710 to cause the vibration component 2710 to vibrate, thereby pushing the air in the cavity to vibrate and produce sound.

In some embodiments, the driving component 2720 may include a driving unit 2722 and a vibration transmission unit 2724. The driving unit 2722 may be electrically connected with other components (e.g., the signal processor) of the loudspeaker 2700 to receive the electrical signal and convert the electrical signal into the mechanical vibration signal. The vibration transmission unit 2724 may be connected between the driving unit 2722 and the vibration component 2710 and configured to transmit the vibration signal generated by the driving unit 2722 to the vibration component 2710.

In some embodiments, the drive unit 2722 may include, but is not limited to, a moving coil acoustic driver, a moving iron acoustic driver, an electrostatic acoustic driver, or a piezoelectric acoustic driver. In some embodiments, the moving coil acoustic driver may include a magnetic component configured to generate a magnetic field and a coil disposed in the magnetic field. When the coil is energized, a vibration may be generated in the magnetic field to convert an electrical energy into a mechanical energy. In some embodiments, the moving iron acoustic driver may include a coil configured to generate an alternating magnetic field and a ferromagnetic component disposed in the alternating magnetic field. The ferromagnetic component may vibrate under the action of the alternating magnetic field to convert the electrical energy into the mechanical energy. In some embodiments, the electrostatic acoustic driver may drive a diaphragm to vibrate through an electrostatic field disposed in the electrostatic acoustic driver, thereby converting the electrical energy into the mechanical energy. In some embodiments, the piezoelectric acoustic driver may convert the electrical energy into the mechanical energy under the action of an electrostrictive effect through a piezoelectric material disposed in the piezoelectric acoustic driver.

In some embodiments, the driving unit 2722 and the vibration transmission unit 2724 may be located on a same side of a vibration direction of the vibration component. In some embodiments, one end of the vibration transmission unit 2724 in a vibration direction of the central region 2711A may be connected with the driving unit 2722, and the other end of the vibration transmission unit 2724 away from the driving unit 2722 may be connected with the central region 2711A of the vibration component 2710. In some embodiments, the reinforcing member 2712 may include a central connection part 27121 covering a center of the central region 2711A. In some embodiments, the other end of the vibration transmission unit 2724 away from the driving unit 2722 may be directly connected with the central connection part 27121, i.e., the vibration transmission unit 2724 may be connected with the central region 2711A through the central connection part 27121. In some embodiments, the other end of the vibration transmission unit 2724 away from the driving unit 2722 may be indirectly connected with the central connection part 27121, i.e., the vibration transmission unit 2724 may be directly connected with the central region 2711A and connected with the central connection part 27121 through the central region 2711A. In some embodiments, a dimension of the vibration transmission unit 2724 may be the same or substantially the same as a dimension of the central connection part 27121 (e.g., a dimension difference may be within 10%).

In some embodiments, a projection of a center of one end of the vibration transmission unit 2724 connected with the central region 2711A in the vibration direction of the elastic element 2711 may coincide or substantially coincide with a projection of a center of the central region 2711A in the vibration direction of the clastic element 2711. With the arrangement, a uniformity and a stability of the vibration of the clastic element 2711 may be improved, and a third resonance peak output by the loudspeaker 2700 may be controlled to be within a frequency range (e.g., 5000 Hz-12000 Hz) described in the embodiments of the present disclosure. In the embodiments of the present disclosure, substantially coinciding means that a distance between the center of one end of the vibration transmission unit 2724 connected with the central region 2711A and the center of the central region 2711A may not exceed 5% of a diameter of the central region 2711A. In some embodiments, when the vibration transmission unit 2724 is connected with the central region 2711A through the central connection part of the reinforcing member 2712, since the dimension of the vibration transfer unit 2724 matches (e.g., the dimension is the same) the dimension of the central connection part, a center of one end of the vibration transmission unit 2724 connected with the central connection part may coincide or substantially coincide with a center of the central connection part 27121. In this case, the center of the central connection part may also coincide or substantially coincide with the projection of the center of the central region 2711A in the vibration direction of the elastic element 2711. More descriptions regarding the central connection part of the reinforcing member 2712 may be found in the relevant descriptions of the central connection part 123 of the reinforcing members 120.

In some embodiments, the vibration component 2710 may receive a force and displacement transmitted by the vibration transmission unit 2724 to push the air to move and product sound. In some embodiments, a structure of the vibration component 2710 may be the same as a structure of the vibration component 100.

In some embodiments, the folded ring region 2711B may be designed with a pattern of a specific shape, thereby destroying a vibration mode of the folded ring region 2711B of the elastic element 2711 within a corresponding frequency range, avoiding sound cancellation caused by a local segmented vibration of the elastic element 2711, and causing the vibration component 2710 to have a relatively flat sound pressure level curve. Meanwhile, a local stiffness of the elastic element 2711 may be increased through the pattern design.

In some embodiments, a modal vibration mode of the vibration component 2710 may be adjusted by adjusting the structure of the reinforcing member 2712.

In some embodiments, the reinforcing member 2712 may include one or more ring structures and one or more strip structures. Each of the one or more strip structures may be connected with at least one of the one or more ring structures. At least one of the one or more strip structures may extend toward a center of the central region 2711A. A region where the one or more ring structures are located and a region where the one or more strip structures are located may form a reinforcing part. In a projection range of a maximum contour of the reinforcing member 2712 in the vibration direction of the elastic element 2711, regions not covered by the one or more ring structures and the one or more strip structures may form a plurality of hollow parts. The descriptions regarding the one or more ring structures and the one or more strip structures of the reinforcing member 2712 may be found in the relevant descriptions of the one or more ring structures and the one or more strip structures elsewhere in the present disclosure.

In some embodiments, by reasonably arranging the reinforcing member 2712 and arranging a plurality of hollow regions in the central region 2711A, a local stiffness of the central region 2711A of the elastic element 2711 may be controlled and adjusted, thereby realizing controllable adjustment of the resonance peak output by the vibration component 2710 using a segmented vibration mode of each of the plurality of hollow regions of the central region 2711A of the vibration component 2711, so that the vibration component 2710 may have a relatively flat sound pressure level curve. In some embodiments, the one or more ring structures and the one or more strip structures may cooperate with each other, so that the reinforcing member 2712 may have an appropriate proportion of reinforcing part and hollow parts (i.e., the plurality of hollow parts), thereby reducing a mass of the reinforcing member 2712 and improving an overall sensitivity of the vibration component 2710. In some embodiments, by designing shapes, dimensions, and counts of the one or more ring structures and the one or more strip structures, positions and bandwidths of a plurality of resonance peaks (e.g., a third resonance peak, a fourth resonance peak, etc.) of the vibration component 2710 may be adjusted, thereby controlling a vibration output of the vibration component 2710.

In some embodiments, a mass of the reinforcing member 2712, a mass of the elastic element 2711, an equivalent air mass, and a driving end equivalent mass may be combined to form a total equivalent mass Mt, and equivalent damping of each part may form total equivalent damping Rt. The elastic element 2711 may provide a stiffness Kt to the system, forming a mass Mt-spring Kt-damping Rt system. When an excitation frequency of the driving component 2720 is close to a resonance frequency of the system, a resonance peak may appear in a frequency response curve of the vibration component 2710, i.e., a first resonance peak of the vibration component 2710. In some embodiments, a frequency of the first resonance peak may be within a range of 180 Hz-3000 Hz. In some embodiments, the frequency of the first resonance peak may be within a range of 200 Hz-3000 Hz. In some embodiments, the frequency of the first resonance peak may be within a range of 200 Hz-2500 Hz. In some embodiments, the frequency of the first resonance peak may be within a range of 200 Hz-2000 Hz. In some embodiments, the frequency of the first resonance peak may be within a range of 200 Hz-1000 Hz.

In some embodiments, the folded ring region 2711B, a connection region 2711D, and a suspension region 2711E disposed between a region of the central region 2711A provided with the reinforcing member 2712 and the folded ring region 2711B may form an equivalent mass Ms, an equivalent stiffness Ks, and equivalent damping Rs, thereby forming a mass Ms-spring Ks-damping Rs system. When the excitation frequency of the driving component 2720 is close to the resonance frequency of the system, a resonance peak may appear in the frequency response curve of the vibration component 2710, i.e., a second resonance peak of the vibration component 2710. In some embodiments, a frequency of the second resonance peak of the vibration component 2710 may be within a range of 3000 Hz-7000 Hz. In some embodiments, the frequency of the second resonance peak of the vibration component 2710 may be within a range of 3000 Hz-6000 Hz. In some embodiments, the frequency of the second resonance peak of the vibration component 2710 may be within a range of 4000 Hz-6000 Hz. In some embodiments, by setting parameters (e.g., parameters of the folded ring region 2711B and the suspension region 2711E) of the clastic element 2711, the second resonance peak of the vibration component 2710 may be located within the above frequency range.

In some embodiments, the reinforcing member 2712, the connection region 2711D, the folded ring region 2711B, the suspension region 2711E disposed between the region of the central region 2711A provided with the reinforcing member 2712 and the folded ring region 2711B, the equivalent air mass, an equivalent mass of the driving component 2720 may be combined to form a total equivalent mass Mt₁, and equivalent damping of each part may form total equivalent damping Rt₁. The reinforcing member 2712 and the elastic element 2711 may provide a stiffness Kt₁ to the system, forming a mass Mt₁-spring Kt₁-damping Rt₁ system. When the excitation frequency of the driving component 2720 is close to a speed resonance frequency of the system, a resonance peak may appear in the frequency response curve of the vibration component 2710, which is a third resonance peak of the vibration component 2710. In some embodiments, a frequency of the third resonance peak may be within a range of 5000 Hz-12000 Hz. In some embodiments, the frequency of the third resonance peak may be within a range of 6000 Hz-12000 Hz. In some embodiments, the frequency of the third resonance peak may be within a range of 6000 Hz-10000 Hz.

In some embodiments, the central region 2711A corresponding to the reinforcing member 2712 may have no less than one hollow region. Each hollow region with a different resonance frequency may vibrate, so that no less than one high frequency resonance peak may be generated on the frequency response curve of the vibration component 2710. In some embodiments, by designing the structure of the reinforcing member 2712, the resonance frequency of each hollow region may be equal or close to each other (e.g., a difference may be less than 4000 Hz), so that a high frequency resonance peak with a relatively large sound pressure level may be generated on the frequency response curve of the vibration component 2710, i.e., a fourth resonance peak of the vibration component 2710. In some embodiments, a frequency of the fourth resonance peak may be within a range of 8000 Hz-20000 Hz. In some embodiments, the frequency of the fourth resonance peak may be within a range of 10000 Hz-18000 Hz. In some embodiments, the frequency of the fourth resonance peak may be within a range of 12000 Hz-18000 Hz. In some embodiments, the frequency of the fourth resonance peak may be within a range of 15000 Hz-18000 Hz. In some embodiments, the frequency of the fourth resonance peak may be greater than 20000 Hz. In some embodiments, the resonance frequency of each hollow region may be different, and vibration phases of different hollow regions within different frequency ranges may be different within a high frequency range (e.g., 8000 Hz-20000 Hz), forming an effect of sound superposition and cancellation, which makes the vibration component 2710 not output the fourth resonance peak.

In some embodiments, by designing the structure of the vibration component 2710, the loudspeaker 2700 may generate two, three, or four resonance peaks within the audible range (e.g., 20 Hz-20 kHz) of the human cars.

In some embodiments, by designing a structure and a dimension of the vibration component 2710, including an overall dimension of the reinforcing member 2712, a count and dimensions of the one or more strip structures, arrangement positions of the one or more strip structures, an area of the suspension region 2711E, a structure (e.g., a folded ring width, a folded ring arch height, a folded ring arch shape, a pattern, etc.) of the folded ring region 2711B, and an area of the connection area 2711D, a difference between the frequency of the second resonance peak and the frequency of the third resonance peak of the vibration component 2710 may be designed. In some embodiments, when the difference between the frequency of the second resonance peak and the frequency of the third resonance peak of the vibration component 2710 is less than 2000 Hz, the second resonance peak and the third resonance peak tend to merge, i.e., the second resonance peak and the third resonance peak may present as one resonance peak, making a medium and high frequency range (3000 Hz-10000 Hz) to have a relatively high sensitivity, and greatly increasing a bandwidth of the merged resonance peak. In some embodiments, the frequency of the fourth resonance peak may be greater than 20000 Hz, i.e., the fourth resonance peak is not presented within the audible range of the human cars. In some embodiments, when the difference between the frequency of the second resonance peak and the frequency of the third resonance peak is less than 2000 Hz and the fourth resonance peak is not presented within the audible range of the human cars, only two resonance peaks may be generated within the audible range of the human car during vibration of the vibration component, and a 3 dB bandwidth of at least one of the only two resonance peaks may not be less than 1000 Hz. The 3 dB bandwidth refers to a width of a frequency band (e.g., the abscissa in FIG. 7D) when a sound pressure level amplitude (e.g., the ordinate in FIG. 7D) corresponding to a resonance peak is reduced by 3 dB. In some embodiments, during vibration of the vibration component 2710, the 3 dB bandwidth of at least one resonance peak within the audible range of the human cars may not be less than 1500 Hz. In some embodiments, during vibration of the vibration component 2710, the 3 dB bandwidth of the at least one resonance peak within the audible range of the human cars may not be less than 1000 Hz. In some embodiments, during vibration of the vibration component 2710, the 3 dB bandwidth of the at least one resonance peak within the audible range of the human cars may not be less than 1000 Hz 500 Hz.

In some embodiments, by the design of the reinforcing member 2712 and the clastic element 2711, the vibration component 2710 may appear a required high-order mode within the audible range (20 Hz-20000 Hz). The first resonance peak, the second resonance peak, the third resonance peak, and the fourth resonance peak may be generated on the frequency response curve of the vibration component 2710, i.e., four resonance peaks may be generated on the frequency response curve of the vibration component 2710 within the frequency range of 20 Hz-20000 Hz.

In some embodiments, by designing the structure of the reinforcing member 2712 and the clastic element 2711, the vibration component 2710 may also generate only three resonance peaks within the audible range (20 Hz-20000 Hz) of the human cars. For example, when the difference between the frequency of the second resonance peak and the frequency of the third resonance peak of the vibration component 2710 is less than 2000 Hz, the second resonance peak and the third resonance peak may present as one resonance peak on a frequency response curve of the vibration component 2710, which forms three resonance peaks of the vibration component 2710 within the audible range (20 Hz-20000 Hz) of the human cars with the first resonance peak and the fourth resonance peak. As another example, the central region 2711A corresponding to the reinforcing member 2712 may have no less than one suspension region. When the resonance frequency of each hollow region is higher than the audible range, or the resonance frequencies of hollow regions are different and the vibration phases of different suspension regions within different frequency ranges are different within the high frequency range (10000 Hz-18000 Hz), forming the effect of sound superposition and cancellation, a high-frequency roll-off effect may be obtained. The fourth resonance peak may not be presented on the frequency response curve of the vibration component 2710. In this case, the first resonance peak, the second resonance peak, and the third resonance peak may form the three resonance peaks of the vibration component 2710 within the audible range (20 Hz-20000 Hz) of the human cars.

In some embodiments, by designing the structure of the reinforcing member 2712 or the clastic element 2711, the frequencies of the plurality of resonance peaks may be adjusted, and the 3 dB bandwidths of the plurality of resonance peaks (e.g., the third resonance peak) and a Q value of a loudspeaker may also be adjusted.

In some embodiments, by designing an angle θ between two sides of a projection shape of the one or more strip structures in the vibration direction, the 3 dB bandwidth of the third resonance peak output by the loudspeaker 2700 and the Q value of the loudspeaker 2700 may be adjusted. In some embodiments, when the loudspeaker 2700 is required to present frequency response characteristics of a low Q value and a wide bandwidth, the angle θ of the one or more strip structures may have a relatively large value. In some embodiments, the angle θ of the one or more strip structures may be within a range of −90°-150°, so that the loudspeaker 2700 may have a relatively low Q value, and the 3 dB bandwidth of the third resonance peak output by the loudspeaker 2700 may not be less than 1000 Hz. In some embodiments, the angle θ of the one or more strip structures may be within a range of −0°-60°, so that the loudspeaker 2700 may have a relatively low Q value and the 3 dB bandwidth of the third resonance peak output by the loudspeaker 2700 may not be less than 1000 Hz.

In some embodiments, when the loudspeaker 2700 is required to present frequency response characteristics of a high Q value and a narrow bandwidth, a relatively small angle θ of the one or more strip structures may be designed. In some embodiments, the angle θ of the one or more strip structures may be within a range of −150°-90°, so that the loudspeaker 2700 may have a relatively high Q value and the 3 dB bandwidth of the third resonance peak output by the loudspeaker 2700 may not be greater than 1000 Hz. In some embodiments, the angle θ of the one or more strip structures may be within a range of −60°-0°, so that the loudspeaker 2700 may have a relatively high Q value and the 3 dB bandwidth of the third resonance peak output by the loudspeaker 2700 may not be greater than 1000 Hz.

In some embodiments, by designing a ratio τ of an area of an inner side to an area of an outer side of a half contour of a projection shape of the reinforcing member 2712 in the vibration direction of the clastic element 2711, the 3 dB bandwidth of the third resonance peak output by the loudspeaker 2700 and the Q value of the loudspeaker 2700 may be adjusted.

When the loudspeaker 2700 is required to present the frequency response characteristics with a low Q value and a wide bandwidth, a relatively large mass may be designed to be concentrated in the central region of the reinforcing member 2712. In some embodiments, the ratio τ of the area of the inner side to the area of the outer side of the half contour of the projection shape of the reinforcing member 2712 in the vibration direction of the clastic element 2711 may be within a range of 0.3-2, so that the loudspeaker 2700 may have a relatively low Q value, and the 3 dB bandwidth of the third resonance peak output by loudspeaker 2700 may not be less than 1000 Hz. In some embodiments, the ratio τ of the area of the inner side to the area of the outer side of the half contour of the projection shape of the reinforcing member 2712 in the vibration direction of the clastic element 2711 may be within a range of 0.5-1.2, so that the loudspeaker 2700 may have a relatively low Q value, and the 3 dB bandwidth of the third resonance peak output by loudspeaker 2700 may not be less than 1000 Hz. When the loudspeaker 2700 is required to present the frequency response characteristics of a high Q value and a narrow bandwidth, a relatively large mass may be designed to be concentrated in an edge region of the reinforcing member 2712. In some embodiments, the ratio τ of the area of the inner side to the area of the outer side of the half contour of the projection shape of the reinforcing member 2712 in the vibration direction of the clastic element 2711 may be within a range of 1-3, so that the loudspeaker 2700 may have a relatively high Q value, and the 3 dB bandwidth of the third resonance peak output by the loudspeaker 2700 may not be greater than 1000 Hz. In some embodiments, the ratio τ of the area of the inner side to the area of the outer side of the half contour of the projection shape of the reinforcing member 2712 in the vibration direction of the clastic element 2711 may be within a range of 1.2-2.8, so that the loudspeaker 2700 may have a relatively high Q value, and the 3 dB bandwidth of the third resonance peak output by the loudspeaker 2700 may not be greater than 1000 Hz.

In some embodiments, at least one of the one or more strip structures may have a plurality of steps with different thicknesses in the vibration direction of the elastic element 2711. The plurality of steps may include a first step located at a radially outermost side of the one or more strips structures and a second step located at a radially innermost side of the one or more strip structures. In some embodiments, by designing a ratio φ of a thickness of the first step to a thickness of the second step, the 3 dB bandwidth of the third resonance peak output by the loudspeaker 2700 and the Q value of the loudspeaker 2700 may be adjusted. When the loudspeaker 2700 is required to present the frequency response characteristics of a low Q value and a wide bandwidth, a relatively large mass may be designed to be concentrated near a center of the reinforcing member 2712. In some embodiments, the ratio φ of the thickness of the first step to the thickness of the second step may be within a range of 0.1-1, so that the loudspeaker 2700 may have a relatively low Q value, and the 3 dB bandwidth of the third resonance peak output by the loudspeaker 2700 may not be less than 1000 Hz. In some embodiments, the ratio φ of the thickness of the first step to the thickness of the second step may be within a range of 0.2-0.8, so that the loudspeaker 2700 may have a relatively low Q value, and the 3 dB bandwidth of the third resonance peak output by the loudspeaker 2700 may not be less than 1000 Hz. When the loudspeaker 2700 is required to present the frequency response characteristics of a high Q value and a narrow bandwidth, a relatively large mass may be designed to be concentrated in the edge region of the reinforcing member 2712. In some embodiments, the ratio φ of the thickness of the first step to the thickness of the second step may be within a range of 0.1-10, so that the loudspeaker 2700 may have a relatively high Q value, and the 3 dB bandwidth of the third resonance peak output by the loudspeaker 2700 may not be greater than 1000 Hz. In some embodiments, the ratio φ of the thickness of the first step to the thickness of the second step may be within a range of 1.2-6, so that the loudspeaker 2700 may have a relatively high Q value, and the 3 dB bandwidth of the third resonance peak output by the loudspeaker 2700 may not be greater than 1000 Hz.

In some embodiments, the housing 2730 may be a regular or irregular three-dimensional structure with a hollow interior (i.e., provided with a cavity). For example, the housing 2730 may be a hollow frame structure, including but is not limited to regular shapes such as a rectangular frame, a circular frame, a regular polygon frame, and any irregular shapes. In some embodiments, the housing 2730 may be made of metal (e.g., stainless steel, copper, etc.), plastic (e.g., polyethylene (PE), polypropylene (PP), polyvinyl chloride (PVC), polystyrene (PS), and acrylonitrile-butadiene-styrene copolymer (ABS), etc.), a composite material (e.g., a metal matrix composite material or a non-metal matrix composite material), etc. In some embodiments, the driving component 2720 may be located in an acoustic cavity formed by the housing 2730 or at least partially suspended in the acoustic cavity of the housing 2730.

In some embodiments, a peripheral side of the elastic element 2711 may be connected within an inner wall of the housing 2730, thereby dividing the cavity formed by the housing 2730 into a plurality of cavities. Specifically, the cavity of the housing 2730 may be divided into a front cavity 2731 and a rear cavity 2733 respectively located on two sides of the elastic element 2711 in the vibration direction of the elastic element 2711 with the elastic element 2711 as a boundary. In some embodiments, the front cavity 2731 may be located at a side of the clastic element 2711 away from the driving unit 2722.

In some embodiments, the rear cavity 2733 may be located at a side of the clastic element 2711 close to the driving unit 2722, i.e., the driving component 2720 may be disposed in the rear cavity 2733.

In some embodiments, one or more holes may be disposed on side walls of the housing 2730 corresponding to the front cavity 2731 and the rear cavity 2733. Merely by way of example, a first hole 2732 may be provided on the housing 2730 on a side of the front cavity 2731 away from the clastic element 2711. The front cavity 2731 may communicate with the outside of the loudspeaker 2700 through the first hole 2732. A second hole 2734 may be provided on the housing 2730 of the rear cavity 2733 away from the clastic element 2711. The rear cavity 2733 may communicate with the outside of the loudspeaker 2700 through the second hole 2734. Sound produced by the vibration component 2710 may be radiated to the front cavity 2731 and/or the rear cavity 2733 and transmitted to the outside of the loudspeaker 2700 through the first hole 2732 and/or the second hole 2734 on the housing 2730.

In some embodiments, a damping mesh or a dust-proof cloth (e.g., a damping mesh 27341) may be disposed on one or more holes (e.g., the second hole 2734). In some embodiments, the damping mesh may adjust (e.g., reduce) an amplitude of sound waves leaking from the one or more holes, thereby improving the performance of the loudspeaker 2700.

In some embodiments, the loudspeaker 2700 may also include a support element 2740 which is connected with the housing 2730 and the fixed region 2711C, respectively. In some embodiments, as illustrated in FIG. 27, the fixed region 2711C of the clastic element 2711 of the vibration component 2710 may be located at a periphery of the connection region 2711D and connected around a circumference of the connection region 2711D. The support element 2740 may be located on any surface of the fixed region 2711C in the vibration direction of the central region 2711A and connected with the connection region 2711D through the fixed region 2711C.

In some embodiments, the support element 2740 may be embedded in the inner wall of the housing 2730 and connected with the housing 2730 to support the elastic element 2711. When the support element 2740 is embedded in the inner wall of the housing 2730, the inner wall of the housing 2730 may be provided with a hole that matches the support element 2740, so that the support element 2740 may be placed in the hole to realize embedding of the support element 2740.

In some embodiments, as illustrated in FIG. 27, the support element 2740 may also be disposed in the cavity formed by the housing 2730. A lower surface (a surface close to the driving unit 2722) or a peripheral surface of the support element 2740 in the vibration direction of the vibration component 2710 may be connected with the housing 2730 to support the clastic element 2711. In some embodiments, when the support element 2740 is disposed in the cavity formed by the housing 2730, the inner wall of the housing 2730 may be configured to have a protruding structure that matches the support element 2740, so that the support element 2740 may be disposed on a surface of the protruding structure in the vibration direction to realize a connection between the support element 2740 and the housing 2730. In this arrangement, by disposing the support element 2740 in the cavity formed by the housing 2730, the support element 2740 may be prevented from being scratched and damaged during use of the loudspeaker 2700, thereby preventing the loudspeaker 2700 (especially the vibration component 2710) from being damaged.

In some embodiments, the support element 2740 may be a rigid structure that is not easily deformed, which only provides support for the elastic element 2711 during a vibration process of the vibration component 2710. In some embodiments, in order to further reduce a system stiffness of the vibration component 2710 during vibration and improve a compliance of the loudspeaker 2700, the support element 2740 may be configured as an easily deformable flexible structure to provide additional displacement for the vibration component 2710 during vibration.

In some embodiments, the support element 2740 may deform in response to a vibration signal of the clastic element 2711 to provide the clastic element 2711 with displacement in the vibration direction of the clastic element 2711, thereby increasing total displacement generated by the clastic element 2711 in the vibration direction of the elastic element 2711, and further improving a low-frequency sensitivity of the vibration component 2710. In some embodiments, a material of the support element 2740 may include one or more of a rigid material, a semiconductor material, an organic polymer material, an adhesive material, or the like. In some embodiments, the rigid material may include, but is not limited to, a metallic material, an alloy material, or the like. The semiconductor material may include, but is not limited to, one or more of silicon, silicon dioxide, silicon nitride, silicon carbide, or the like. The organic polymer material may include, but is not limited to, one or more of polyimide (PI), parylene, polydimethylsiloxane (PDMS), hydrogel, or the like. The adhesive material may include, but is not limited to, one or more of gel, silicone, acrylic, polyurethane, rubber, epoxy, hot melt, light curing, or the like. In some embodiments, in order to enhance a connection force between the support element 2740 and the clastic element 2711 and improve a reliability between the support element 2740 and the clastic element 2711, the material of the support element 2740 may be silicone adhesive glue, organic silicone sealing glue, etc. In some embodiments, a cross-sectional shape of the support element 2740 on a cross-section parallel to a vibration direction of an enhancement region may be a rectangle, a circle, an ellipse, a pentagon, or other regular and/or irregular geometric shapes. Meanwhile, by arranging the support element 2740 with a flexible structure, the vibration characteristics of the vibration component 2710 may be changed, the elastic element 2711 may be prevented from directly contacting the housing 2730, reducing a stress concentration (the housing is generally a rigid body) at a connection end of the elastic element 2711 with the housing 2730, thereby further protecting the clastic element 2711.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, it is understood by those skilled in the art that the aspects of the present disclosure may be illustrated and described in several patentable categories or circumstances, including any new and useful process, machine, product, or combination of matter, or any new and useful improvements thereof. Accordingly, various aspects of the present disclosure may be executed entirely by hardware, may be entirely executed by software (including firmware, resident software, microcode, etc.), or may be executed by a combination of hardware and software. The above hardware or software may be referred to as “data block”, “module”, “engine”, “unit”, “component”, or “system”. Furthermore, the aspects of the present disclosure may be embodied as a computer product including computer-readable program codes located on one or more computer-readable media.

Computer storage media may contain a propagated data signal embodying the computer program code, such as at baseband or as part of a carrier wave. The propagated signal may have multiple manifestations, including an electromagnetic form, an optical form, or the like, or an appropriate combination. The computer storage media may be any computer-readable media other than computer-readable storage media that enable communication, propagation, or transmission of a program for use in connection with an instruction execution system, apparatus, or equipment. The program codes located on the computer storage media may be transmitted via any appropriate medium, including radio, electrical cables, fiber optic cables, radio frequency (RF), or similar media, or any combination thereof.

The computer program codes required for the operation of each part of the present disclosure may be written in any one or more programming languages, including object-oriented programming languages such as Java, Scala, Smalltalk, Eiffel, JADE, Emerald, C++, C#, VB.NET, Python etc., conventional procedural programming languages such as C language, Visual Basic, Fortran 2003, Perl, COBOL 2002, PHP, and ABAP, dynamic programming languages such as Python, Ruby, and Groovy, or other programming languages. The program codes may run entirely on the user's computer, as a stand-alone software package, or partially on the user's computer and partially on a remote computer, or entirely on a remote computer or server. In the latter case, the remote computer may be connected to the user's computer via any form of network, such as a local area network (LAN) or a wide area network (WAN), or to an external computer (e.g. via the Internet), or in a cloud computing environment, or as a service such as Software as a Service (SaaS).

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Rather, claimed subject matter may lie in less than all features of a single foregoing disclosed embodiment.

In some embodiments, counts describing the quantity of components and attributes are used. It should be understood that such counts used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A loudspeaker, comprising:
a driving component configured to generate a vibration based on an electrical signal; and
a vibration component configured to receive the vibration of the driving component to vibrate; wherein
the vibration component includes an elastic element and a reinforcing member;
the elastic element includes a central region, a folded ring region disposed at a periphery of the central region, and a fixed region disposed at a periphery of the folded ring region, and the elastic element is configured to vibrate in a direction perpendicular to the central region; and
the reinforcing member is connected with the central region, the reinforcing member includes a reinforcing part and a plurality of hollow parts, and vibrations of the reinforcing member and the elastic element generate at least two resonance peaks within an audible range of human ears.

2. The loudspeaker of claim 1, wherein the reinforcing member includes one or more ring structures and one or more strip structures; each of the one or more strip structures is connected with at least one of the one or more ring structures to form the reinforcing part and the plurality of hollow parts; and at least one of the one or more strip structures extends toward a center of the central region.

3. The loudspeaker of claim 2, wherein a maximum area of a projection of the one or more ring structures in a vibration direction of the elastic element is less than an area of the central region.

4. (canceled)

5. (canceled)

6. The loudspeaker of claim 2, wherein a count of the one or more ring structures is within a range of 1-10.

7. The loudspeaker of claim 6, wherein the one or more ring structures include a first ring structure and a second ring structure, a radial dimension of the first ring structure is less than a radial dimension of the second ring structure, and the first ring structure is disposed at an inner side of the second ring structure.

8. The loudspeaker of claim 7, wherein the one or more strip structures include at least one first strip structure and at least one second strip structure; the at least one first strip structure is disposed at an inner side of the first ring structure and connected with the first ring structure; the at least one second strip structure is disposed between the first ring structure and the second ring structure and connected with the first ring structure and the second ring structure, respectively.

9. The loudspeaker of claim 8, wherein the at least one first strip structure and the at least one second strip structure are connected with the first ring structure at different positions.

10. The loudspeaker of claim 2, wherein at least one of the one or more strip structures has a plurality of different thicknesses in a vibration direction of the elastic element.

11. (canceled)

12. The loudspeaker of claim 2, wherein the elastic element further includes a connection region disposed between the folded ring region and the fixed region.

13. The loudspeaker of claim 1, wherein when the vibration component vibrates, only two resonance peaks are generated within the audible range of the human ears, and a 3 dB bandwidth of at least one of the two resonance peaks is not lower than 1000 Hz.

14. The loudspeaker of claim 1, wherein the at least two resonance peaks include a first resonance peak within a frequency range of 200 Hz-3000 Hz, a second resonance peak within a frequency range of 3000 Hz-7000 Hz, and a third resonance peak within a frequency range of 5000 Hz-12000 Hz.

15. The loudspeaker of claim 14, wherein when the vibration component vibrates, only three resonance peaks are generated within the audible range of the human ears.

16. The loudspeaker of claim 14, wherein one or more hollow regions are formed between the one or more ring structures and the one or more strip structures, and a ratio of an area of at least one of the one or more hollow regions to a thickness of the elastic element is within a range of 100 mm-1000 mm, so that the at least two resonance peaks include a fourth resonance peak within a frequency range of 10000 Hz-18000 Hz.

17. The loudspeaker of claim 16, wherein when the vibration component vibrates, only four resonance peaks are generated within the audible range of the human ears.

18. The loudspeaker of claim 14, wherein a difference between a frequency of the third resonance peak and a frequency of the second resonance peak is less than 3000 Hz.

19. (canceled)

20. The loudspeaker of claim 14, wherein one or more hollow regions are formed between the one or more ring structures and the one or more strip structures, and a ratio of an area of the one or more hollow regions to a thickness of the elastic element is less than 100 mm, so that vibrations of the reinforcing member and the elastic element generate a fourth resonance peak outside the audible range of the human ears.

21. The loudspeaker of claim 1, wherein
the driving component includes a driving unit and a vibration transmission unit, one end of the vibration transmission unit in a vibration direction of the central region is connected with the driving unit, and the other end of the vibration transmission unit is connected with the central region; and
the reinforcing member includes a central connection part, the vibration transmission unit is directly connected with the central connection part and connected with the central region through the central connection part, or the vibration transmission unit is directly connected with the central region and indirectly connected with the central connection part through the central region.

22. (canceled)

23. The loudspeaker of claim 21, wherein a projection of a center of one end of the vibration transmission unit connected with the central region in the vibration direction of the elastic element coincides or substantially coincides with a projection of a center of the central region in the vibration direction of the elastic element.

24. (canceled)

25. (canceled)

26. A vibration component, comprising:
an elastic element including a central region, a folded ring region disposed at a periphery of the central region, and a fixed region disposed at a periphery of the folded ring region, the elastic element being configured to vibrate in a direction perpendicular to the central region; and
a reinforcing member connected with the central region, the reinforcing member including a reinforcing part and a plurality of hollow parts; wherein
the reinforcing member is configured such that the vibration component at least generates a resonance peak within a range of 10000 Hz-18000 Hz during vibration.

27-41. (canceled)

42. A vibration component, comprising:
an elastic element including a central region, a folded ring region disposed at a periphery of the central region, and a fixed region disposed at a periphery of the folded ring region, the elastic element being configured to vibrate in a direction perpendicular to the central region; and
a reinforcing member, wherein a projection area of a maximum contour of the reinforcing member in a vibration direction of the elastic element is less than a projection area of the central region in the vibration direction; and the central region includes a suspension region disposed at a periphery of the reinforcing member; wherein
the folded ring region and the suspension region are configured such that the vibration component at least generates a resonance peak within a range of 3000 Hz-7000 Hz during vibration.

43-84. (canceled)
